(19) United States
(12) Patent Application Publication
(10) Pub. No.: US 2018/0260481 A1
(43) Pub. Date: Sep. 13, 2018

(54) Displaying search result associated identified or extracted unique identity associated structured contents or structured website

(71) Applicant: Yogesh Rathod, Mumbai (IN)

(72) Inventor: Yogesh Rathod, Mumbai (IN)

(21) Appl. No.: 15/955,675

(22) Filed: Apr. 17, 2018

Related U.S. Application Data
(63) Continuation of application No. PCT/IB2018/052660, filed on Apr. 17, 2018.
Application No. PCT/IB2018/052660 is a continuation-in-part of application No. PCT/IB2018/052246, filed on Apr. 1, 2018.

(51) Int. Cl. G06F 17/30

(52) U.S. Cl. CPC G06F 17/30864; G06F 17/30893; G06F 17/30887

(57) ABSTRACT

Various embodiments of a system, methods, platform, database, search engine & device for identifying search result associate unique identity or extracting unique identity based on parsing search result associated Uniform Resource Locator (URL) or web address or metadata, automatically determining or preparing or generating query based on said identified unique identity and automatically executing said query to automatically search, identify, invoke or retrieve or generate said identified unique identity associated one or more types of structured contents, structured data or structured website. In an embodiment enable to create and manage standardized, compact, searchable and search result compatible structured site or website including pages or webpages or GUIs or categories or categories of posts, and associated one or more types of contents including posts, structured contents, user actions and reaction controls or GUIs and presenting said structured contents with corresponding search result item based on search result item associated domain name of website associated user or account or source.

### FIELD OF INVENTION

The present invention relates generally to enabling to create and manage standardized, compact, searchable and search result compatible structured site or website including pages or webpages or GUIs or categories or categories of posts, and associated one or more types of contents including posts, structured contents, user actions and reaction controls or GUIs and presenting said structured contents with corresponding search result item based on search result item associated domain name of website associated user or account or source. The present invention also relates to generating feeds based on monitor, tracked, logged and stored searching related activities, actions, events, status, behaviours, communication and transactions. The present invention also relates to enabling communication with search result associated user or account or source or website admin or users based on monitor, tracked, logged and stored searching related activities, actions, events, status, behaviours, communication and transactions. The present invention also relates to presenting search result item associated user actions and reactions controls or GUIs.

### BACKGROUND OF THE INVENTION

U.S. Pat. No. 8,930,389 of Sloan et. El. (Title: Mutual search and alert between structured and unstructured data stores) discloses an approach is provided that search unstructured data sources with a search engine using initial search terms. Search hits received from the search engine are gathered and possible search terms are retrieved from the search hits. Entities are extracted from the search hits where the entities correspond to the extracted terms. The extracted entities and terms that are extracted are used to query structured data sources, such as tables in a relational database. Query results are then received from the queries performed on the structured data sources. Sloan et. El. Teaches searching a first set of one or more unstructured data sources on one or more initial search terms using a search engine; receiving one or more search hits from the searching of the first set of unstructured data sources; retrieving one or more terms from the search hits; extracting one or more entities from the search hits corresponding to the retrieved one or more terms; automatically constructing one or more structured queries using the one or more extracted entities as one or more fields and the corresponding one or more terms as one or more search parameters within the fields; querying one or more structured data sources using the one or more structured queries; receiving one or more query results from the querying.

PCT Patent Publication No. WO2007052285 Yogesh Rathod et el discloses enabling user to follow or subscribe one or more other users of network by searching people based on their structured profile or search posted messages and follow or subscribe message associated source and enable user to post or publish message which received and view by followers or subscribers of said posting or publishing user.

Currently Google™ search engine enables searching user to search for information on the World Wide Web. The search results are generally presented in a line of results often referred to as search engine results pages (SERPs). The information may be a mix of web pages, images, and other types of files. The main purpose of Google Search is to hunt for text in publicly accessible documents offered by web servers, as opposed to other data, such as images or data contained in databases. Internet content that is not capable of being searched by a web search engine is generally described as the deep web. Web search engines get their information by web crawling from site to site. As we speak, Google is using web crawlers to organize information from webpages and other publicly available content in the Search index. Google ranking systems sort through hundreds of billions of webpages in the Search index to give searching user useful and relevant results. Every search result has three parts: Title: The first blue line of any search result is the title of the webpage. Click the title to go to the site. URL: In green, you'll see the web address of the web page. Snippet: Below the URL is text that helps show how the page relates to your query. The words you search for will show in bold to make it easier for you to decide if the page has what you're looking for. Google parsing website microformats in order to populate search result pages with “Rich snippets”. Such snippets include additional details about results, such as displaying reviews for restaurants and social media accounts for individuals.

Google “AMP Stories” format that will appear in Google search—but only if you go looking for it. Search for a publication like People, CNN, or SBNation, and you might get served a carousel of slideshow content created by that partner. It could be a slideshow of a top-10 list, little moving images, or some other “visually rich [way] of storytelling specifically designed for mobile”.

Google Map shows information about place including local business name, address, website, email, phone, photos, videos, menu, map & directions and ratings & reviews. Many directory sites enables local business to listing as per standard structured and enable searching user to search or browse categories directories of local business and service providers.

Currently Google Adwords enables advertiser to provided call to actions with advertisement. A call to action (CTA) is a prompt on a website that tells the user to take some specified action. A call to action is typically written as a command, such as ‘Sign Up’ or ‘Buy Now’ and generally takes the form of a button or hyperlink. Calls to action like purchase, call today, order, browse, sign up, or get a quote make clear what the next steps are. Keywords in ad text show advertiser's ad's relevance to what people want. For example, if you've included digital cameras as a keyword, your ad headline could be “Buy Digital Cameras.” Adwords Ad extensions allow advertiser to extend advertiser's advert and show other relevant information alongside advertiser's advert on Google. Adwords Ad extensions allow advertiser to get users to what they want faster whether that be to a certain URL on advertiser's website, download advertiser's app, find directions to advertiser closes shop or simply call advertiser without having to visit advertiser's website. Adwords ad extensions comprises sitelink extensions, callout extensions, structured snippet extensions, call extensions, message extensions, location extensions, affiliate location extensions, price extensions, app extensions, review extensions.

Currently Facebook, Twitter, Instagram, Snapchat enables user to provide structured profile and other information including name including person name, brand name, product or service name, company name, details, age, gender, location, interest & like and based on said profile and posted or shared or published contents enable to search people and follow, view contents and follow associated source or account or user, search contents and follow associated source or account or user. The deep web, invisible web, or hidden web is parts of the World Wide Web whose contents are not indexed by standard web search engines for any reason. The opposite term to the deep web is the surface web, which is accessible to anyone using the Internet.

A Facebook page is a public profile specifically created for businesses, brands, celebrities, causes, and other organizations. Unlike personal profiles, pages do not gain “friends,” but “fans”—which are people who choose to “like” a page. Businesses, organizations and public figures can connect with their customers or fans on Facebook by creating a Facebook Page. Anyone with a Facebook account can create a Page or help manage one, as long as they have a role on the Page. People who like a Page can get updates about the Page, such as posts, photos or videos, in their News Feed.

Facebook enables user to make post which comprise photo, video, text, checked-in place, location information, feelings, activity types, tags, stickers and like and share with friends or contacts or users of network or public.

Facebook Pages run by businesses can display a so-called “call-to-action button” next to the page's like button. “Call to action” is a customizable button that lets page administrators add external links for easy visitor access to the business' primary objective, with options ranging from “Book Now”, “Contact Us”, “Use App”, “Play Game”, “Shop Now”, “Sign Up”, and “Watch Video”.

Website builders are tools that typically allow the construction of websites without manual code editing. In other words, a website builder is a program, or tool, that helps you build a website. There are two main types of website builders: offline and online. Offline website builders come as software programs that you download and install on your computer. You will build your website and save your files on your computer, and when your website is ready, all you need to do is upload all your website files to a web host. Online website builders are web-based and run on the provider's service. Unlike offline website builders, you don't need to download or install the software on your computer—all you need is a web browser (i.e. Chrome, Firefox or Internet Explorer) and an Internet connection. This allows you to work on your website from anywhere and any device. Another benefit is that the website builder comes with web hosting services so you don't need to purchase it and/or set it up separately. Many online website builders are designed for people with little or no coding experience. Online website builders are designed to be very easy to use, allowing anyone—beginners or experienced designers—to create an entire website within minutes using a drag-and-drop editor. Users build a website simply by dragging elements and dropping them to the desired location, no coding knowledge or experience is required. It's as easy as moving file icons on your computer. You start by choosing a design template that best fit your needs. All online website builders come with a library of website templates. Each template comes with built-in elements and content. To edit an element (i.e. replace the text and images with your own) all you need to do is click on it. This will open the editor where you can make changes. Page elements are re-arranged by dragging and dropping—just drag and drop the element to the new position. Add new elements and widgets to enhance your website. Standard elements and widgets include images, photo galleries, videos, contact forms, blogs, social sharing buttons (i.e. Facebook Like, Twitter Tweet, Pinterest Pin and more). You can also add a PayPal Buy Now button or a full-on shopping cart if you want to sell products on your website. After creating and finalizing with your new website, just click on the Publish button and your website will be viewable online.

A website is a collection of related web pages, including multimedia content, typically identified with a common domain name, and published on at least one web server. A website may be accessible via a public Internet Protocol (IP) network, such as the Internet, or a private local area network (LAN), by referencing a uniform resource locator (URL) that identifies the site. Websites can have many functions and can be used in various fashions; a website can be a personal website, a corporate website for a company, a government website, an organization website, etc. Websites are typically dedicated to a particular topic or purpose, ranging from entertainment and social networking to providing news and education. All publicly accessible websites collectively constitute the World Wide Web, while private websites, such as a company's website for its employees, are typically a part of an intranet. Web pages, which are the building blocks of websites, are documents, typically composed in plain text interspersed with formatting instructions of Hypertext Markup Language (HTML, XHTML). They may incorporate elements from other websites with suitable markup anchors. Web pages are accessed and transported with the Hypertext Transfer Protocol (HTTP), which may optionally employ encryption (HTTP Secure, HTTPS) to provide security and privacy for the user. The user's application, often a web browser, renders the page content according to its HTML markup instructions onto a display terminal. A dynamic website is one that changes or customizes itself frequently and automatically. Server-side dynamic pages are generated “on the fly” by computer code that produces the HTML (CSS are responsible for appearance and thus, are static files). There are a wide range of software systems, such as CGI, Java Servlets and Java Server Pages (JSP), Active Server Pages and ColdFusion (CFML) that are available to generate dynamic web systems and dynamic sites. Various web application frameworks and web template systems are available for general-use programming languages like Perl, PHP, Python and Ruby to make it faster and easier to create complex dynamic websites. A server-side dynamic web page is a web page whose construction is controlled by an application server processing server-side scripts. In server-side scripting, parameters determine how the assembly of every new web page proceeds, including the setting up of more client-side processing.

Google search result associated snippets, rich snippets and Ad. extensions having limited functionalities compare to wide variety of needs including one or more types of contents (photo, video, album, slideshow, carousal, event) and need of plurality types of actions controls or GUIs including buy, book, get appointment, subscribe, share, follow, invite contacts, customers, prospective customers to connect and reactions controls or GUIs including Like button, emoticons, comments. Some features limited for advertisers including Ad. extensions.

Facebook pages are limited compare to website. It enables providing some pre-defined structured information, categories, user actions and reactions controls including share, like, comment. Facebook enables advertiser to add call-to-action button to advertiser's advertisements, wherein call-to-action buttons comprise shop now, book now, learn more, sign up, contact us, use app, watch video, play game, download, see menu, apply now, request time, order. User can visit page or view page in news feed. Facebook enable advertiser to promote page, so maximum target user can view. Facebook enables searching of page, so user can search and view pages. Some features limited for advertisers including selected call-to-actions with advertisement. Facebook provides search based on structured information related to users of network. Facebook doesn't provide crawler based search engine to search websites of internet. So Facebook search is limited to information about users of network. Facebook posts limited to contents posted by user.

Each Website is different than other websites. There are no standards for websites. Heterogeneous types of websites exist in internet in terms of design, topic, database, server, contents. Crawler based search engine can search publically available web pages which cannot search deep or restricted data associated with website.

Present invention enables to create, promote and manage standardized, integrate-able, compact, social network or social attributes or social actions & reactions enabled, search engine friendly structured website including dynamically created domain, subject, feature, topic, and website specific structured information, structured pages, structured posts, website specific users actions, reactions, call-to-actions controls and GUIs, payment service, verification service, indexing service, standardized design, content posting, content presentation, user actions and reactions, deep data indexing and searching, categorization, standardized profile, in-search result standard presentation, standard advertisement, selling, marketing, boost and promotion.

RSS (Rich Site Summary; originally RDF Site Summary; often called Really Simple Syndication) is a type of web feed which allows users to access updates to online content in a standardized, computer-readable format. These feeds can, for example, allow a user to keep track of many different websites in a single news aggregator. The news aggregator will automatically check the RSS feed for new content, allowing the content to be automatically passed from website to website or from website to user. This passing of content is called web syndication. Websites usually use RSS feeds to publish frequently updated information, such as blog entries, news headlines, audio, video. An RSS document (called “feed”, “web feed”, or “channel”) includes full or summarized text, and metadata, like publishing date and author's name. A standard XML file format ensures compatibility with many different machines/programs. RSS feeds also benefit users who want to receive timely updates from favorite websites or to aggregate data from many sites. Subscribing to a website RSS removes the need for the user to manually check the website for new content. Instead, their browser constantly monitors the site and informs the user of any updates. The browser can also be commanded to automatically download the new data for the user. RSS feed data is presented to users using software called a news aggregator. This aggregator can be built into a website, installed on a desktop computer, or installed on a mobile device. Users subscribe to feeds either by entering a feed's URI into the reader or by clicking on the browser's feed icon. The RSS reader checks the user's feeds regularly for new information and can automatically download it, if that function is enabled. The reader also provides a user interface.

On the World Wide Web, a web feed (or news feed) is a data format used for providing users with frequently updated content. Content distributors syndicate a web feed, thereby allowing users to subscribe a channel to it. Making a collection of web feeds accessible in one spot is known as aggregation, which is performed by a news aggregator. A web feed is also sometimes referred to as a syndicated feed. A typical scenario of web-feed use might involve the following: a content provider publishes a feed link on its site which end users can register with an aggregator program (also called a feed reader or a news reader) running on their own machines; doing this is usually as simple as dragging the link from the web browser to the aggregator. When instructed, the aggregator asks all the servers in its feed list if they have new content; if so, the aggregator either makes a note of the new content or downloads it. One can schedule aggregators to check for new content periodically.

At present Twitter™ enables registered user of Twitter™ to search message posted by users of network and enable to follow search message associated source by clicking or tapping on search result item associated “Follow” button. Twitter™ search is limited to users of network and search content is limited to messages or tweets publicly posted by users of network.

The present invention also relates to providing of a ‘web search engine’ that is designed to search for information on the World Wide Web. The search results are generally presented in a line of results often referred to as search engine results pages (SERPs). The information may be a mix of web pages, images, and other types of files. Search result item comprise title, website URL or web address, snippet which comprise text that helps show how the page relates to searching user's query i.e. the words searching user search for will show in bold to make it easier for searching user to decide if the page has what searching user is looking for and follow or subscribe button or link or icon or control or Graphical User Interface (GUI) for enabling searching user to follow or subscribe said search result item associated source or account or user or enterprise user or website for receiving posted one or more types of contents including message, post, photo, video, wherein based on search result item associated website's unique domain name or host name (extract from URL or web address) identify associated user's or account's or source's identity or identifier and storing or relating in database, identity of searching user who have clicked or tapped on “Follow” or “Subscribe” or “Like” button with identity of search result item associated website's unique domain name or host name. User is provided with Graphical User Interface (GUI) for enabling user to post one or more types of contents or media including photo, video, text, link, location, and any combination thereof which following user can view in their feed.

Online instant messenger or chat enables user to communicate with other users based on contacts and connections. Present invention monitors, tracks, logs & stores searching user's activities, actions, events, transactions, sharing, communication, status, duration, behaviours, reactions related to one or more search queries and updates to search result item associated website or source or account or user or advertiser or enterprise user for enabling to communicate with searching user for real-time exchanging messages or one or more types of contents, queries, answers, contacts, map & directions, offers, discounts, and enable brand or seller or advertiser or website user to ask one or more type of reaction controls or Graphical User Interface (GUIs) to searching user and enable searching user to provide one or more types of reactions including like, comment, ratings, reviews, add to list, refer. In an embodiment advertiser can present or provide one or more action controls or Graphical User Interface (GUIs) for enabling user to click or tap on action control to take one or more actions, participate in events or group deals or activities, conduct transactions, provide status or updates or requirement specification, communicate with website user or brand or seller or enterprise user, install application, buy product, subscribe service, share, follow, connect, register, fill-forms, survey & polls, claim offers, checked-in place, disclose whether searching user is customer or prospective customer, view presentation, profile, menu, catalogues, information about product or service or brand or company. In an embodiment searching users can communicate with search results associated contextual websites users or search results associated advertisers or enterprise users or websites users or advertisers or enterprise users can communicate with searching users.

Google Analytics™ is a web analytics service offered by Google™ that tracks and reports website traffic. Integrated with AdWords, users can now review online campaigns by tracking landing page quality and conversions (goals). Goals might include sales, lead generation, viewing a specific page, or downloading a particular file. It also provides more advanced features, including custom visitor segmentation. Google Analytics™ e-commerce reporting can track sales activity and performance. The e-commerce reports shows a site's transactions, revenue, and many other commerce-related metrics. Google Analytics™ enables Real Time analytics, enabling a user to have insight about visitors currently on the site. Google Analytics™ is implemented with “page tags”, in this case, called the Google Analytics™ Tracking Code, which is a snippet of JavaScript code that the website owner adds to every page of the website. The tracking code runs in the client browser when the client browses the page (if JavaScript is enabled in the browser) and collects visitor data and sends it to a Google™ data collection server as part of a request for a web beacon. Google Analytics™ provides real-time analytics to website administrator or user or account, but Google Analytics™ does not enable website user to real-time communicate with contextual and real-time searching users based on monitored and tracked presented one or more types of activities or actions including view, click, add to cart or checkout or buy or subscribe or order or book, get appointment, add to one or more types of lists including wish list, view map & direction, view profile, view contact information, view menu item, participate in deal, downloads, install application, make call, send message, fill form, & login or register or membership with website or application, user who abandoned items in their shopping carts, user who searched the site but did not convert, interactions or status or social interactions & reactions including like, share, comment & rate, location or checked-in place (wherein type of activity comprise searching or clicking or viewing or add to cart or remove from cart or make order or book ticket or make payment particular product or service details or post or photo or video or listing or event) to enable website user or enterprise user or advertiser or seller or service provider to real-time presenting, negotiating, upselling cross selling, getting one or more types of user actions and reactions, providing offers including discounts, gifts, vouchers, cash backs, free samples and redeemable points, answering queries of searching user, providing support, conveying them to buy products or subscribe services, marketing products and services.

A web chat is a system that allows users to communicate in real time using easily accessible web interfaces. LiveChat is an online customer service software with live support, help desk software, and web analytics capabilities. The LiveChat comprise website chat widget—embedded on customer's website and seen by the end users (website visitors) as a small chat box, traditionally displayed in the bottom right corner of the web browser. Chat widget is visible on desktop and mobile devices, either in the browser or as a part of mobile application and agent application—used by the company employees to respond to questions asked by the customers. Usually agents use the web-based application, which allows employees to log in and conduct a chat with website visitor using any browser. There are two ways of having an online chat session between the agent and website visitor: Passive communication, started when the website visitor clicks on the chat button or widget displayed on the page. Active communication, initiated manually by the agent or automatically by the LiveChat system as soon as the visitor meets the predefined criteria (i.e. searched keyword, time on website, encountered error, etc.). Once the criteria is met, LiveChat displays a chat invitation with a customized message. During the chat session, agents close the sales, which results in increasing the overall conversion rate. Apart from website chat, other core features include: real-time website traffic monitoring, built-in ticketing system and agents' efficiency analytics. System identifies the best prospects visiting a website based on data gathered from the purchasing decisions of buyers. Statistics section allows calculating the conversion from chat invitations into chat sessions and then into sales.

Google™ provides a service that incorporates live chat with businesses right into search results, via a new link that shows whether a business is currently available, and immediately launches a chat via Google Hangouts™ (on either desktop or mobile) if they are, incorporates its service right into the business listing search result card it shows on Google™, which also shows you details including price level, address, map location, phone number, opening hours, ratings and reviews. The new experimental chat feature offers a direct text-based line of communication, in this case with a restaurant, so that you could theoretically ask if it's currently busy, if there's a reservation available, or menu-specific queries, for example, and receive an answer in real-time. Google is experimenting with a service that incorporates Google Hangouts into its search results, that could allow local businesses to better communicate with consumers. Strategy. A local business can add “chat” functionality to communicate with consumers, as well as a link right after the “chat” option to show its availability. Consumers can then start a Google Hangouts conversation with the business, where they can have more flexibility to make reservations, check product availability, and ask menu-specific questions of a restaurant, for example.

Therefore, it is with respect to these considerations and others that the present invention has been made.

### OBJECT OF THE INVENTION

The principal object of the present invention is to enabling user to enable to create, build, generate, wizard based create, configure, publish, advertise, promote, manage standardized, social network enabled, mobile friendly, search engine friendly or integrate-able with search result structured website or structured site or structured website or set of structured pages and each page associated structured posts including one or more types of contents comprise structured data or information or contents or media (based on selected or created one or more types of fields and associated one or more types of values, types of forms by using profile builder, form builder, fields and associated type and values creator or generator), one or more photos, videos, text, URLs or links, events, structured products and services details, actions controls and Graphical User Interface (GUIs), reaction controls and Graphical User Interface (GUIs), profile for enabling searching user or viewing user or requesting user to view said structured site or view said structured site in search results or with search result item and enable to view structured site associated structured profile, structured information, click or tap on associated named URLs, action controls or Graphical User Interface (GUIs), and reaction controls or Graphical User Interface (GUIs), view comments and reviews, view number of various types of reactions including number of impressions, views, likes, average ratings, comments and shares, download or install application, view, browse, navigate structured site associated pages and structured page or named page or tabs or categories associated various types of posts or structured posts including photo, video, text, links, URLs, locations, emoticons or emoji or stickers, album, canvas, carousal, slideshow, structured events information, products and service details including photo, video, price, tags, categories, features, description, offers, one or more types of structured information and any combination thereof, access or click or tap on associated one or more types of actions or call-to actions controls including share, follow, buy, order, book, get appointment, subscribe, message, chat, call, fil forms, survey, poll, connect, add to list, add to contact and Graphical User Interface (GUIs), reaction controls and Graphical User Interface (GUIs) including like, dislike, provide emoticons or expressions or reaction stickers or emoticons or emoji, provide comment or reviews or feedbacks or suggestions to take one or more actions and activities, conduct transactions, do interactions, connections, communications, collaborations, participations, sharing and provide various types of reactions.

The other object of the present invention is to receiving, from a first computing device of a first user, a search query to search for information on the World Wide Web or search for webpages with information that matches said searching query, searching, matching and identifying search results and presenting said search query specific search result items or search results or search results pages to a first computing device of a first user, wherein search result item comprise title, URL or web address and snippet, receiving, from a first computing device of a first user, request to follow or subscribe search result item associated source or account or user or website or webpage, identifying identity of source or account or user or website or webpage based on said request to follow or subscribe search result item associated unique domain name or hostname (extracted or identified from search result item associated URL or web address of website or webpage) and storing or relating in database, identity of searching user with said identified identity of search result item associated website's unique domain name or hostname unique domain name or hostname (extracted or identified from search result item associated URL or web address of website or webpage), receiving, from a second computing device of the second user, a message for distribution to one or more unspecified recipients and identifying, by a computer processor, the followers of the second user as recipients of the message; and sending the message to the followers of the second user, including the first user.

Other important object of present invention is to receiving, from a first computing device of a first user, a search query to search for information on the World Wide Web or search for webpages with information that matches said searching query, searching, matching and identifying search results, identifying identity of source or account or user or website or webpage associated with each search result item based on search result item associated unique domain name or hostname (extracted or identified from search result item associated URL or web address of website or webpage); presenting said search query specific search result items or search results or search results pages and follow or subscribe control or GUI including button or icon or link to, a first computing device of a first user, for enabling searching user or first user to click or tap on “Follow” or “Subscribe” control or GUI including button or icon or link, wherein search result item may comprise title, URL or web address and snippet or rich snippet, receiving, from a first computing device of a first user, request to follow or subscribe search result item associated source or account or user or website or webpage; storing or relating in database, identity of searching user with said identified identity of search result item associated unique domain name or hostname (extracted or identified from search result item associated URL or web address of website or webpage); receiving, from a second computing device of the second user, a message for distribution to one or more unspecified recipients; identifying, by a computer processor, the followers of the second user as recipients of the message; and sending the message to the followers of the second user, including the first user.

Other important object of present invention is to generating feeds based on monitored, tracked, logged and stored searching related activities, actions, events, status, behaviours, communication and transactions.

Other important object of present invention is to enabling communication with search result associated user or account or source or website admin or users based on monitor, tracked, logged and stored searching related activities, actions, events, status, behaviours, communication and transactions. The present invention also relates to presenting search result item associated user actions and reactions controls or GUIs.

Other important object of present invention is to monitoring, tracking, logging and storing one or more types of information about user's one or more types of activities, actions, events, transactions, interactions, session, status, behaviours, communications, searching, current location, liked locations, checked-in place, visited place, entered in, staying in and exited from pre-defined geo-fence boundary, sharing and reactions including viewing, like, comment, rate, provide emoticons and presenting said monitored, tracked, logged and stored one or more types of information to determined or contextual or selected or related or associated one or more sources, accounts, users, contacts of users, advertisers and enterprise users and enable said determined or contextual or selected or related or associated source or account or user or contact of user or advertiser or enterprise user to communicate including chat or instant messaging, collaborate, share, present, conduct one or more types of actions and reactions via presented one or more types of actions and reactions controls or Graphical User Interfaces (GUIs), participate, transact with said user and conduct one or more activities, actions, and reactions.

Other important object of present invention is to create social network, customer network, business & professional network, followers & following network in current invention related server, website, application, service, platform and network 110 based on 3^{rd} parties of external networks associated user's user names and profile links.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein extracting or parsing or identifying unique domain name or host name from search query specific search result item associated Uniform Resource Locator (URL) or web address of website or webpage; and retrieving said globally unique domain name or host name or second level domain name associated one or more types of contents including structured contents.

In an embodiment presenting with search result item said unique domain name or host name associated structured site or website or structured posts or one or more types of structured contents and associated actions and reactions matches with said search query.

In an embodiment extracting or parsing or identifying unique domain name or host name from search query specific search result item associated Uniform Resource Locator (URL) or web address of website or webpage; searching, matching and identifying said unique domain name or host name associated identity or identifier or unique user name or identity; and retrieving said identity or identifier associated site or one or more types of contents including structured contents.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to follow or subscribe search result item associated source or account or user; identifying identity of source or account or user based on said request to follow or subscribe search result item associated identified unique user name or user account, wherein identify user name or user account and type of network based on matching search result item associated Uniform Resource Locator (URL) or web address with one or more profile Uniform Resource Locators (URLs) of users of network or extracting unique user name from search result item associated Uniform Resource Locators (URLs) by parsing search result item associated Uniform Resource Locators (URLs) and matching said identified unique user name with stored user names of users of network; storing or relating in database, identity of searching user with said identified identity of search result item associated said identified unique user name or user account and type of network including social or business & professional or customer or following & followers network; receiving, from a second computing device of the second user, a message for distribution to one or more unspecified recipients; identifying, by a computer processor, the followers of the second user as recipients of the message; and sending the message to the followers of the second user, including the first user.

In an embodiment search result item may comprise title, Uniform Resource Locator (URL) or web address of webpage or website and snippets or rich snippets.

In an embodiment structured site or website structured post or structured contents comprise posts, photos, videos, text, links or Uniform Resource Locators (URLs), locations, emoticons or emoji or stickers and any combination thereof, structured data & information including one or more types of fields and associated values or data or information, controls or one or more types of contents or multimedia including business or job or personal or product or service profile, and reaction Graphical User interfaces (GUIs) or controls including like, dislike, emoticons, ratings, comment, and action Graphical User interfaces (GUIs) or controls including share, refer, report including report as spam or inappropriate, add to particular type of list including bookmark, favorite & wish list, follow, invite, connect, add to contact, and links or Uniform Resource Locators (URLs) of features, actions, reactions and call to actions including about, contact, sign-in, FAQs, map & directions, store locator, related to said identified source or account or user or website or webpage.

In an embodiment receiving, from a first computing device of a first user, a search query to search for information on the World Wide Web or search for webpages with information that matches said searching query; searching, matching, identifying, retrieving and generating search results; presenting said search query specific search result items or search results or search results pages; identifying identity of source or account or user or website or webpage or unique domain name or host name or second level domain name associated with each search result item based on search result item associated one or more types of contents, associated one or more types of identity including search result item identity, metadata or associated Uniform Resource Locator (URL) or web address of website or webpage; retrieving said identified source or account or user or website or webpage associated one or more types of structured contents matches with said search query; and presenting said identified source or account or user or website or webpage associated one or more types of structured contents, matches with said search query.

In an embodiment auto present structured site or website or structured post or structured contents and associated actions and reactions based on current location of user's device.

In an embodiment auto present structured site or website or structured post or structured contents and associated actions and reactions based on one or more types of user data including user status, current activity, action, event, transaction, interaction, current location of user's device, checked-in place, enter, stay & exit in geo-fence boundary, date & time, user profile and any combination thereof.

In an embodiment auto present structured site or website or structured post or structured contents and associated actions and reactions based on scanning of code including QRcode, scanning of image or in the event of triggering of recognizing of one or more objects in camera display screen.

In an embodiment auto present structured site or website or structured post or structured contents and associated actions and reactions based on voice command.

In an embodiment in the event of click or tap on place or shop or location or item or element icon on map, present associated contextual structured site or website or structured post or structured contents and associated actions and reactions.

In an embodiment in the event of clicking on link or Uniform Resource Locator (URL) of structured site or website or structured post or entering or selecting structured site or website or structured post link or Uniform Resource Locator (URL) in browser address bar, presenting said entered or selected link or Uniform Resource Locator (URL) associated structured site or website, wherein structured site or website comprise structured post, structured contents and associated actions and reactions.

In an embodiment send or share or publish or embedded structured site or website or structured post link or Uniform Resource Locator (URL) to one or more user selected contacts, connections, groups, followers, selected or selected categories or types of users of network and selected one or more types of one or more destinations including websites, webpages, applications, services, devices, user accounts or profiles.

In an embodiment publish one or more posts or updates of structured site or website or structured post based on schedules.

In an embodiment show structured site or website based on pre-defined geo-fence boundaries or nearby search.

In an embodiment show structured post(s) of structured site or website based on pre-defined geo-fence boundaries or nearby search.

In an embodiment show or hide structured site or website or structured post for public viewing or viewable for searching user with search result based on show or hide instruction from structured site or website owner or user or administrator.

In an embodiment auto filtering structured site or website or structured post content for presenting to contextual search query specific searching user based on search query keywords, one or more types of user data including user device current location, checked-in place, status, type of activity, action, event, transaction, liked contents, preferences, privacy settings, profile including type of gender, age range, interest, income range, language, qualification, home and work address or location, past related search queries and associated logged activities, actions, events, transactions, communications, sharing, locations, places, status, one or more types of reactions including provided or viewed likes, comments, ratings and conducted actions including follow, share refer, bookmarks, buy, order, subscribe, click, view, listen, fill forms, calls, sent and received messages, add to list, bookings, install, download, upload, claim offers, participate in event, survey, and poll, connect, invite, make payment.

In an embodiment automatically generating structured site or website, associated structured pages or categories, associated structured post based on type of structured site or website, name of structured site or website, domain name or host name, one or more categories, names of one or more structured pages, one or more categories of posts, selected and customized template or part of template including type of structured information to generate structured information or type of contents including product, service, information, advertisement, offer, event, application, album, slideshow, carousal, canvas, forms including profile, menu, survey, event, poll based on data in relational database, one or more types of files including photos, videos, icons, objects, controls and Graphical User Interfaces (GUIs) including actions and reactions controls and Graphical User Interfaces (GUIs), named Uniform Resource Locators (URLs), web application, map & directions, preferences, settings, privacy settings, rules, wherein post or one or more types of content comprise photo, video, voice, text, location or place information, date & time, emoticons, profile link, Uniform Resource Locators (URLs) or named Uniform Resource Locators (URLs), structured information, actions and reactions controls and Graphical User Interfaces (GUIs) and any combination thereof.

In an embodiment automatically generating posts or one or more types of contents based on selected and customized template or part of template including type of structured information to generate structured information or type of contents including product, service, information, advertisement, offer, event, application, album, slideshow, carousal, canvas, forms including profile, menu, survey, event, poll based on data in relational database, one or more types of files including photos, videos, icons, objects, controls and Graphical User Interfaces (GUIs) including actions and reactions controls and Graphical User Interfaces (GUIs), named Uniform Resource Locators (URLs), web application, map & directions, preferences, settings, privacy settings, rules, wherein post or one or more types of content comprise photo, video, voice, text, location or place information, date & time, emoticons, profile link, Uniform Resource Locators (URLs) or named Uniform Resource Locators (URLs), structured information, actions and reactions controls and Graphical User Interfaces (GUIs) and any combination thereof.

In an embodiment enable to automated publishing said auto generated posts.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to follow or subscribe search result item associated source or account or user or website or webpage; identifying identity of source or account or user or website or webpage based on said request to follow or subscribe search result item associated identified domain name or host name, wherein identify domain name or host name or user name or user account based on extracting or parsing search result item associated Uniform Resource Locator (URL) or web address of website or webpage; storing or relating in database, identity of searching user with said identified identity of search result item associated said identified domain name or host name or user name or user account; receiving, from a second computing device of the second user, a message for distribution to one or more unspecified recipients; identifying, by a computer processor, the followers of the second user as recipients of the message; and sending the message to the followers of the second user, including the first user.

In an embodiment present followed sources associated posted each one or more types of contents including messages, posts, photos, videos, text, Links or Uniform Resource Locators (URLs) and any combinations thereof.

In an embodiment user is enable to intelligently follow search result item associated identified user or account or source or website, wherein said search result item associated identified user or account or source or website can send posts or contents to selected one or more followers, type of followers including selected type of gender, one or more types of interests, age range, income range, qualification, one or more languages, one or more categories, type of activity, action, behaviours, status and transaction, keywords in logged search queries, selected or set or pre-defined locations or geo-fence boundaries or places specific matched followers, preference of followers.

In an embodiment auto determining presenting of followed sources associated posted one or more types of contents including messages, posts, photos, videos, text, Links or Uniform Resource Locators (URLs) and any combinations thereof based on one or more types of user data including current or past search queries, user status, preferences, current or past logged activities, actions, events, transactions, interactions, status, views, clicks, sharing, communications, current or past locations of user's device, checked-in places, enter, stay & exit in geo-fence boundary, one or more types of user reactions including likes, comments, and ratings, date & time, user profile including type of gender, age range, income range, qualification, and any combination thereof.

In an embodiment receiving, from a first computing device of a first user, a search query to search for information on the World Wide Web or search for webpages with information that matches said searching query; searching, matching and identifying search results; identifying identity of source or account or user or website or webpage associated with each search result item based on search result item associated Uniform Resource Locator (URL) or web address of website or webpage or search result item associated content including search result item identity and metadata; serving or presenting said search query specific search result items or search results or search results pages and follow or subscribe control or Graphical User interface Graphical User interface (GUI) including button or icon or link to, a first computing device of a first user, for enabling searching user to click or tap on “Follow” or “Subscribe” control or Graphical User interface (GUI) including button or icon or link, wherein search result item may comprise title, Uniform Resource Locator (URL) or web address and snippet; receiving, from a first computing device of a first user, request to follow or subscribe search result item associated source or account or user or website or webpage; storing or relating in database, identity of searching user with said identified identity of search result item associated website's domain name or hostname or user name or user account, wherein identify domain name or host name based on extracting or parsing search result item associated Uniform Resource Locator (URL) or web address of website or webpage or search result item associated content including search result item identity and metadata; receiving, from a second computing device of the second user, a message for distribution to one or more unspecified recipients; identifying, by a computer processor, the followers of the second user as recipients of the message; and sending the message to the followers of the second user, including the first user.

In an embodiment receiving, from a first computing device of a first user, a search query to search for information on the World Wide Web or search for webpages with information that matches said searching query; searching, matching and identifying search results; identifying identity of source or account or user associated with each search result item based on search result item associated Uniform Resource Locator (URL) or web address of website or webpage or search result item associated content including search result item identity and metadata; serving or presenting said search query specific search result items or search results or search results pages and follow or subscribe control or Graphical User interface Graphical User interface (GUI) including button or icon or link to, a first computing device of a first user, for enabling searching user to click or tap on “Follow” or “Subscribe” control or Graphical User interface (GUI) including button or icon or link, wherein search result item may comprise title, Uniform Resource Locator (URL) or web address and snippet; receiving, from a first computing device of a first user, request to follow or subscribe search result item associated source or account or user; storing or relating in database, identity of searching user with said identified identity of search result item associated user name or user account, wherein identify user name or user account based on extracting or parsing search result item associated Uniform Resource Locator (URL) or web address of website or webpage or search result item associated content including search result item identity and metadata; receiving, from a second computing device of the second user, a message for distribution to one or more unspecified recipients; identifying, by a computer processor, the followers of the second user as recipients of the message; and sending the message to the followers of the second user, including the first user.

In an embodiment determining presenting of posted one or more types of contents including messages, posts, photos, videos, text, Links or Uniform Resource Locators (URLs) and any combinations thereof by posting user based on selecting all or one or more followers, type of followers including selected type of gender, one or more types of interests, age range, income range, qualification, one or more languages, one or more categories, type of activity, action, behaviours, status and transaction, keywords in logged search queries, selected or set or pre-defined locations or geo-fence boundaries or places specific matched followers.

In an embodiment auto determining presenting of followed sources associated posted one or more types of contents including messages, posts, photos, videos, text, Links or Uniform Resource Locators (URLs) and any combinations thereof based on one or more types of user data including current or past search queries, user status, preferences, current or past logged activities, actions, events, transactions, interactions, status, views, clicks, sharing, communications, current or past locations of user's device, checked-in places, enter, stay & exit in geo-fence boundary, one or more types of user reactions including likes, comments, and ratings, date & time, user profile including type of gender, age range, income range, qualification, and any combination thereof.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to connect with search result item associated source or account or user or website or webpage; identifying identity of source or account or user or website or webpage based on said request to connect with search result item associated identified domain name or host name, wherein identify domain name or host name or user name or user account based on extracting or parsing search result item associated Uniform Resource Locator (URL) or web address of website or webpage; sending invitation to said identified source or account or user or website or webpage; and in the event of accepting request to connect by said identified source or account or user or website or webpage, storing or relating in database, identity of searching user with said identified identity of search result item associated said identified domain name or host name or user name or user account. In an embodiment enable invitee to delete inviter's request to connect with invitee. In an embodiment user is enable to ignore received connection request.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to connect with search result item associated source or account or user or website or webpage; identifying identity of source or account or user or website or webpage based on said request to connect with search result item associated identified domain name or host name or user name or user account, wherein identify domain name or host name based on extracting or parsing search result item associated Uniform Resource Locator (URL) or web address of website or webpage; and storing or relating in database, identity of searching user with said identified identity of search result item associated said identified domain name or host name or user name or user account.

In an embodiment receiving, from a first computing device of a first user, a search query to search for information on the World Wide Web or search for webpages with information that matches said searching query; searching, matching and identifying search results; identifying identity of source or account or user or website or webpage associated with each search result item based on search result item associated Uniform Resource Locator (URL) or web address of website or webpage; serving or presenting said search query specific search result items or search results or search results pages and connect control or Graphical User interface (GUI) including button or icon or link to, a first computing device of a first user, for enabling searching user to click or tap on “Connect” control or Graphical User interface (GUI) including button or icon or link, wherein search result item may comprise title, Uniform Resource Locator (URL) or web address and snippet; receiving, from a first computing device of a first user, request to connect with search result item associated source or account or user or website or webpage; storing or relating in database, identity of searching user with said identified identity of search result item associated website's domain name or hostname or user name or use account, wherein identify domain name or host name based on extracting or parsing search result item associated Uniform Resource Locator (URL) or web address of website or webpage.

In an embodiment receiving, from a first computing device of a first user, a search query to search for information on the World Wide Web or search for webpages with information that matches said searching query; searching, matching and identifying search results; identifying identity of source or account or user or website or webpage associated with each search result item based on search result item associated Uniform Resource Locator (URL) or web address of website or webpage; serving or presenting said search query specific search result items or search results or search results pages and connect control or Graphical User interface (GUI) including button or icon or link to, a first computing device of a first user, for enabling searching user to click or tap on “Connect” control or Graphical User interface (GUI) including button or icon or link, wherein search result item may comprise title, Uniform Resource Locator (URL) or web address and snippet; receiving, from a first computing device of a first user, request to connect with search result item associated source or account or user or website or webpage; sending invitation to said identified source or account or user or website or webpage; and in the event of accepting request to connect by said identified source or account or user or website or webpage, storing or relating in database, identity of searching user with said identified identity of search result item associated said identified domain name or host name or user name or user account. In an embodiment enable invitee to delete inviter's request to connect with invitee. In an embodiment user is enable to ignore received connection request.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to connect with search result item associated source or account or user; identifying identity of source or account or user based on said request to connect search result item associated identified unique user name or user account, wherein identify user name or user account and type of network based on matching search result item associated Uniform Resource Locator (URL) or web address with one or more profile Uniform Resource Locators (URLs) of users of network or extracting unique user name from search result item associated Uniform Resource Locators (URLs) by parsing search result item associated Uniform Resource Locators (URLs) and matching said identified unique user name with stored user names of users of network; sending invitation to said identified source or account or user; and in the event of accepting request to connect by said identified source or account or user, storing or relating in database, identity of searching user with said identified identity of search result item associated said identified unique user name or user account and type of network including social or business & professional or customer or following & followers network. In an embodiment enable invitee to delete inviter's request to connect with invitee. In an embodiment user is enable to ignore received connection request.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to connect with search result item associated source or account or user; identifying identity of source or account or user based on said request to connect search result item associated identified unique user name or user account, wherein identify user name or user account and type of network based on matching search result item associated Uniform Resource Locator (URL) or web address with one or more profile Uniform Resource Locators (URLs) of users of network or extracting unique user name from search result item associated Uniform Resource Locators (URLs) by parsing search result item associated Uniform Resource Locators (URLs) and matching said identified unique user name with stored user names of users of network; storing or relating in database, identity of searching user with said identified identity of search result item associated said identified unique user name or user account and type of network including social or business & professional or customer or following & followers network.

In an embodiment receiving, from a first computing device of a first user, a search query to search for information on the World Wide Web or search for webpages with information that matches said searching query; searching, matching and identifying search results; identifying identity of source or account or user and type of social network associated with each search result item based on search result item associated Uniform Resource Locator (URL) or web address of website or webpage or search result item associated content including search result item identity and metadata; serving or presenting said search query specific search result items or search results or search results pages and connect control or Graphical User interface (GUI) including button or icon or link to, a first computing device of a first user, for enabling searching user to click or tap on “Connect” control or Graphical User interface (GUI) including button or icon or link, wherein search result item may comprise title, Uniform Resource Locator (URL) or web address and snippet; receiving, from a first computing device of a first user, request to connect with search result item associated source or account or user; storing or relating in database, identity of searching user with said identified identity of search result item associated said identified unique user name or user account and type of network including social or business & professional or customer or following & followers network.

In an embodiment receiving, from a first computing device of a first user, a search query to search for information on the World Wide Web or search for webpages with information that matches said searching query; searching, matching and identifying search results; identifying identity of source or account or user associated with each search result item based on search result item associated Uniform Resource Locator (URL) or web address of website or webpage or search result item associated content including search result item identity and metadata; serving or presenting said search query specific search result items or search results or search results pages and connect control or Graphical User interface (GUI) including button or icon or link to, a first computing device of a first user, for enabling searching user to click or tap on “Connect” control or Graphical User interface (GUI) including button or icon or link, wherein search result item may comprise title, Uniform Resource Locator (URL) or web address and snippet; receiving, from a first computing device of a first user, request to connect with search result item associated source or account or user; sending invitation to said identified source or account or user; and in the event of accepting or confirm request to connect by said identified source or account or user, storing or relating in database, identity of searching user with said identified identity of search result item associated said identified unique user name or user account and type of network including social or business & professional or customer or following & followers network. In an embodiment enable invitee to delete inviter's request to connect with invitee. In an embodiment enable invitee to delete inviter's request to connect with invitee. In an embodiment user is enable to ignore received connection request.

In an embodiment receiving, from a second computing device of the second user, a message or post for distribution to one or more connected users; identifying, by a computer processor, the connections or selected one or more connections of the second user as recipients of the message; and sending the message to the connections or selected one or more connections of the second user, including the first user.

In an embodiment enabling connected users to communicate with each other, send and receive messages, posts, make call, share profile, request recommendation, recommend or refer, view profile, follow, unfollow, remove connection, invite to join particular group or event, save profile, report or block.

In an embodiment in the event of rejection of connection request by invitee inform about rejection to searching user or inviter or invitor.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to view one or more types of information or contents including profile, business profile, company profile, webpage, published contents, posts, messages, photos, videos, structured information and structured site or website; identifying identity of source or account or user or website or webpage based on said request to view one or more types of information or contents related to search result item associated identified domain name or host name or user name or user account, wherein identify domain name or host name or user name or user account based on extracting or parsing search result item associated Uniform Resource Locator (URL) or web address of website or webpage; and presenting to searching user, requested one or more types of information or contents.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, request to view one or more types of information or contents including user profile, job profile, social network profile, webpage, published contents, posts, messages, photos, videos, structured information and structured site or website; identifying identity of source or account or user based on said request to view one or more types of information or contents related to search result item associated identified unique user name or user account, wherein identify user name or user account and type of network based on matching search result item associated Uniform Resource Locator (URL) or web address with one or more profile Uniform Resource Locators (URLs) of users of network or extracting unique user name from search result item associated Uniform Resource Locators (URLs) by parsing search result item associated Uniform Resource Locators (URLs) and matching said identified unique user name with stored user names of users of network; and presenting to searching user, requested one or more types of information or contents.

In an embodiment receiving, from a first computing device of a first user, a search query to search for information on the World Wide Web or search for webpages with information that matches said searching query; searching, matching and identifying search results; identifying identity of source or account or user or website or webpage associated with each search result item based on search result item associated Uniform Resource Locator (URL) or web address of website or webpage; serving or presenting said search query specific search result items or search results or search results pages and one or more types of control or Graphical User interface (GUI) including button or icon or link to, a first computing device of a first user, for enabling searching user to click or tap on “View Profile” or “View Posts” or “View Structured Site or Website” or “View Structured Information” control or Graphical User interface (GUI) including button or icon or link, wherein search result item may comprise title, Uniform Resource Locator (URL) or web address and snippet; receiving, from a first computing device of a first user, request to view one or more types of information or contents including profile, business profile, job profile, company profile, webpage, published contents, posts, messages, photos, videos, structured information and structured site or website related to search result item associated source or account or user or website or webpage; and presenting to searching user, requested one or more types of information or contents.

In an embodiment receiving, from a first computing device of a first user, a search query to search for information on the World Wide Web or search for webpages with information that matches said searching query; searching, matching and identifying search results; identifying identity of source or account or user associated with each search result item based on search result item associated Uniform Resource Locator (URL) or web address of website or webpage or search result item associated content including search result item identity and metadata; serving or presenting said search query specific search result items or search results or search results pages and one or more types of control or Graphical User interface (GUI) including button or icon or link to, a first computing device of a first user, for enabling searching user to click or tap on “View Profile” View Social Profile” or View Job Profile” or View Professional Profile” or “View Posts” or “View Structured Site or Website” or “View Structured Information” control or Graphical User interface (GUI) including button or icon or link, wherein search result item may comprise title, Uniform Resource Locator (URL) or web address and snippet; receiving, from a first computing device of a first user, request to view one or more types of information or contents including user profile, social profile, job profile, professional profile, webpage, published contents, posts, messages, photos, videos, structured information and structured site or website related to search result item associated source or account or user or website or webpage; and presenting to searching user, requested one or more types of information or contents.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, one or more types of actions, status and reactions including like, dislike, selected expression or emoticon or emoji or sticker indicating one or more types of user actions and reactions, rating, sharing, referring, bookmark, add to one or more types of list, comment on search result item or source or post or one or more types of contents including webpage, profile, business profile, company profile, published contents, posts, messages, photos, videos, structured information, structured site or website, structured page, and structured post and checked-in search result item associated place or location or monitored current location of user device, enter in and stays in defined geo-fence boundary, indication of customer or prospective customer or current or past client or guest or member or student or employee or employer or friend or in contact or in connection or patient or viewer or viewed or viewing or like to view or read or reader or like to read or listen or listener or like to listen or eat or eating or like to eat (present list of types of indications based on search query, search result item associated profile, type of website, searched content, type of content including photo, video, post, advertisement, text, blog, news, keywords, identified keywords based on recognized objects in photo or video (series of images) categories, location and user data including current and past visited or checked-in locations or places and associated details including profile, current event (movie, play, show), type & name of place or associated business details (shop name), date & time) from searching user or indication of visited or visiting or interest to visit place or location or event of search result item associated source or website or webpage or account or user or entity; identifying identity of source or account or user or website or webpage or entity based on said search result item associated identified domain name or host name or user name or user account, wherein identify domain name or host name based on extracting or parsing search result item associated Uniform Resource Locator (URL) or web address of website or webpage; and storing said one or more types of searching user's reactions with identify of searching user and identity of said identified domain name or host name or user name or user account.

In an embodiment receiving, from a first computing device of a first user, a search query to search for information on the World Wide Web or search for webpages with information that matches said searching query; searching, matching and identifying search results; identifying identity of source or account or user or website or webpage associated with each search result item based on search result item associated Uniform Resource Locator (URL) or web address of website or webpage; serving or presenting said search query specific search result items or search results or search results pages and one or more types of actions, reactions and status controls or Graphical User interfaces (GUIs) including button or icon or link to, a first computing device of a first user, for enabling searching user to click or tap on one or more types of actions, reactions and status controls or Graphical User interfaces (GUIs) including button or icon or link, wherein search result item may comprise title, Uniform Resource Locator (URL) or web address and snippet; receiving, from a first computing device of a first user, one or more types of actions, status and reactions including like, dislike, selected expression or emoticon or emoji or sticker indicating one or more types of user actions and reactions, rating, sharing, referring, bookmark, add to one or more types of list, comment on search result item or source or post or one or more types of contents including webpage, profile, business profile, company profile, published contents, posts, messages, photos, videos, structured information, structured site or website, structured page, and structured post and checked-in search result item associated place or location or monitored current location of user device, enter in and stays in defined geo-fence boundary, indication of customer or prospective customer or current or past client or guest or member or student or employee or employer or friend or in contact or in connection or patient or viewer or viewed or viewing or like to view or read or reader or like to read or listen or listener or like to listen or eat or eating or like to eat from searching user (present list of types of indications based on search query, search result item associated profile, type of website, searched content, type of content including photo, video, post, advertisement, text, blog, news, keywords, identified keywords based on recognized objects in photo or video (series of images) categories, location and user data including current and past visited or checked-in locations or places and associated details including profile, current event (movie, play, show), type & name of place or associated business details (shop name), date & time) or indication of visited or visiting or interest to visit place or location or event of search result item associated source or website or webpage or account or user or entity; identifying identity of source or account or user or website or webpage or entity based on said search result item associated identified domain name or host name or user name or user account, wherein identify domain name or host name based on extracting or parsing search result item associated Uniform Resource Locator (URL) or web address of website or webpage; and storing said one or more types of searching user's reactions with identify of searching user and identity of said identified domain name or host name or user name or user account.

In an embodiment receiving, from a first computing device of a first user, a search query to search for information on the World Wide Web or search for webpages with information that matches said searching query; searching, matching and identifying search results; serving or presenting said search query specific search result items or search results or search results pages to a first computing device of a first user, wherein search result item comprise title, Uniform Resource Locator (URL) or web address and snippet; receiving, from a first computing device of a first user, one or more types of actions, status and reactions including like, dislike, selected expression or emoticon or emoji or sticker indicating one or more types of user actions and reactions, rating, sharing, referring, bookmark, add to one or more types of list, comment on search result item or source or post or one or more types of contents including webpage, user profile, job profile, professional profile, social profile, published contents, posts, messages, photos, videos, structured information, structured site or website, structured page, and structured post on search result item associated source or account or user or profile or post; identifying identity of source or account or user based on said request to view one or more types of information or contents related to search result item associated identified unique user name or user account, wherein identify user name or user account and type of network based on matching search result item associated Uniform Resource Locator (URL) or web address with one or more profile Uniform Resource Locators (URLs) of users of network or extracting unique user name from search result item associated Uniform Resource Locators (URLs) by parsing search result item associated Uniform Resource Locators (URLs) and matching said identified unique user name with stored user names of users of network; and storing information about said one or more types of searching user's reactions with identify of searching user and said identified identity of search result item associated said identified unique user name or user account and type of network including social or business & professional or customer or following & followers network.

In an embodiment receiving, from a first computing device of a first user, a search query to search for information on the World Wide Web or search for webpages with information that matches said searching query; searching, matching and identifying search results; identifying identity of source or account or user associated with each search result item based on search result item associated Uniform Resource Locator (URL) or web address of website or webpage or search result item associated content including search result item identity and metadata; serving or presenting said search query specific search result items or search results or search results pages and one or more types of actions, reactions and status controls or Graphical User interfaces (GUIs) including button or icon or link to, a first computing device of a first user, for enabling searching user to click or tap on one or more types of actions, reactions and status controls or Graphical User interfaces (GUIs) including button or icon or link, wherein search result item may comprise title, Uniform Resource Locator (URL) or web address and snippet; receiving, from a first computing device of a first user, one or more types of actions, status and reactions including like, dislike, selected expression or emoticon or emoji or sticker indicating one or more types of user actions and reactions, rating, sharing, referring, bookmark, add to one or more types of list, comment on search result item or source or post or one or more types of contents including webpage, user profile, professional profile, job profile, social profile, published contents, posts, messages, photos, videos, structured information, structured site or website, structured page, and structured post on search result item associated source or account or user or profile or post; identifying identity of source or account or user based on said request to view one or more types of information or contents related to search result item associated identified unique user name or user account, wherein identify user name or user account and type of network based on matching search result item associated Uniform Resource Locator (URL) or web address with one or more profile Uniform Resource Locators (URLs) of users of network or extracting unique user name from search result item associated Uniform Resource Locators (URLs) by parsing search result item associated Uniform Resource Locators (URLs) and matching said identified unique user name with stored user names of users of network; and storing information about said one or more types of searching user's reactions with identify of searching user and said identified identity of search result item associated said identified unique user name or user account and type of network including social or business & professional or customer or following & followers network.

In an embodiment presenting said stored one or more types of actions, reactions and status, related to said domain name or host name, provided by users of network with search result item related to said domain name or host name, wherein presenting information about one or more types of actions, reactions and status comprise number of likes, number of dislikes, number of comments or reviews, average ratings, comments and reviews, number of followers, number of shares, number of views, number of impressions, number of prospective customers, number of customers, number of connections, number of each type of emoticons including happy, happier, not happy, number of bookmarks, number of add to list, number of checked-in place, number of add to contacts, number of profile views, number of posts views, number of clicks, number of site views.

In an embodiment receiving, from a first computing device of a first user, a search query to search for information on the World Wide Web or search for webpages with information that matches said searching query; searching, matching, identifying, retrieving and generating search results; presenting said search query specific search result items or search results or search results pages; monitoring, tracking, logging and storing search result or search result items associated activities, actions, events, transactions, interactions, session, status, behaviours, communications, sharing and reactions; determining and generating or updating contextual feed items based on said search query, search query specific search results and search results associated search items and associated contents including matched snippets and Uniform Resource Locator (URL) associated source related one or more types of search query related matched contents, categories, keywords, webpages, posts, structured site or website related contents including structured pages and structured posts, one or more types of user associated or related data, search query related past search queries and said monitored, tracked, logged and stored one or more types of one or more search result or search result items associated or based on broad match, exact match and phrase match search query related identified past search queries associated information about activities, actions, events, transactions, interactions, session, status, behaviours, communications, sharing and reactions; and presenting said generated feed items in feed.

In an embodiment presenting or updating or appending search query specific generated feed items in feed in chronological order as per search query entered and executed for search result.

In an embodiment one or more types of user associated or related data comprise current location of user device, checked-in location, user provided status, availability status, current one or more types of one or more role of user including user, member, subscriber, customer, prospective customer, student, guest, viewer, seller, buyer, employer, employee, administrator, server, assistant, worker, associate, colleague, service provider, commuter, doctor, engineer, lawyer, account, government employee, advertiser, and friend or contact, interacted or nearest entities or contacts, structured query or requirement or status, search query, monitored, tracked, provided or logged or stored one or more types of activities, actions, senses, preferences, privacy settings, interests, keywords, tags, categories, requirements, search queries, connections, sharing, communications, collaborations, participations, events, user device location associate identified event or one or more types of entities, transactions, behaviours and associated data and metadata, one or more fields and associated one or more types of values including one or more types of forms, user profiles including age, gender, skills, qualifications, interest or hobbies, home & work address or locations, income ranges, liked or dislikes products, entities, contents or content sources & services, education, related named entities including school, college, company, organization, customer profile including used or using or want to use brands, products & services, business profile including type, information, address, offering services or provider of products, job profile, health profile, activity profile, advertisement, entity, brand, product & service profile or information and any combination thereof.

In an embodiment enabling user to take one or more actions including share, follow, add to list, add to contact, send message, chat, call, fill forms, become members, buy or order product, subscribe service, install application, book, reservation, get appointment, participate in deal, send requirement specification for request for quote, view photo or video or post, view profile, click and visit website or web page and reactions including like, dislike, provide emoticons, comment, ratings, reviews on feed item.

In an embodiment monitoring, tracking, logging and storing one or more types of information about search result item associated one or more types of one or more activities, actions, events, transactions, interactions, senses, session, status, behaviours, communications, collaborations, sharing, location or place information, date & time, search query and reactions and any combination thereof; identifying search result associate unique identity or determining or extracting unique identity based on parsing search result associated Uniform Resource Locator (URL) or web address or metadata; displaying to said identified source or account or user associated with said search result item and said searching user, said search result item associated monitored, tracked, logged and stored one or more types of information about one or more types of one or more activities, actions, events, transactions, interactions, senses, session, status, behaviours, communications, collaborations, sharing, location or place information, date & time, search query and reactions and any combination thereof; enable said search result item associated source or account or user and searching user to select from said displayed search result item associated monitored, tracked, logged and stored one or more types of information about one or more types of one or more activities, actions, events, transactions, interactions, senses, session, status, behaviours, communications, collaborations, sharing, location or place information, date & time, search query and reactions and any combination thereof and enable to communicate, collaborate, share, present, transact, negotiate, make offers, ask queries or provide answers, connect, provide and take one or more types of actions and reactions via actions and reactions controls and Graphical User Interface (GUIs), participate with each other based on said selected one or more types of information 1811/1817 or 1934/1933 about one or more types of one or more activities, actions, events, transactions, interactions, senses, session, status, behaviours, communications, collaborations, sharing, location or place information, date & time, search query and reactions, wherein identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

In an embodiment searching user is enable to communicate with current or selected one or more types of activity specific communication with search result items associated sources or accounts or users or advertisers or enterprise users.

In an embodiment search result item associated source or account or user or advertiser or enterprise user is enabled to communicate with one or more searching users based on current or selected one or more types of activities of searching user.

In an embodiment receiving from a searching user, instruction to start, stop, remove, cancel, pause, report, block and clear conversation.

In an embodiment enabling searching user to view profile or details, view associated logs related to searching activities, actions, events, transactions, status & communications, share one or more types of contents including photo, video, text, location information, contact information, user's reactions including comments, like, dislike, emoticons, and ratings, make call, send email, share screen, provide actual profile including name, age, gender, interests, requirement specification and address, follow, connect, like, provide indication of user as a customer or a prospective customer, add to contact, add to one or more types of lists to conversation associated source.

In an embodiment displaying instant messaging application or interface beside search results or displaying instant messaging application or interface with search result, wherein enabling searching user to show or hide instant messaging application or interface or in prominent place of search results or search application or search interface or search application or displaying instant messaging application or interface on or overlays on search results and enabling user to show or hide instant messaging application or interface on or overlays on search results.

In an embodiment enabling search result associate user or account or website or company or brand or advertiser to select one or more search queries or keywords or categories and select associate one or more searching users or select one or more searching users or select one or more search queries or keywords or categories and select associate one or more searching users and select associate one or more types of activities or select one or more types of activities specific all or one or more selected searching users and enable to conduct communication, messaging, conversation, sharing, answering of queries, collaboration, participations, presentation, negotiations, offering, supporting services, transactions, providing details or structured information, providing location information, providing status, providing and taking actions and reactions with/on said searching users.

In an embodiment enabling searching user to select one or more search queries and select all or one or more search results or select one or more search queries and select all or one or more search results and select all or one or more types of activities or select one or more search results or select one or more types of activities and enable to conduct communication, messaging, conversation, sharing, collaboration, participations, presentation, negotiations, transactions, claim offers, asking of queries, asking for supports, providing profile or details or selected one or more types of user data, providing location information, providing status, providing and taking actions and reactions with/on associate one or more users or accounts or websites.

In an embodiment monitoring, tracking, logging, processing and storing conversation associated activities, actions, events, transactions, reactions, behaviours, status, senses, events, logs, locations or place information, interactions, behaviours, communications, messaging, collaborations, sharing, participations, date & time, and enable to filter based on one or more selected searching user, one or more selected search result associated user or account or website or enterprise user or advertiser, one or more locations or places, date & time range, past customers, current customers, prospective customers, one or more fields or attributes of searching user including age, gender, interest type, location, nearest location, incomer range, skill, position, education, company name, one or more fields or attributes of website user or enterprise user or seller or service provider or advertiser including name, location, category, nearest location, type, rank or ratings, bookmarked or liked or favorite or customer of particular brand or product or service or company, type of activity or action or status or transaction specific searching users or customers or prospective customers including bought, shared, subscribed, installed, registered, ordered, booked, communicated, participated or type of reaction specific searching users or customers or prospective customers including liked, commented, and rated and any combination thereof, wherein one or more types of conversation comprise conversation related to particular searching user with search query specific one or more search results, conversation related to particular searching user with one or more users or accounts or websites, conversation related to user or account or website with searching users or each keyword or category or search query specific searching users or type of activity or action or call to action or transaction or location or place or status or event specific, conversation related to searching users, conversation related to users of network including websites, enterprise, business, brands, general users, conversation related to one or more type of activities, conversation related to keywords or search queries or categories.

In an embodiment receiving, from a first computing device of a first user, a search query to search for information on the World Wide Web or search for webpages with information that matches said searching query; searching, matching, identifying, retrieving and generating search results; presenting said search query specific search result items or search results or search results pages; monitoring, tracking, logging and storing one or more types of information about each search result item associated activities, actions, events, transactions, interactions, session, status, behaviours, communications, sharing and reactions; identifying identity of search result item associated website associated unique identity or unique identity of user account; presenting to said identified source or account or user associated with said search result item, said search result item associated monitored, tracked, logged and stored one or more types of information about one or more types of one or more activities, actions, events, transactions, interactions, session, status, behaviours, communications, sharing and reactions; enable said search result item associated source or account or user to communicate, collaborate, share, transact, connect, participate with said searching user.

In an embodiment identifies identity of search result item associated website, webpage, source, account or user based on extracting worldwide or global unique identity domain name or host name or second level domain name from parsing search result item associated Uniform Resource Locator (URL) or web address of website or webpage.

In an embodiment identifies identity of registered user and identify identity of structured site or website based on matching said global unique identity in the form of unique domain name with said identified registered user associated stored website or domain name or hostname.

In an embodiment enable said search result item associated source or account or user to communicate including send and receive message, share or present photos, videos, maps & directions, provide answers of queries, receive requirement specifications and provide quote, provide offers, discounts, redeemable points, cashbacks, coupons, promo code and deals, collaborate, share, transact, negotiate, participate with said searching user, provide one or more types of actions and reactions controls or Graphical User Interfaces (GUIs) to searching user to enable searching user to take one or more actions buy and order product, book tickets or services, get appointment, subscribe services, follow, share, connect, register, add to list, add to contacts, send message, chat, call, view map & direction, fill forms or survey or poll, provide one or more types of details or profile, view product details, company profile, install application, download, upload, claim offers, get discounts, offers, points & coupons, provide requirement specification and get quote, claim samples and reactions including like, dislike, provide emoticons for user expressions, comment, and rate.

In an embodiment monitoring, tracking, logging and storing each search result item associated activities, actions, events, transactions, interactions, session, status, behaviours, communications, sharing and reactions comprises click on link, time spend on particular website or one or more webpages of website, conduct one or more types of actions and reactions including make call, send message or query or requirement specification, like, provide ratings, comments & reviews, fill-form, register with website, share Uniform Resource Locator (URL) or link of website or web page, purchase or order product, subscribe service, get appointment, participate in group deals, claim offers, view video, view photo.

In an embodiment monitoring, tracking, logging and storing each search result item associated structured site or website related activities, actions, events, transactions, interactions, session, status, behaviours, communications, sharing and reactions comprises liked, disliked, rated, commented, shared, bookmarked, added to one or more types of lists, transacted including make payment, purchase or order product or service, and get appointment, followed, connected, communicated, install application, participated, subscribed, registered one or more structured sites or pages or posts and associate structured details related keywords and metadata, viewing of structured site or structured website, associated one or more structured pages and structured posts, photos, videos, and profile, one or more types of actions including follow, form or survey fill-ups, making of calls, sending and receiving of messages, video or VOIP calls, each type of reaction specific reactions including likes, comments, and shares, ratings, transactions, registration, membership, installation of applications and participation with events or groups or deals or group deals, duration of time spend on website or particular web pages clicked from structured site or website, duration of time spend on structured site or structured website or associated structured pages or associated structured posts, disclosure by searching user as a customer or prospective customer of or identified customer or prospective customer of structured site or website associated website, seller, brand, product or service, send invitation to connect, acceptance of invitation to connect, claim offers including discounts, coupons, redeemable points, vouchers, cashbacks and samples or gifts, by particular product or subscribe particular service, download, make bookings, get appointments, amount of transactions and any combination thereof.

In an embodiment real-time presenting said monitored, tracked, logged and stored information or data related to one or more types of one or more activities, actions, events, transactions, interactions, session, status, behaviours, communications, sharing and reactions to search result item associated source or account or users or advertiser or enterprise user and enable to communicate for/on each or selected or current activity, action, transaction, sharing, search, reaction, status, interaction including related to website, related to currently viewing web page, related to currently viewing product, related to currently viewing service details, related to currently viewing photo, video, album, post, listing, advertisement, content, profile, blogs, articles, contacts, about, features, portfolio, reviews, comments, ratings, number of likes, comments & reactions, or webpage or section or feature, related to currently searching or searched products or services, related to currently added to cart product(s) or service(s), related to currently conducted transaction, related to currently providing of one or more types of reactions including liked or commented or rated or shared particular product or service or photo or video or content or post or web page, related to currently conducted actions including add to one or more types of list including wish list, share, follow, buy, order, book, get appointment, viewing menu or particular menu item, viewing description of application or visiting application page, installing or installed application, add to calendar, add to contact, bookmark, register or become member, view map & direction, view listing on map, search within website, send message including ask query, access or clicks one or more web pages, sections, features or categories of website.

In an embodiment searching user is enable to selectively communicate with one or more search result items associated sources or accounts or users or advertisers or enterprise users.

In an embodiment searching user is enable to communicate with one or more sources or accounts or users or advertisers or enterprise users.

In an embodiment search result item associated source or account or user or advertiser or enterprise user is enabled to communicate with one or more searching users whose search result comprise search result item associated with said source or account or user or advertiser or enterprise user.

In an embodiment enabling search result item associated source or account or user or advertiser or enterprise user to create multi user environment and route communication with search users based on location of searching user, profile of searching user including customer, prospective customer, type of gender, income range, interest, past transactions, and number of active communications with searching users.

In an embodiment monitoring, tracking, logging and storing one or more types of information about user's one or more types of activities, actions, events, transactions, interactions, session, status, behaviours, communications, collaborations, connection, following, registration, searching, current location or checked-in place, liked locations, checked-in place, visited place, entered in, staying in and exited from pre-defined geo-fence boundary, sharing and reactions including viewing, like, comment, rate, provide emoticons; presenting said monitored, tracked, logged and stored one or more types of information to determined or contextual or selected or related or associated one or more sources, accounts, users, contacts of users, advertisers, enterprise users and interacted, transacted, communicated, participated one or more types of entities related to or associated with said monitored, tracked and logged one or more types of activities, actions, events, transactions, interactions, session, status, behaviours, communications, collaborations, connection, following, registration, searching, current location or checked-in place, liked locations, checked-in place, visited place, entered in, staying in and exited from pre-defined geo-fence boundary, sharing and reactions; enable determined or contextual or selected or related or associated source or account or user or contact of user or advertiser or enterprise user to communicate including chat or instant messaging, collaborate, share, present, conduct one or more types of actions and reactions via presented one or more types of actions and reactions controls or Graphical User Interfaces (GUIs), participate, transact with said user and conduct one or more activities, actions, and reactions.

In an embodiment identifying search result associate unique identity or extracting unique identity based on parsing search result associated Uniform Resource Locator (URL) or web address or metadata; automatically determining or preparing or generating query based on said identified unique identity; and automatically executing said query to automatically search, identify, invoke or retrieve or generate said identified unique identity associated one or more types of structured contents, structured data or structured website.

In an embodiment displaying said retrieved or generated one or more types of structured contents, structured data or structured website, wherein generating structured contents, structured data or structured website based on pre-defined or pre-set structure or template or configuration and associated one or more types of settings.

In an embodiment displaying said retrieved or generated one or more types of structured contents, structured data or structured website with said search result item of search results, wherein search results comprise one or more search result items and each search result item may comprise title, Uniform Resource Locator (URL) or web address and snippet.

In an embodiment identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item may comprise title, Uniform Resource Locator (URL) or web address and snippet.

In an embodiment automatically querying one or more structured data sources or storage mediums including photos, videos, images, voice, emoticons, stickers, text, data, location information and one or more types of files associated with said unique identity using said structured query.

In an embodiment one or more types of structured contents may comprise structured website including structured page or category or structured sub-page or sub-category specific structured post, wherein structured post may comprise one or more photos, videos, text, location information, emoticons, links or Uniform Resource Locators (URLs) and one or more types of digital content, actions and reactions Graphical User interfaces (GUIs) or controls, actions and reactions statistics, structured information including one or more fields and associated values or data, web applications and any combination thereof.

In an embodiment enabling user to view structured site or website, posts, one or more types of profiles, follow, share, add to contact, add to one or more types of lists, send invitation to connect, direct connect with said search result item associated identified worldwide unique domain name or host name or second level domain name or identified search result item associated global unique identity (GUID) or unique user name or user identity or user associated unique account.

In an embodiment enabling user to provide one or more types of reactions including like, dislike, bookmark, add to one or more types of lists, add to contact, provide one or more types of emoticons, emoji, stickers, provide comments, ratings & reviews on said search result item associated identified worldwide unique domain name or host name or second level domain name or identified search result item associated global unique identity (GUID) or unique user name or user identity or user associated unique account, unique account associated structured site or website, structured page, profile, post or one or more types of contents or multimedia.

In an embodiment enabling user to take or conduct one or more types of actions on post or one or more types of contents or multimedia associated with said search result item associated identified worldwide unique domain name or host name or second level domain name or identified search result item associated global unique identity (GUID) or unique user name or user identity or user associated unique account, wherein one or more types of actions including buy, order, book, subscribe, share, message, view product or service details, view structured information.

In an embodiment maintaining or accessing pre-defined or pre-set or pre-configured structure or template or set-up or composition or configuration of structured website including associated one or more types settings, elements, widgets, objects, applications, controls and Graphical User Interfaces (GUIIs) and structured contents and structured data; identifying search result associate unique identity or extracting unique identity based on parsing search result associated Uniform Resource Locator (URL) or web address or metadata; automatically determining or preparing or generating query based on said identified unique identity; and automatically executing said query to automatically search and identify said identified unique identity associated one or more types settings, elements, objects, applications, interfaces, controls and Graphical User Interfaces (GUIs) and structured contents and structured data; and invoking or generating structured website based on said identified and retrieved one or more types settings, elements, objects, applications, interfaces, controls and Graphical User Interfaces (GUIs) and structured contents and structured data.

In an embodiment structured contents and data comprise a photo, a video, a text, a location information, an emoticons or icons or stickers or emoji, an Uniform Resource Locator (URL) or web address or link, structured data including one or more types of one or more fields and associated values or data, one or more templates or part of templates and associated one or more types of fields and field specific values and any combination thereof and a form, a message, a post.

In an embodiment settings comprise name, title, one or more categories, type, position, height, width, length, font name, font type, font color, font size, background color, foreground color, order, sequence number, Uniform Resource Locator (URL) or web address or link or namespace associated with structured website or associated one or more pages or sub-pages or categories or sub-categories or associated one or more posts and post associated on or more types of contents or multimedia including photo, video, image, voice, location, emoticon or emoji or sticker, album, slideshow, canvas, carousal, named webpage Uniform Resource Locator (URL), structured data and associated one or more types of controls or Graphical User Interfaces (GUIIs), applications, widgets, objects, structured information templates or edited parts of templates, forms and any combination thereof.

In an embodiment controls or Graphical User Interfaces (GUIIs) comprise actions controls or Graphical User Interfaces (GUIIs) including share, refer, buy, subscribe, order, book, get appointment, install and reactions controls or Graphical User Interfaces (GUIIs) including like, dislike, expression emoticons or emoji or stickers or icons or templates, comment & review, ratings and one or more applications including web applications, smart client applications.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item may comprise title, Uniform Resource Locator (URL) or web address and snippet; identifying search result associate unique identity or extracting unique identity based on parsing search result associated Uniform Resource Locator (URL) or web address or metadata; automatically determining or preparing or generating query based on said search query and said identified unique identity; and automatically executing said query to automatically search, identify, invoke or retrieve or generate said search query specific and identified unique identity associated one or more types of structured contents, structured data or contents within structured website.

In an embodiment displaying said identified one or more types of structured contents, structured data or contents within structured website with said search result item.

In an embodiment highlighting search query related one or more keywords in said displayed one or more types of structured contents, structured data or contents within structured website.

In an embodiment loading one or more identified structured contents or structured data or contents within structured website comprises a photograph or a video or a post contains photo, video, voice, text, location information, one or more types of contents or multimedia, one or more types of actions and reactions controls or Graphical User Interfaces (GUIs) and any combination thereof; each viewing of the identified structured contents or structured data or contents within structured website comprising sequential display of the plurality of identified structured contents or structured data or contents within structured website, wherein present on the display a first identified structured content items or structured data or content item within structured website of the set of identified structured content items or structured data items or content items within structured website; receive from a touch controller a haptic contact signal indicative of a gesture applied to the display; wherein the controller in response to the haptic contact signal, proceeds to load and present on the display a second identified structured content items or structured data or content item within structured website of the set of identified structured content items or structured data items or content items within structured website or present on the display loaded second identified structured content items or structured data or content item within structured website of the set of identified structured content items or structured data items or content items within structured website.

In an embodiment identifying or determining or extracting unique identity based on parsing search result associated Uniform Resource Locator (URL) or web address or metadata; receiving, from a first computing device of a first user, request to follow or subscribe search result item associated identified unique domain name or host name or user or source or associated identified unique account; and storing or relating in database, identity of said searching user or requesting user with said identified identity of search result item associated said identified unique domain name or host name or user name or user account.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item comprise at least Uniform Resource Locator (URL) or web address.

In an embodiment receiving, from a second computing device of the second user, a message for distribution to one or more unspecified recipients; identifying, by a computer processor, the followers of the second user as recipients of the message; and sending the message to the followers of the second user, including the first user.

In an embodiment receiving, from a second computing device of the second user, one or more types of contents including user profile, one or more types of user related structured information, posted one or more messages, posts, photos, videos, images, voice, location information, URL and any combination thereof and associated privacy settings including allow anyone to view said one or more types of contents, not allow anybody to access or allow one or more contacts or groups to access said one or more types of contents; storing said one or more types of contents in database; and displaying said one or more types of contents in webpage or updated webpage or application or interface of said one or more types of contents posting or publishing or saving user.

In an embodiment embedding, integrating, composing or combining said updated webpage or child webpage of one or more followed users or sources or accounts with each following user's webpage or parent webpage or feed or timeline, wherein embedding said webpage of each followed source(s) within webpage of each following user so following user can view web page of each followed source in their webpage, wherein webpage comprise one or more types of stored or posted content items by posting or publishing user and enabling viewing user to view content items horizontally and navigate or scroll content items horizontally by swiping left or right or tapping or clicking on previous or next control or button.

In an embodiment plurality types of available technologies can by user to embed, integrate and display a web page within another web page. For example an iframe is used to display a web page within another web page. An iframe or inline frame is used to display external objects including other web pages within a web page. The basic syntax for adding an iframe can be given with: <iframe src=“URL”> alternative content for browsers which do not support iframe. </iframe>. The URL points to the location of external object or web page. The height and width attributes are used to specify the height and width of the iframe. <iframe src=“demo-page.html” width=“200” height=“200”> alternative content for browsers which do not support iframe. </iframe>. The frameborder attribute specifies whether or not to display a border around the iframe. This attribute carries a value of 0 or 1. The default value of 1 results in a border while a value of 0 removes the border from the iframe. An iframe can be used as a target for the hyperlinks. An iframe can be named using the name attribute. This implies that when a link with a target attribute with that name as value is followed, the linked resource is opened in the iframe. To display a web page within another web page PHP—either through include or Apache parse php code on .html pages or .AJAX & JS.

In an embodiment identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

In an embodiment present followed sources associated posted each one or more types of content items or message including one or more posts, photos, videos, images, voice, text, location information, emoticons or emoji or stickers, one or more types of file attachments, Uniform Resource Locators (URLs) or web address or short link or profile link and any combinations thereof.

In an embodiment enabling user to intelligently or conditionally follow or subscribe search result item associated identified unique website or domain name or host name or source or user or account, wherein said search result item associated identified unique website or domain name or host name or source or user or account can send or post or publish one or more types of posts or contents or message to selected one or more followers or subscribers, one or more types of followers or subscribers including selected type of gender, one or more types of interests, age range, income range, qualification, one or more languages, one or more categories, one or more types of activities, actions, behaviours, status and transactions specific, keywords in logged search queries, selected or set or pre-defined locations or geo-fence boundaries or places specific followers or matched followers and based on preference of followers.

In an embodiment auto determining presenting of followed identified unique website or domain name or host name or source or user or account associated posted or published one or more types of content items or message including one or more posts, photos, videos, images, voice, text, location information, emoticons or emoji or stickers, one or more types of file attachments, Uniform Resource Locators (URLs) or web address or short link or profile link and any combinations thereof based on one or more types of user data including current or past search queries, user status, preferences, current or past logged activities, actions, events, transactions, interactions, status, views, clicks, sharing, communications, current or past locations of user's device, checked-in places, enter, stay & exit in geo-fence boundary, one or more types of user reactions including likes, comments, and ratings, date & time, user profile including type of gender, age range, income range, qualification, and any combination thereof.

In an embodiment enabling posting or publishing user to prepare or draft one or more types of contents or message by using client application or in response to request presenting one or more types of contents preparation interface or application or publishing & posting tool or editor or message posting interface or application for enabling posting user or publishing user to prepare or draft one or more types of contents or message and enable to post or publish or present or send said prepared one or more types of contents or message to followers or subscribers or conditional followers or subscribers of posting users.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item comprise at least Uniform Resource Locator (URL) or web address; identifying search result associate unique identity or extracting unique identity based on parsing search result associated Uniform Resource Locator (URL) or web address or metadata; receiving, from a first computing device of a first user, request to follow or subscribe search result item associated identified unique domain name or host name or user or source or associated identified unique account; storing or relating in database, identity of said searching user or requesting user with said identified identity of search result item associated said identified unique domain name or host name or user name or user account; receiving, from a second computing device of the second user, a message for distribution to one or more unspecified recipients; identifying, by a computer processor, the followers of the second user as recipients of the message; and sending the message to the followers of the second user, including the first user.

In an embodiment receiving, from a first computing device of a first user, a search query to search for information on the World Wide Web or search for webpages with information that matches said search query; searching, matching and identifying search results; identifying search result associate unique identity or extracting unique identity based on parsing search result associated Uniform Resource Locator (URL) or web address or metadata; generating search query specific search results, wherein each result comprise search result and embedded or integrated follow or subscribe control or Graphical User interface (GUI) including follow or subscribe button or menu item or icon or link, wherein search result item may comprise title, Uniform Resource Locator (URL) or web address and snippet or rich snippet; serving or presenting said search query specific search results comprise each search result and each search result associated embedded or integrated follow or subscribe control or Graphical User interface (GUI) including follow or subscribe button or menu item or icon or link to a first computing device of a first user; enabling searching user to click or tap on said search result item associated “Follow” or “Subscribe” control or Graphical User interface (GUI); in the event of receiving from a first computing device of a first user a signal indicating activation of follow or subscribe control or Graphical User interface (GUI) including follow or subscribe button or menu item or icon or link associated with particular search result by triggering of clicking or tapping or receiving of haptic contact engagement & release or accessing on follow or subscribe control or Graphical User interface (GUI) including follow or subscribe button or menu item or icon or link, receiving, from a first computing device of a first user, request to follow or subscribe search result item associated identified unique domain name or host name or user or source or associated identified unique account; automatically identifying unique identity of requesting user or searching user or viewing user and identity of said request to follow search result item associated said unique domain name or host name or user name or user account; automatically storing or relating in database or storage medium or at a storage coupled to the server, identity of said searching user or requesting user with said identified identity of search result item associated said identified unique domain name or host name or user name or user account to designating, by a computer processor, the first user as a follower of the second user in response to the request; receiving, from a second computing device of the second user, a message for distribution to one or more unspecified recipients; identifying, by a computer processor, the followers of the second user as recipients of the message; and sending the message to the followers of the second user, including the first user.

In an embodiment presenting sent messages and messages received from following users in chronological order.

In an embodiment enabling following user to view messages or posted content items from followed sources and take one or more actions and reactions including like, dislike, provide one or more types of expression emoticons or emoji or stickers, share, provide comments, ratings, buy, order, book, get appointment, subscribe, install application, send message, make call, register, add to one or more types of list, view source profile.

In an embodiment enabling to unfollow or unsubscribe one or more followed or subscribed users.

In an embodiment user is enable to follow other users of network and allowing other users of network to follow user.

In an embodiment notifying following user about receiving of new message or one or more types of contents posted or published or send by followed sources and notifying user when somebody follow user.

In an embodiment enabling external websites, webpages and applications to embedded or integrate follow or subscribe control or Graphical User interface (GUI) including follow or subscribe button or menu item or icon or link, for enabling searching user to click on search result associated Uniform Resource Locator (URL) or web address or link and visit website or webpage or application or interface and click or tap on said integrated or embedded follow or subscribe control or Graphical User interface (GUI) including follow or subscribe button or menu item or icon or link and follow said search result item associated identified unique account or domain name or host name or user or source to receive each posted or published or broadcasted one or more types of contents or message from said followed unique account or source or user or domain name associate website.

In an embodiment identifying or determining one or more types of contents or feed items based on monitored and tracked search or searching user or search query or search keyword(s) or search results or search result or search session or search instance in multi searching related one or more types of activities, actions, events, transactions, interactions, senses, status, behaviours, connections, communications, collaborations, date & time, locations or places or pre-defined geo-fence boundaries, sharing and reactions and any combination thereof and searching user associated or related one or more types of data or search query or search keyword(s) or search results or search results associated search session or search instance in multi searching related one or more keywords, categories, taxonomy, hashtags, structured content associated field name and associated value or keywords, search result associated URL associated website related keywords, categories, taxonomy, hashtags, metadata, identified keywords related to recognized objects in photos or videos or voice or images and any combination thereof.

In an embodiment real-time update and display or pushed to feed or interface or timeline of viewing user or append to feed or interface or timeline of viewing user said real-time identified or determined one or more types of contents or feed items.

In an embodiment one or more types of contents or feed items sources or sources of one or more types of contents or feed items comprise structured website associated contextual posts, posted by search results associated websites, and applications, posted by connected users of searching user, maintained by search engine's server, searched by search engine, posted by relevant followed sources, posted by contextual users of network, maintained, accessed and posted by 3rd parties' external domains, websites, applications, services, web services, devices, networks, servers, databases, providers.

In an embodiment said identifying or determining one or more types of contents or feed items based on monitored and tracked search or searching user or search query or search keyword(s) or search results or search result or search session or search instance in multi searching related one or more types of activities, actions, events, transactions, interactions, senses, status, behaviours, communications, collaborations, date & time, locations or places or pre-defined geo-fence boundaries, sharing and reactions comprise search result associated URL associated website related one or more types of activities or actions or interactions or senses including viewed or clicked or accessed or searched or navigated products, services, structured information including fields and associated values or data, maps & directions, news, posts and one or more types of contents associated identified keywords and identified keywords related to recognized objects in photos or videos or voice or images, triggering of one or more types of events including, participated events including group deals or groups associated identified keywords, connections including connected users of searching user associated one or more types of user data associated identified keywords, transactions including order, purchase, book, participate in deal or group deal, add to cart one or more products or services associated identified keywords, status or presence information of user associated identified keywords, behaviours including visiting shop or viewing movie or eating type or named food item, listing of song associated keywords associated identified keywords, communications or collaborations including sending and receiving of message associated keywords, call associated recorded voice associated recognized keywords based on voice to text recognition technologies, current date & time associated event or schedule plan or appointment or meeting or festival or particular day associated keywords, keywords related to current location or place of monitored user device or checked-in place or address associated place or entered and stayed in identified pre-defined geo-fence boundary associated keywords, sharing and one or more types of user reactions including like, comments, reviews, ratings, provided one or more types of expression emoticons or emoji or stickers associated products or services or posts or one or more types of contents associated keywords including identified keywords related to recognized objects in said reacted photos or videos or voice or images, wherein keywords comprise categories, sub-categories, taxonomy, hashtags, ontology, tags, metadata, system data, properties, attributes and structured field, field type or field associated data type associated structured value or data and metadata.

In an embodiment search result item may comprise title, Uniform Resource Locator (URL) or web address and snippet.

In an embodiment one or more types of user or connected user associated or related data comprise current location of user device, checked-in location, user provided status, availability status, current one or more types of one or more role of user including user, member, subscriber, customer, prospective customer, student, guest, viewer, seller, buyer, employer, employee, administrator, server, assistant, worker, associate, colleague, service provider, commuter, doctor, engineer, lawyer, account, government employee, advertiser, and friend or contact, interacted or nearest entities or contacts, structured query or requirement or status, search query, monitored, tracked, provided or logged or stored one or more types of activities, actions, senses, preferences, privacy settings, interests, keywords, tags, categories, requirements, search queries, connections, sharing, communications, collaborations, participations, events, user device location associate identified event or one or more types of entities, transactions, behaviours and associated data and metadata, one or more fields and associated one or more types of values including one or more types of forms, user profiles including age, gender, skills, qualifications, interest or hobbies, home & work address or locations, income ranges, liked or dislikes products, entities, contents or content sources & services, education, related named entities including school, college, company, organization, customer profile including used or using or want to use brands, products & services, business profile including type, information, address, offering services or provider of products, job profile, health profile, activity profile, advertisement, entity, brand, product & service profile or information and any combination thereof.

In an embodiment displaying updated one or more types of contents or feed items or posts based on one or more types of order including chronological order, order based on searching user's search result associated one or more types of activities, actions, events, transactions, interactions, senses, status, behaviours, communications, collaborations, date & time, keywords, categories, locations or places or pre-defined geo-fence boundaries, sharing and reactions including clicked search result associated Uniform Resource Locator (URL), visiting website or webpage, spend duration in viewing website or webpage or content, liked website, liked number of products or services or posts or one or more types of contents, booked, buying or bought, ordering or ordered, get appointment, shared, referred, messaging, calls, subscribe, followed, provided comments, ratings and one or more types of reactions or expressions via emoticons, current location or place of monitored user's device and rank based of said identified or determined one or more types of contents or feed items or posts based on number of one or more types of reactions of viewing users on one or more types of contents or feed items or posts including numbers of likes, expressions via emoticons or emoji or stickers, comments, ratings, shares, views, clicks, number of times presented in fed (impressions), added to one or more types of lists, number of following users or connections of said displayed content item or feed item or post associated source, number of customers, number of prospective customers, number of checked-in place associated with said content item or feed item or post associated place or location or address.

In an embodiment storing information about monitored, tracked and logged search or searching user or search query or search keyword(s) or search results or search result or search session related one or more types of activities, actions, events, transactions, interactions, senses, status, behaviours, communications, collaborations, date & time, locations or places or pre-defined geo-fence boundaries, sharing and reactions and any combination thereof.

In an embodiment real-time identifying or determining, generating, updating and displaying feed items in feed based on monitored, tracked and logged search or searching user or search query or search keyword(s) or search results or search result or search session related one or more types of activities, actions, events, transactions, interactions, senses, status, behaviours, communications, collaborations, date & time, locations or places or pre-defined geo-fence boundaries, sharing and reactions and any combination thereof.

In an embodiment one or more types of contents comprise a post, an feed item, a photo, a video, an image, a voice file, text, location information, emoticons or emoji or stickers, one or more types of file attachments, Uniform Resource Locators (URLs) or web address or short link or profile link, live stream or live video, one or more types of actions and reaction controls or Graphical User Interface (GUIs), multimedia file, one or more types of structured contents including forms, profile, field and associated data type specific values or data, structured website and any combinations thereof.

In an embodiment displaying said identified or determined one or more types of contents or feed items for transitory period of time and in the event of triggering or identification or update of particular predefined action or event or status or location or remove or hide said displayed one or more types of contents or feed items including display said for pre-set view duration, wherein view duration can set by server or default or set by searching user or set by provider or publisher of feed item and in the event of expiration of timer remove or hide said displayed one or more types of contents or feed items, display up-to next searching or entering new or next search query in search box and in the event of entering or inputting or selecting new search query, remove or hide said displayed one or more types of contents or feed items, display up-to click on next page of search result and in the event of click or tap on next page of search results, remove or hide said displayed one or more types of contents or feed items, display up-to one or more entered or selected search queries are substantial identical based on broad match, phrase match and exact match and in the event of identification of different search queries, remove or hide said displayed one or more types of contents or feed items, display up-to user logged-in or up-to particular type of user's status or presence information and in the event of log-out or identification of pre-defined type of status or presence information, remove or hide said displayed one or more types of contents or feed items, display up-to user close the search application or webpage and in the event of close the search application or webpage, remove or hide said displayed one or more types of contents or feed items, display up-to end of search session and in the event of ending of session, remove or hide said displayed one or more types of contents or feed items, display up-to change of place or location or display start from user enter into, stay and display up-to exit from pre-defined geo-fence boundary and in the event of identification of new place or new type of location or exit from geo-fence boundary, remove or hide said displayed one or more types of contents or feed items, display for pre-set number of times of view and in the event of after said pre-set maximum number of time of views, remove or hide said displayed one or more types of contents or feed items, display non-viewed said identified or determined one or more types of contents only, not display mark as viewed or watched or read said identified or determined one or more types of contents, display up-to closing of searched result item associated clicked or tapped or accessed Uniform Resource Locator (URL) or web address or link associated website or webpage or section or feature of website or application and in the event of close, remove or hide said displayed one or more types of contents or feed items, display up-to change of type of content search including web, images, videos, news, blogs, maps and the event of changing of type of search, remove or hide said displayed one or more types of contents or feed items, display up-to close of browser or search website or search webpage or search application or feed webpage or feed application and in the event of closing of browser or search website or search webpage or search application or feed webpage or feed application, remove or hide said displayed one or more types of contents or feed items, in the event of exceeding pre-set limit of number of maximum displayed said one or more types of content items or posts, remove or hide said exceeded displayed one or more types of contents or feed items based on date & time or remove exceeded displayed one or more types of contents or feed items based on first displayed first removed order and enabling user to manually bookmark, save, share, connect or follow feed item or post associated source, react and delete currently generated or displayed or current search session related feed or one or more selected feed items.

In an embodiment displaying said identified or determined one or more types of contents or feed items based on selection of one or more search queries, categories, locations or place, date & time range of searching, keywords and any combination thereof.

In an embodiment displaying said updated identified or determined one or more types of contents or feed items beside search results in desktop application or online web based application or displaying said updated identified or determined one or more types of contents or feed items in prominent place of search results or search application or search interface or search application or displaying said updated identified or determined one or more types of contents or feed items on or overlays on search results and enabling user to show or hide updated feed items on or overlays on search results in mobile application.

In an embodiment enabling user to take one or more actions including share, follow, add to list, add to contact, send message, chat, call, fill forms, become members, buy or order product, subscribe service, install application, book, reservation, get appointment, participate in deal, send requirement specification for request for quote, view photo or video or post, view profile, click and visit website or web page and reactions including like, dislike, provide emoticons, comment, ratings, reviews on feed item.

In an embodiment said identifying or determining one or more types of contents or feed items or sources of one or more types of contents or feed items based on past search queries, one or more types of user or connected users of user related or associated data or digital contents, current trends, contextual advertisements, past reacted one or more types of contents or posts or sources of one or more types of contents or feed items including liked, provided expressions in the form of emoticons or stickers, commented, shared, referred, bookmarked, added to list, saved, viewed, rated, followed, connected, checked-in place of source of content, provided indication of customers or prospective customers related one or more types of contents or posts and associated sources, user preferences including categories, keywords, tags, hashtags, locations, places, interests, type and named sources, range of date & time of posted contents, ranked or most reacted including most liked, rated, comments, shared, viewed, purchased, subscribed, ordered, installed, downloaded, booked, participated and settings including type of content.

In an embodiment filter feed or feed items comprises filter feed or feed items based on one or more locations, places, geo-fence boundaries, supplied or provided object model or image or scanned image or code including QRcode specific, date & time or range of date & time, not viewed, viewed, new, rank specific, source type or source name wise, connected or followed sources, rank wise, user acted including bought, ordered, booked, shared, followed, connected, added to list or reacted including liked, commented, rated source wise, type of content wise, one or more keyword or search query or similar search queries or categories wise one or more types of contents or feed items or posts.

In an embodiment sort feed or feed items based on chronological, date & time wise, source type or source name wise, connected or followed sources, rank wise, user acted including bought, ordered, booked, shared, followed, connected, added to list or reacted including liked, commented, rated source wise, type of content wise, one or more keyword or search query or similar search queries or categories wise one or more types of contents or feed items or posts.

In an embodiment identifying search result associate unique identity or determining or extracting unique identity based on parsing search result associated Uniform Resource Locator (URL) or web address or metadata; receiving, from a first computing device of a first user, request to connect search result item associated identified unique domain name or host name or user or source or associated identified unique account; and storing or relating in database, identity of said searching user or requesting user with said identified identity of search result item associated said identified unique domain name or host name or user name or user account.

In an embodiment storing or relating in database, identity of said searching user or requesting user with said identified identity of search result item associated said identified unique domain name or host name or user name or user account and type of network including social network or business or professional or customer network.

In an embodiment receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item comprise at least Uniform Resource Locator (URL) or web address.

In an embodiment receiving, from a second computing device of the second user, a message for distribution to all or selected one or more or one or more selected groups of connected users or connections of user; identifying, by a computer processor, the said all or selected connections of the second user as recipients of the message; and sending the message to the said all or selected connections of the second user, including the first user.

In an embodiment identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

In an embodiment display in feed or user's timeline connected users of user or connected sources associated posted or published each one or more types of content items or message including one or more posts, photos, videos, images, voice, text, location information, emoticons or emoji or stickers, one or more types of file attachments, Uniform Resource Locators (URLs) or web address or short link or profile link and any combinations thereof.

In an embodiment enabling user to filter user's connections based on one or more types of profile fields including age, age range, gender, interest, education, qualification, skill, position, company, organization, school, college, group, location, place, address, rank, favorite, categories, type of connection including friends, classmate, relatives, family, followers, business, industry, partners, professional, employees, colleagues, associates, customers, prospective customers, customers or prospective customers related to particular product or service, guests, clients, members, viewers, visitors, attendees, subscribers, student, patients and type of role or job or business or service.

In an embodiment enabling user to send message or post or one or more types of contents to said one or more selected types of filter specific or filtered or select from filtered connections of user.

In an embodiment enabling user to prepare or draft one or more types of contents or message by using client application or in response to request, presenting one or more types of contents preparation interface or application or publishing & posting tool or editor or message posting interface or application for enabling user to prepare or draft one or more types of contents or message and enable to post or publish or present or send said prepared one or more types of contents or message to all or selected one or more or one or more selected groups of connected users or connections of user.

In an embodiment enabling connected users to communicate with each other, send and receive messages, posts, make call, share profile, request recommendation, recommend or refer, view profile, follow, unfollow, remove connection, invite to join particular group or event, save profile, report or block.

In an embodiment enable invitee to delete inviter's request to connect with invitee or ignore received connection request or in the event of rejection of connection request by invitee inform about rejection to searching user or inviter or invitor.

In an embodiment identifying search result associate unique identity or determining or extracting unique identity based on parsing search result associated Uniform Resource Locator (URL) or web address or metadata; receiving, from a first computing device of a first user, invitation to connect search result item associated identified unique domain name or host name or user or source or associated identified unique account; send said invitation to said search result item associated identified unique domain name or host name or user or source or associated identified unique account; and in the event of acceptance of said invitation by search result item associated identified unique domain name or host name or user or source or associated identified unique account, storing or relating in database, identity of said searching user or requesting user with said identified identity of search result item associated said identified unique domain name or host name or user name or user account.

In an embodiment receiving, from a first computing device of a first user, a search query to search for information on the World Wide Web or search for webpages with information that matches said search query; searching, matching and identifying search results; identifying search result associate unique identity or extracting unique identity based on parsing search result associated Uniform Resource Locator (URL) or web address or metadata; generating search query specific search results, wherein each result comprise search result and embedded or integrated connect control or Graphical User interface (GUI) including connect button or menu item or icon or link, wherein search result item may comprise title, Uniform Resource Locator (URL) or web address and snippet or rich snippet; serving or presenting said search query specific search results comprise each search result and each search result associated embedded or integrated connect control or Graphical User interface (GUI) including connect button or menu item or icon or link to a first computing device of a first user; enabling searching user to click or tap on said search result item associated “Connect” or “Add Friends” or “Add to Contacts” or “Mutual Follow” or “I am Customer” or “I am Prospective Customer” control or Graphical User interface (GUI); in the event of receiving from a first computing device of a first user a signal indicating activation of connect control or Graphical User interface (GUI) including connect button or menu item or icon or link associated with particular search result by triggering of clicking or tapping or receiving of haptic contact engagement & release or accessing on connect control or Graphical User interface (GUI) including connect button or menu item or icon or link, receiving, from a first computing device of a first user, request to connect search result item associated identified unique domain name or host name or user or source or associated identified unique account; automatically identifying unique identity of requesting user or searching user or viewing user and identity of said request to connect search result item associated said unique domain name or host name or user name or user account; and automatically storing or relating in database or storage medium or at a storage coupled to the server, identity of said searching user or requesting user with said identified identity of search result item associated said identified unique domain name or host name or user name or user account to designating, by a computer processor, the first user as a connection of the second user in response to the request.

In an embodiment send invitation to connect search result item associated said identified unique domain name or host name or user name or user account and in the event of acceptance of invitation to connect, automatically storing or relating in database or storage medium or at a storage coupled to the server, identity of said searching user or requesting user with said identified identity of search result item associated said identified unique domain name or host name or user name or user account to designating, by a computer processor, the first user as a connection of the second user in response to the request.

In an embodiment receiving, from a second computing device of the second user, a message for distribution to all or selected one or more or one or more selected groups of connected users or connections of user; identifying, by a computer processor, said all or selected one or more or one or more selected groups of connected users or connections of user of the second user as recipients of the message; and sending the message to the said to all or selected one or more or one or more selected groups of connected users or connections of user of the second user, including the first user.

In an embodiment identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

In an embodiment enabling connected users to communicate with each other, send and receive messages, posts, make call, share profile, request recommendation, recommend or refer, view profile, remove connection, remove connection, invite to join particular group or event, save profile, report or block.

In an embodiment enabling user to search other users of network and connect with selected one or more users of network or send invitation to connect to selected one or more users of network and in the event of acceptance of invitation, connect said invitation accepted user with said invitation sender, wherein notifying inviter about acceptance of connection by invitee.

In an embodiment enabling external websites, webpages and applications to embedded or integrate connect control or Graphical User interface (GUI) including connect button or menu item or icon or link, for enabling searching user to click on search result associated Uniform Resource Locator (URL) or web address or link and visit website or webpage or application or interface and click or tap on said integrated or embedded connect control or Graphical User interface (GUI) including connect button or menu item or icon or link and connect said search result item associated identified unique account or domain name or host name or user or source.

In an embodiment receiving, from a first computing device of a first user, indication of customer or prospective customer of search result item associated said identified unique domain name or host name or website or user name or user account; storing said identity of said provider of indication of customer or prospective customer of search result item associated identified unique domain name or host name or website or user name or user account with identity of said search result item associated identified unique domain name or host name or website or user name or user account.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic. One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines. Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a network diagram depicting a network system having a client-server architecture configured for exchanging data over a network implementing various embodiments of in-search structured contents, actions & reactions and real-time communication system including components of an electronic device implementing Site Management system, Search Result with Site related contents, actions & reactions system, Monitoring searching activities and actions and Generating feed based on monitored search related activities and actions, Monitoring and presenting searching activities and actions and enabling associated communication.

FIG. 2 illustrates components of an electronic device implementing various embodiments of in-search structured contents, actions & reactions and real-time communication system.

FIG. 3 illustrates logical structure of site comprise site associated structured information, actions and reactions controls & Graphical User Interface (GUIs), integrated online application or webpage Uniform Resource Locator (URL) or link or smart client application, categories of post and associated structured information, actions and reactions controls & Graphical User Interface (GUIs), posts or structured posts or content items including one or more photos, videos, text, location information, event, product or service details, album, carousal, canvas, slideshow, and associated actions and reactions controls & Graphical User Interface (GUIs), named webpage Uniform Resource Locator (URLs), integrated online application or webpage Uniform Resource Locator (URL) or link or smart client application.

FIGS. 4-13 illustrates Graphical User Interface (GUIs) for enabling publisher or advertiser or user or website owner to create site or structured site or website or structured website or structured one or more types of set of contents including associated structured information, actions and reactions controls & Graphical User Interface (GUIs), integrated online application or webpage Uniform Resource Locator (URL) or link or smart client application, categories of post or pages and associated structured information, actions and reactions controls & Graphical User Interface (GUIs), posts or structured posts or content items including one or more photos, videos, text, location information, event, product or service details, album, carousal, canvas, slideshow, and associated actions and reactions controls & Graphical User Interface (GUIs), named webpage Uniform Resource Locator (URLs), integrated online application or webpage Uniform Resource Locator (URL) or link or smart client application.

FIG. 14 illustrates Graphical User Interface (GUIs) showing search query specific search result with each search result item associated site or structured site or website or structured website or structured one or more types of set of contents for enabling searching user to view posts, photos, videos, text, location information, number of various types of reactions including number of likes, comments, reviews, average ratings, shares, reactions controls & Graphical User Interface (GUIs) including like button to like site or post or content item or source, comment textbox to provide comments & reviews on post or content item or source, rate site or post or content item or source, actions controls & Graphical User Interface (GUIs) including view profile, access online or web application or web page.

FIG. 15 illustrates map Graphical User Interface (GUIs) showing plotted map associated location or place or displayed icon associated or search query associated site or structured site or website or structured website or structured one or more types of set of contents.

FIG. 16 illustrates Search Graphical User Interface (GUIs) for enabling user to search based on provided search query. System monitors and tracks search query specific search result associated one or more types of activities, actions, status, events, reactions and transactions.

FIG. 17 illustrates Graphical User Interface (GUIs) showing generated or updated feed or set of contents or contextual sites or structured sites or websites or structured websites or structured one or more types of set of contents based on said monitored or tracked and stored one or more types of activities, actions, status, events, reactions and transactions.

FIGS. 18-19 illustrates Communication Graphical User Interface (GUIs) enabling search result item associated advertiser or company or product or service seller or website to communicate, collaborate, share, participate, present, provide offers, negotiate with searching user and enable searching user to conduct one or more types of actions and reactions based on presented or updated details or data or information related to search result item associated monitored, tracked and stored one or more types of activities, actions, status, events, reactions and transactions.

FIG. 20 illustrates Search Graphical User Interface (GUIs) enabling searching user to search and enable to follow, view profile, view sites, view posts or one or more types of contents, provide one or more types of reactions, take one or more actions, connect with search query specific search result item associated source or website.

FIG. 21 illustrates Graphical User Interface (GUIs) related to particular advertiser, brand, product, service, company, source, account, user and website to enabling viewing users or followers or searching user to views posts or one or more types of contents posted by advertiser, brand, product, service, company, source, account, user and website.

FIG. 22 illustrates Search Graphical User Interface (GUIs) enabling searching user to search and enable to follow, view profile, view sites, view posts or one or more types of contents, provide one or more types of reactions, take one or more actions, connect with search query specific search result item associated source or user or account.

FIG. 23 illustrates Graphical User Interface (GUIs) related to particular account or user to enabling viewing users or followers or searching user to views posts or one or more types of contents posted particular user.

FIG. 24 illustrates example taxonomy of structured site or website categories.

FIG. 25 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

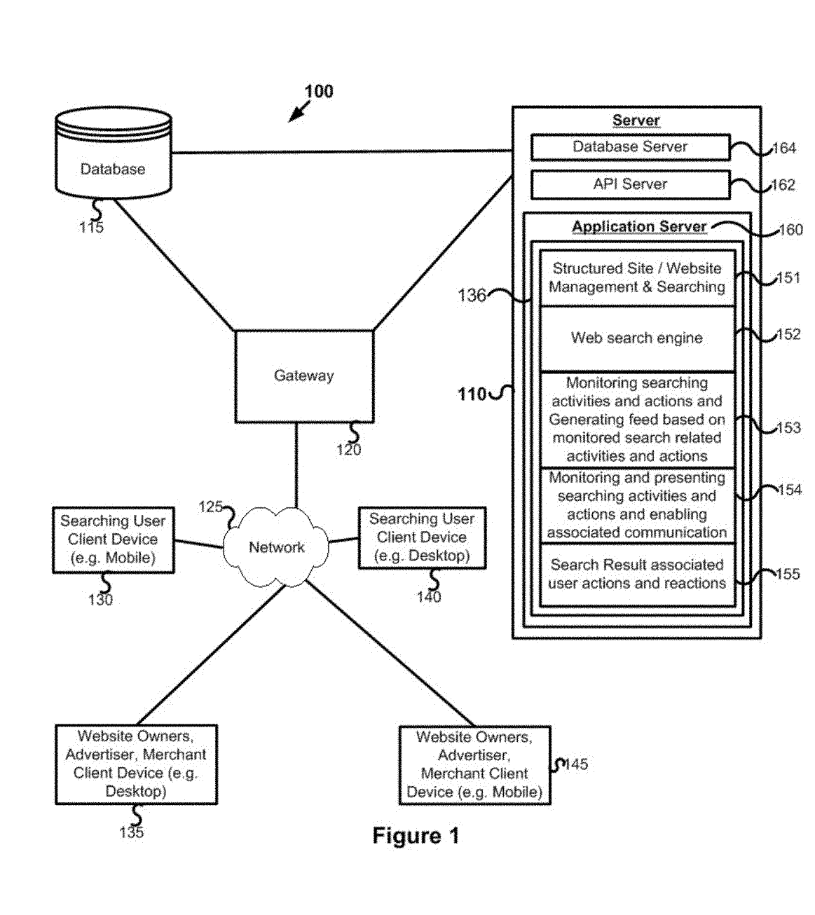

FIG. 1 illustrates an example in-search structured content, actions & reactions and real-time communication system and searching platform, under an embodiment. According to some embodiments, system 100 can be implemented through software that operates on a portable computing device, such as a mobile computing device 110. System 100 can be configured to communicate with one or more network services, databases, objects that coordinate, orchestrate or otherwise provide search results, search results associated structured contents or sites and associated posts, actions and reaction controls, monitoring searching activities and actions and Generating feed based on monitored search related activities and actions, monitoring and presenting searching activities and actions and enabling associated communication and search Result associated user actions and reactions. Additionally, the mobile computing device can integrate third-party services which enable further functionality through system 100.

The system for presenting search results and associated structured contents or sites for enabling searching user to view search result item associated website or source associated one or more types of contents including posts, photos, videos, product details, service details, menu, album, carousal, canvas, slideshow, survey, poll, online application, and associated one or more types of user actions and reaction controls or Graphical User Interface (GUIs) for taking one or more actions and reactions. While FIG. 1 illustrates a gateway 120, a database 115 and a server 110 as separate entities, the illustration is provided for example purposes only and is not meant to limit the configuration of the in-search structured content, actions & reactions and real-time communication system. In some embodiments, gateway 120, database 115 and server 110 may be implemented in the in-search structured content, actions & reactions and real-time communication system as separate systems, a single system, or any combination of systems.

As illustrated in FIG. 1, the in-search structured content, actions & reactions and real-time communication system may include a searching user device or mobile devices 130/140 and website owner or website user device or mobile devices 135/145. Devices or Mobile devices 130/140/135/145 may be particular set number of or an arbitrary number of devices or mobile devices which may be capable of searching, viewing, presenting, posting, sharing, publishing, broadcasting, advertising, sending, presenting, matching, accessing and managing search results, associated structured contents or structured sites or shared or followed or posted contents to searching users or viewers or users or followers or users of network. Each device or mobile device in the set of searching or viewing user(s) 130/140 and communicating user(s) including website owners, administrators, advertisers, sellers' device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the in-search structured content, actions & reactions and real-time communication system may include gateway 120. Gateway 120 may be a web gateway which may be configured to communicate with other entities of the in-search structured content, actions & reactions and real-time communication system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of in-search structured content, actions & reactions and real-time communication system. In various embodiments, gateway 120 may be connected to database 115 and/or server 110 via a wired or a wireless network connection.

Gateway 120 may be configured to send and receive search queries, search results, posted contents, search results associated structured contents or updated structured contents including posts, videos, photos, text, location information, products or services details, event details to searching users, followers, and searching users based on monitored search activities and actions to/from mobile devices 130/140/135/145. Gateway 120 may be configured to send and receive one or more types of user data comprises user profile, user connections, connected users' data, user shared data or contents, user logs, activities, actions, events, senses, transactions, status, updates, presence information, locations, check-in places and like to/from mobile devices 130/140/135/145. For example, gateway 120 may be configured to receive search queries and receive information or logged data about monitored or tracked search related activities, actions, status, events, reactions and transactions of searching user from client devices 130/140, receive structured contents posted and updated by web site owner or admins or advertiser or publisher from client devices 135/145, receive information from web crawler from crawled websites of internet to database 115 for storage, wherein web crawling or spidering software update their web content or indices of others sites' web content. Web crawlers copy pages for processing by a search engine which indexes the downloaded pages so users can search more efficiently.

As another example, gateway 120 may be configured to serve or send search query specific un-structured contents including matched content from searched webpage, snippet or rich snippet with structured contents or structured site including collection of categories posts, photos, videos, multimedia, texts, locations and associated actions and reactions controls or GUIs to searching user, requesting user, followers and viewers stored in database 115 to mobile devices 130/140. Gateway 120 may be configured to receive search requests from mobile devices 130/140 for searching and presenting structured contents with search result.

For example, gateway 120 may receive a request from a mobile device and may query database or index database or sabotage medium 115 with the request for searching and matching request specific or search query specific matched search results, structured contents or structured site contents, sources, contacts, followers, and users of networks. Gateway 120 may be configured to inform server 110 of updated data. For example, gateway 120 may be configured to notify server 110 when a new or updated post, site, logged activities, actions, events, transactions, status, reactions has been received from a mobile device or device of website owner or posting or publishing or content broadcaster(s) or provider(s) stored on database 115.

As illustrated in FIG. 1, the in-search structured content, actions & reactions and real-time communication system may include a database, such as database 115. Database 115 may be connected to gateway 120 and server 110 via wired and/or wireless connections. Database 115 may be configured to store a database of registered user's profile, accounts, posted or shared contents, sites, followed sources, user data including logged activities, actions, events, transactions, reactions, status, communication, sharing, updates, behaviours, searching activities and payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, search query specific search result, search query specific contents of structured site including posts, photos, videos, multimedia, text, links or URLs, location information, actions and reactions controls and GUIs, user profile, user data, posted or shared contents, user followers, following users, viewers, contacts or connections, reacted users profile, number of reactions related to particular type of reaction, user or provider account's related data which meet the criteria specified in the request. Database 115 may be configured to communicate with server 110.

As illustrated in FIG. 1, the in-search structured content, actions & reactions and real-time communication system may include a server, such as server 110. Server may be connected to database 115 and gateway 120 via wired and/or wireless connections. As described above, server 110 may be notified, by gateway 120, of new or updated site content, user profile, user data, user posted or shared contents, actions and reactions, user followed sources and various types of status stored in database 115.

FIG. 1 illustrates a block diagram of the in-search structured content, actions & reactions and real-time communication system configured to implement the platform where user(s) can search crawler based un-structured contests, semi structured or rich snippets and structured contents or structured site or website associated structured contents, posts, photos, video, data, and associated actions and reactions controls or GUIs to searching user, followers, and requesting or viewing users. While FIG. 1 illustrates a gateway 120, a database 115 and a server 110 as separate entities, the illustration is provided for example purposes only and is not meant to limit the configuration of the in-search structured content, actions & reactions and real-time communication system. In some embodiments, gateway 120, database 115 and server 110 may be implemented in the publishing or broadcasting or advertising user contents and searching or viewing or requesting user as separate systems, a single system, or any combination of systems.

The server 110 stores database server 164, API server 162 and application server 160 which stores applications, modules, services, APIs, web services 136 including Structured Site/Website Management & Searching 151, Monitoring searching activities and actions and Generating feed based on monitored search related activities and actions 153, Monitoring and presenting searching activities and actions and enabling associated communication 154, Search Result associated user actions and reactions 155 to implement operations of various embodiments of the invention and may include executable instructions to access a client device which coordinates operations disclosed herein. Alternately, may include executable instructions to coordinate some of the operations disclosed herein, while the client device implements other operations.

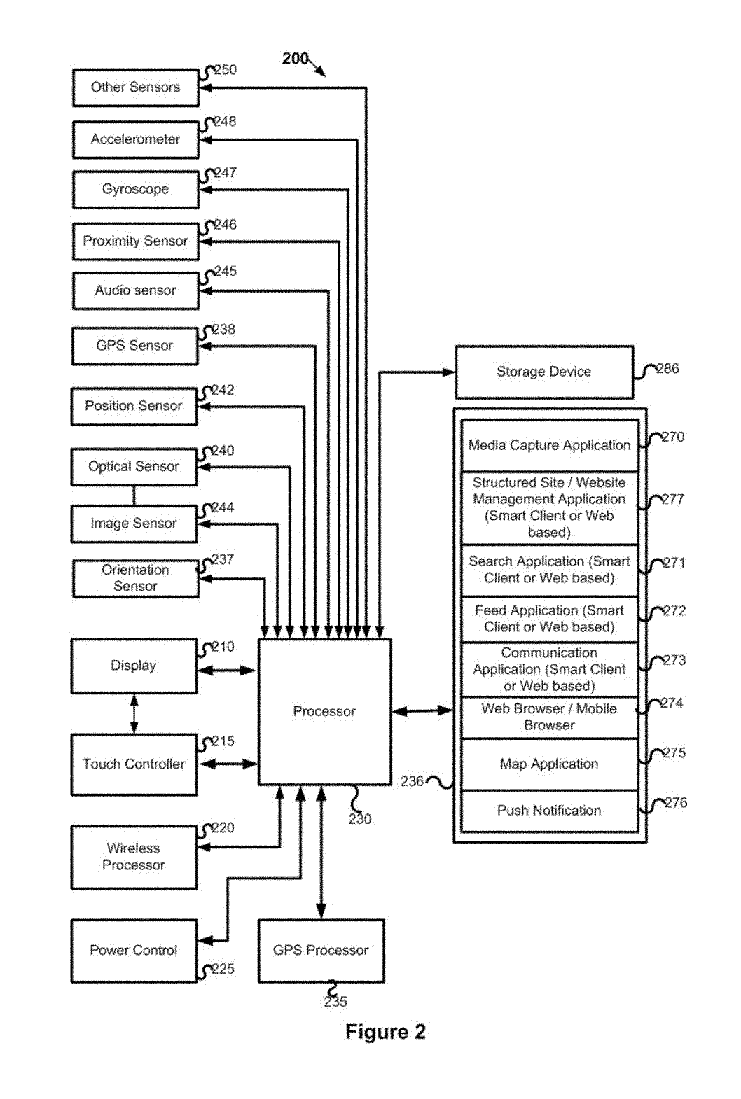

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores Structured Site/Website Management Application (Smart Client or Web based) 277 to implement operations of one of the embodiment of the invention. The Structured Site/Website Management Application (Smart Client or Web based) 277 may include executable instructions to access a client device and/or a server which coordinates operations disclosed herein. Alternately, the Structured Site/Website Management Application (Smart Client or Web based) 277 may include executable instructions to coordinate some of the operations disclosed herein, while the server implements other operations.

The memory 236 stores a Search Application (Smart Client or Web based) 271 to implement operations of one of the embodiment of the invention. The Search Application (Smart Client or Web based) 271 may include executable instructions to access a client device and/or a server which coordinates operations disclosed herein. Alternately, the Search Application (Smart Client or Web based) 271 may include executable instructions to coordinate some of the operations disclosed herein, while the server implements other operations.

The memory 236 stores a Feed Application (Smart Client or Web based) 272 to implement operations of one of the embodiment of the invention. The Feed Application (Smart Client or Web based) 272 may include executable instructions to access a client device and/or a server which coordinates operations disclosed herein. Alternately, the Feed Application (Smart Client or Web based) 272 may include executable instructions to coordinate some of the operations disclosed herein, while the server implements other operations.

The memory 236 stores a Communication Application (Smart Client or Web based) 273 to implement operations of one of the embodiment of the invention. The Communication Application (Smart Client or Web based) 273 may include executable instructions to access a client device and/or a server which coordinates operations disclosed herein. Alternately, the Communication Application (Smart Client or Web based) 273 may include executable instructions to coordinate some of the operations disclosed herein, while the server implements other operations.

The memory 236 stores a Web Browser/Mobile Browser 274 to implement operations of one of the embodiment of the invention. The Web Browser/Mobile Browser 274 may include executable instructions to access a client device and/or a server which coordinates operations disclosed herein. Alternately, the Web Browser/Mobile Browser 274 may include executable instructions to coordinate some of the operations disclosed herein, while the server implements other operations.

The memory 236 stores a Map Application 275 to implement operations of one of the embodiment of the invention. The Map Application 275 may include executable instructions to access a client device and/or a server which coordinates operations disclosed herein. Alternately, the Map Application 275 may include executable instructions to coordinate some of the operations disclosed herein, while the server implements other operations.

The memory 236 stores a Push Notification Application 276 to implement operations of one of the embodiment of the invention. The Push Notification Application 276 may include executable instructions to access a client device and/or a server which coordinates operations disclosed herein. Alternately, the Push Notification Application 276 may include executable instructions to coordinate some of the operations disclosed herein, while the server implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the structured site/website management application, search application 271, feed application 272 and communication application 273 operating in conjunction with a server.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage 236, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application 270.

The media capture application 270 includes executable instructions to generate media items such as pictures and videos using the optical sensor 240 or image sensor 244. The media capture application 270 also associates a media item with the geolocation and the position of the mobile device 200 at the time the media item is generated using the GPS sensor 238 and the position sensor 242.

The storage 236 includes a memory that may be or include flash memory, random access memory, any other type of memory accessible by the processor 230, or any suitable combination thereof. The storage 236 stores the media items generated or shared or received by user and also store the corresponding geolocation information, auto identified system data including date & time, auto recognized objects in photo or image(s) of video associated keywords, metadata, and user provided information. The storage 236 also stores executable instructions corresponding to

the Search Application (Smart Client or Web based) 271, Feed Application (Smart Client or Web based) 272, Communication Application (Smart Client or Web based) 273, Web Browser/Mobile Browser 274, Map Application 275 and Push Notification 276.

The display 210 includes, for example, a touch screen display. The display 210 displays the media items generated by the media capture application 270. A user captures, records and selects media items for preparing structured website or site or adding to one or more types of pages or posts or feeds, stories or galleries by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

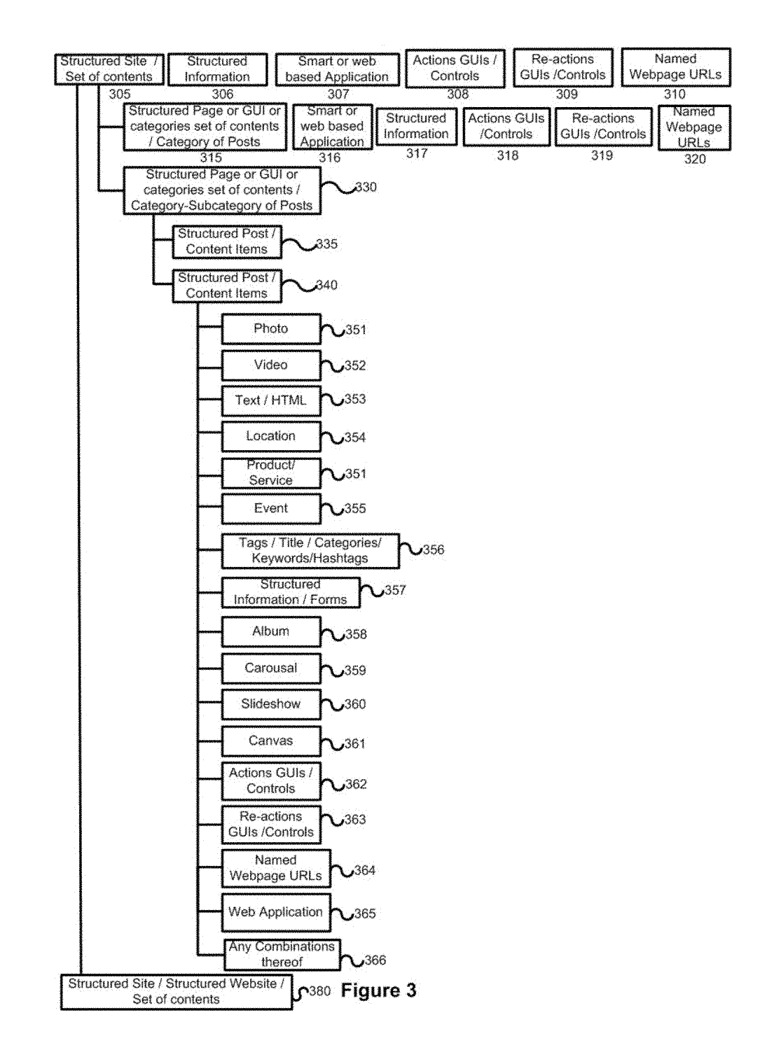

FIG. 3 illustrates typical structure of structured site or structured website. In an embodiment a structured site or structured website 305 is a collection of structured pages or structured categories of posts 315/330, each page or category 330 specific structured post 340 and each post 340 associated one or more types of contents, multimedia, actions and reactions controls or Graphical User Interfaces (GUIs) including photos 351, videos 352, voice, text 353, links, namespace of structured content, web address or Uniform Resource Locator (URL) or named URLs 364, location information 354, categories, tags & keywords 356, emoticons or emoji or stickers, structured product details 351, structured service details, structured event details 355, album 358, carousal 359, slideshow 360, stories, gallery, canvas 361, one or more types of contents and multimedia, associated one or more types of named Uniform Resource Locators (URLs) 364, actions 362 and reaction 363 controls and Graphical User Interface (GUI) and any combination thereof, structured site comprise structured information or data or one or more types of contents 306, associated smart client application or web application 365, structured site 305 associated one or more types of actions 308 and reaction 309 controls and Graphical User Interface (GUI) and web application or smart client application 307, structured page 315 comprise structured information or data or one or more types of contents 317, associated smart client application or web application 316, associated one or more types of actions 318 and reaction 319 controls and Graphical User Interface (GUI) and named URLs 320. In an embodiment structured site or structured website 305 can linked with other structured site or structured website 380.

In an embodiment structured site or structured website is identified by domain name, Uniform Resource Locator (URL) or web address, namespace, one or more types of unique identity including e-mail address, user identity, GUID, phone number, auto generated unique identity, current website's related domain name or host name, current website's related domain name with (e.g. If current website name is “www.GUCCI.com” then unique identity of structured site or structured website is “site. GUCCI” OR “www.site.com/GUCCI” OR “@GUCCI”.

In an embodiment structured pages of structured site or structured website access via name, category, keyword, title, link or namespace. In an embodiment the server(s) 110 associated database(s) or storage medium 115 maintains structured website or structured site's structure or data related to structured website or structured site or both. In an another embodiment the server 110 associated database(s) or storage medium 115 maintains only structure of structured website or structured site and data of structured website or structured site maintains by server(s) & associated database(s) of or 3^{rd} parties hired sever(s) & associated database(s) by owner of structured website or structured site. In an embodiment the server 110 maintains index of contents of structured site or structured website including structured information, site associated data, text, locations, check-in place, comments, profile, URLs or links, categories, tags, hashtags, keywords, attached files, metadata and system data.

In an embodiment the server 110 maintains index of photos, videos of structured site or structured website based on recognized or identified objects in photos, videos and voice associated identified keywords.

In an another embodiment structured site or structured website owner can maintains one or more web applications on their server(s) or 3^{rd} parties server(s) and add one or more web applications with their structured site or structured website for making them available to their users.

In an another embodiment structured site or structured website owner can maintains one or more actions and reactions controls and Graphical User Interfaces (GUIs) on their server(s) or 3^{rd} parties server(s) and add one or more with their structured site or structured website, associated one or more structured pages and associated one or more structured posts or contents for making them available to their users.

In an embodiment structured site or structured website owner can maintains structure of structured site or structured website, based on standards, rules, privacy defined by server 110, on their server(s) or 3^{rd} parties server(s) and link to search engine associated account or website.

In an embodiment structured site or structured website owner can maintains structure of structured site or structured website, based on standards, rules, privacy defined by server 110, on their server(s) or 3^{rd} parties server(s) and search engine or server 110 identifies link of said structured site or structured website.

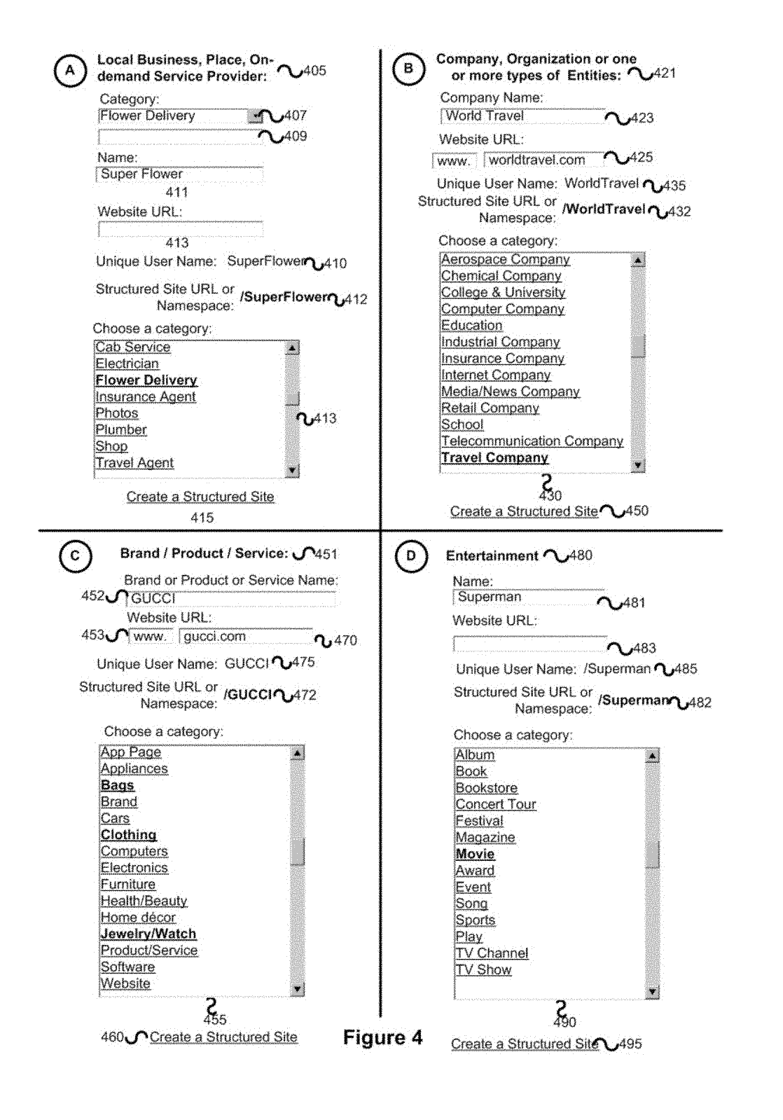

FIG. 4 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) for enabling user or website owner or advertiser to create one or more types of named structured site or structured website. In an embodiment user can sign-up or register with server 110, wherein registration details may comprise first name & last name, age, gender, phone number, email address, one or more social network account names or user names or links of profiles including Facebook™, Twitter™, Linked-In™, Instagram™, Snapchat™ and Google+™ user name or link of profile for creating personal account and company name, brand, product, service, shop or local business or place name, contact address, phone number, email address, website address. After registration and verification via mobile OTP, enabling user to log-in to access Graphical User Interface (GUI) to create one or more types of named structured site or structured website. User can select type of structured site or structured website including local business or place 405, company, organization, institution and entity 421, brand or product or service 431, personal or celebrities 501 an entertainment 530.

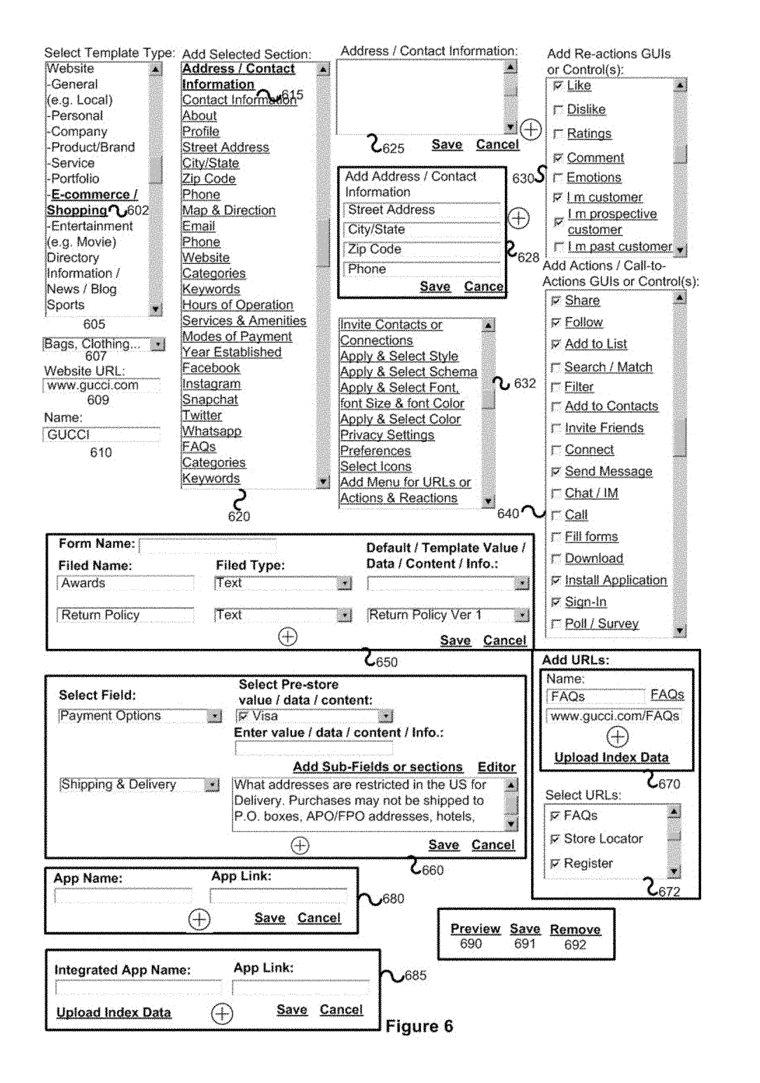

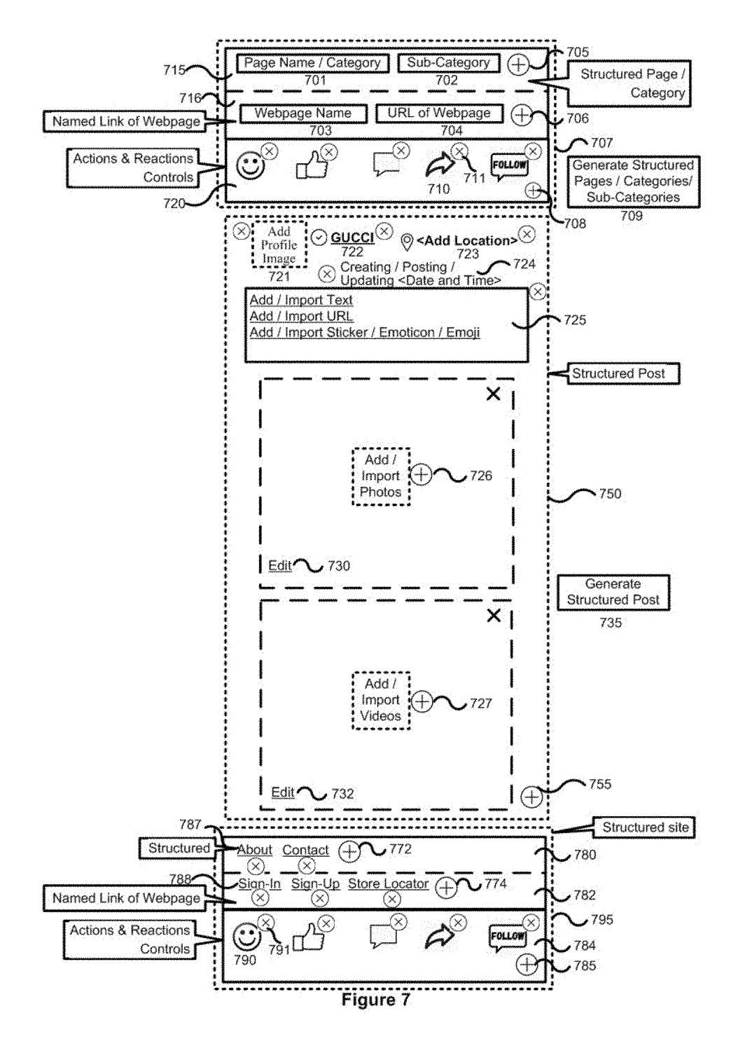

For example user or enterprise user or website owner can select type local business or place 405 and can input 409 or select 407 one or more categories 407/409/FIGS. 6-7, provide name 411 (e.g. name of shop or place or mall), provide website Uniform Resource Locator (URL) or web address 413 and starts to create structured site or website via tapping or clicking on create structured site or website icon or link or button 415. In an embodiment creating unique Uniform Resource Locator (URL) (e.g. 412) of structured site or website based on extracted domain name from website URL 413 or unique user name 410.

In an embodiment in the event of no website, user can use unique name of structured site or website and search engine use structured data of structured site or website to matches search query of searching user with said unique named structured data of structured site or website and present in search result item related to said structured data of structured site or website.

In an embodiment in the event of non-registered user, search engine use unique name of structured site or website as unique identity of user. In an embodiment in the event of non-registered user and in the event of no website, search engine use unique name of structured site or website as unique identity of user as well as search result item associated website or title.

In another example user or enterprise user or website owner can select type company, organization, institution and entity 421 and can select or input one or more categories 430/FIGS. 6-7, company name 423, website Uniform Resource Locator (URL) or web address 425 and starts to create structured site or website via tapping or clicking on create structured site or website icon or link or button 450. In an embodiment creating unique Uniform Resource Locator (URL) (e.g. 432) of structured site or website based on extracted domain name from website URL 425 or unique user name 435.

In another example user or enterprise user or website owner can select type brand or product or service 451 and can select or input one or more categories 455/FIGS. 6-7, brand or product or service name 452, website Uniform Resource Locator (URL) or web address 453 and starts to create structured site or website via tapping or clicking on create structured site or website icon or link or button 460. In an embodiment creating unique Uniform Resource Locator (URL) (e.g. 472) of structured site or website based on extracted domain name from website URL 453 or unique user name 475.

In another example user or enterprise user or website owner can select type entertainment 480 and can select or input one or more categories 490/FIGS. 6-7, name 483, website Uniform Resource Locator (URL) or web address 483 and starts to create structured site or website via tapping or clicking on create structured site or website icon or link or button 495. In an embodiment creating unique Uniform Resource Locator (URL) (e.g. 482) of structured site or website based on extracted domain name from website URL or unique user name 485.

In an embodiment server 110 can identify domain name based on website name or URL and can assign said domain name as unique identity of structured site or structured website.

In an embodiment in the absence of providing of website name or URL, server 110 assigns unique user name or identity as unique identity of structured site or structured website.

In an embodiment in the event of un-registered user or website and in the absence of providing of website name or URL, server 110 automatically generates unique identity or user name and assigns said automated generated unique identity as unique identity of structured site or structured website.

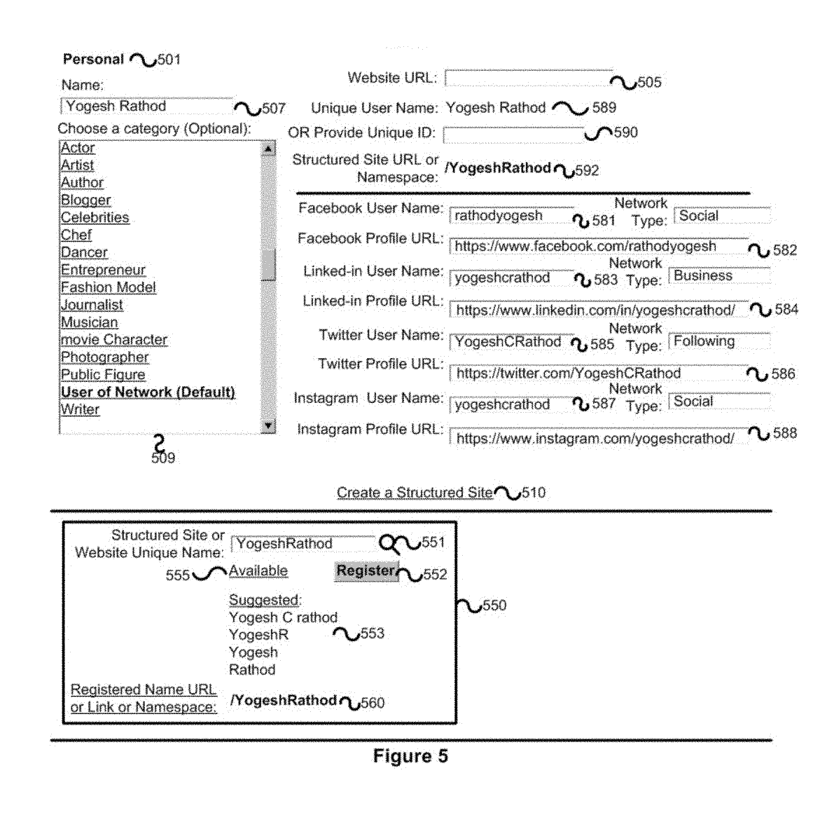

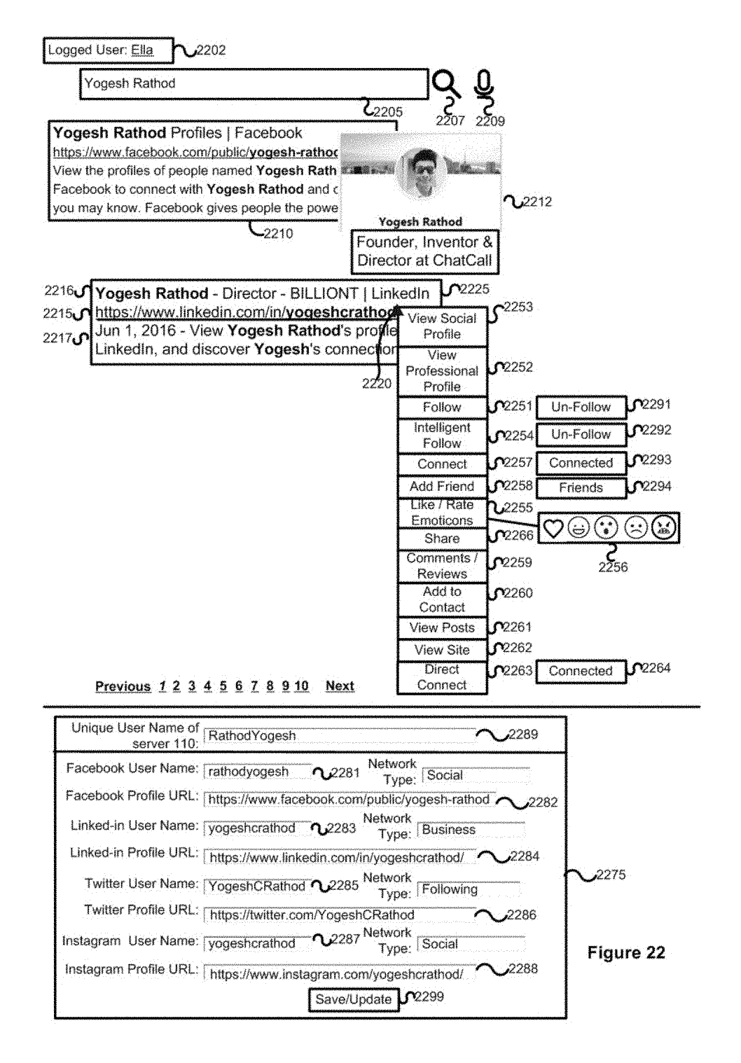

FIG. 5 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) for enabling user or personal user to select type “Personal” 501 and can input or select one or more categories 509/FIGS. 6-7, provide name 507 (e.g. name of user or person), provide website Uniform Resource Locator (URL) or web address 505 and starts to create structured site or website via tapping or clicking on create structured site or website icon or link or button 510. In an embodiment user can link or provide one or more types of one or more social network accounts (e.g. user name 581 or link or URL of profile 582 of e.g. Facebook) with user's unique identity or name 589 or website's domain name 505 or structured site or website's unique name 505 or auto generated unique identity 590, so search engine can identify search result item associated user based on matching search result item associated profile link with said user provided one or more profile links 582/584/586/588 related to one or more social networks or matching user name with search result item associated user name by extracting user name from search result item associated Uniform Resource Locator (URL), so searching user can follow or connect or send request to connect to said identified user or view said identified user's posts, structured site or website, one or more types of profiles including general profile, social profile, and business or professional profile stored in database 115 of server 110 or searching user can click or tap on like button to like said identified user associated with search result item, or searching user can click or tap on comment button to provide comment on said identified user associated with search result item or searching user can add to contact said identified user associated with search result item (discuss in detail in FIG. 22). In an embodiment creating unique Uniform Resource Locator (URL) (e.g. 592) of structured site or website based on extracted domain name from website URL or unique user name 589.

In an embodiment user can register unique structured site or website name with server 110 by searching unique available name 551 and in the event of availability of unique structured site or website name 551, user can register said unique structured site or website name 551 by providing registration details and in an embodiment making payment for unique structured site or website name. In an embodiment user can select unique structured site or website name from suggested list of unique structured site or website names 553.

FIG. 6 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) for enabling creating of structured site or website 610. In an embodiment in the event of tap or click on create a structured site or website button or icon or link 415/450/460/495/510 server module 151 receives selected type of structured site or website, name of local business or place or company or brand or product or service or entertainment (e.g. movie), and person name, website's URL, structured site or website's unique name or URL, unique user name or user identity, one or more categories or sub-categories, personal account associated one or more user names or unique user profile links related to one or more social networks and stores to server 110 database 115 and In an embodiment presents to user type of structured site or website associated templates 605. In an embodiment user can select template (e.g. user selects template “E-commerce/Shopping” 602) from list of template 605. In an embodiment based on said selected template, server module 151 presents said template associated templates of structured information for site 620 which user can select from list 620. For example user selects structured information template “Address/Contact information” 615 and in the event of selection of structured information template e.g. “Address/Contact information” 615, presenting associate structured form 628 (one or more fields to enable user to provide one or more types of details or data or contents) or free form 625 or both 628/625, so user can fill or enter or select or input or update information or structured data or one or more types of field associated one or more types of values and save to server database 115 via server 110 module 151. Likewise user can select other template from 620 and can provide associated structured information or data or one or more types of fields specific one or more types of values, For example profile, about, FAQs, hours of operation, map & direction, categories, keywords, logo, profile photo, mode of payments & like. In an embodiment server module 151 stores said structured information or updated structured information related with site to database 115. In an embodiment server creates named link of said structured information, so viewing user can click on name and view associated structured information. In an embodiment user can preview said structured information or links of structured information.

In an embodiment user can select or drag and drop one or more types of reactions controls or Graphical User Interface (GUIs) from list of reactions controls or Graphical User Interface (GUIs) 630 to associate with structured site or website including Like, Comment, Rate, I am Customer, I am Prospective Customer button or link or icon. For example user selects “Like” to enable structured site or website viewing user to like said structured site or website.

In an embodiment user can select or drag and drop one or more types of actions controls or Graphical User Interface (GUIs) including Share, Follow, Add to List, Search, Match, Filter, Invite, Connect, Chat, Install, Sign-Up from list of actions controls or Graphical User Interface (GUIs) 640 to associate with structured site or website. For example user selects “Follow” to enable structured site or website viewing user to follow said structured site or website to receive updates or posted contents.

In an embodiment server module 151 stores said selected actions and reactions controls or Graphical User Interface (GUIs) with said structured site or website to database 115. In an embodiment server generates site and embedding or integrating said selected actions and reactions controls or Graphical User Interface (GUIs) with said structured site or website, so viewing user can click on said selected actions and reactions controls or Graphical User Interface (GUIs) with said structured site or website for taking actions or providing reactions and view associated structured information. In an embodiment user can preview said structured information or links of structured information.

In an embodiment user can create one or more templates or forms or fields and define type of field and provide associated default or sellable list of field type specific values 650 for providing structured information for structured site or website. After creating one or more templates or forms or fields user can select one or more templates or forms or fields and provide each field specific field type related one or more values or data or content 660. In an embodiment server module 151 stores said structured information or updated structured information related with site to database 115. In an embodiment server creates named link of said structured information, so viewing user can click on name and view associated structured information. In an embodiment user can preview said structured information or links of structured information.

In an embodiment user can create named URL or link of website 670 and in the event of clicking or tapping on named URL or link clicking user redirects to webpage or website associated with said URL or link. In an embodiment user can select said created named URL or link from list of named URL or links 672 and add to structured site or website. In an embodiment server module 151 stores said named URL or link of website with said structured site or website.

In an embodiment user can link web application or smart client application 680 with structured site or website by providing web application name and web application or smart client application Uniform Resource Locator (URL) 680 with said structured site or website (e.g. 472).

In an embodiment user can link structured site or website with structured site or website by providing structured site or website name and structured site or website Uniform Resource Locator (URL) 680 with said structured site or website (e.g. 472).

In an embodiment user can link integrated web application with structured site or website by providing integrated web application name and integrated web application Uniform Resource Locator (URL) 685 with said structured site or website (e.g. 472).

In an embodiment user can change or update name 610, website URL 609 and add or remove categories 607 associated with structured site or website (e.g. 472).

In an embodiment after configuring structured site or website (e.g. 472), user can preview 690, save 691 or remove 692 structured site or website associated said structured information, selected and added actions and reactions controls and Graphical User Interfaces (GUIs), named Uniform Resource Locators (URLs) and one or more web applications. In an embodiment server module 151 of server 110 stores said structured site or website associated said structured information, selected and added actions and reactions controls and Graphical User Interfaces (GUIs), named Uniform Resource Locators (URLs) and one or more web applications in database 115 for later retrieval, updates, management and publishing. In an embodiment creator or owner of structured site or website can stores said structured site or website associated said structured information, selected and added actions and reactions controls and Graphical User Interfaces (GUIs), named Uniform Resource Locators (URLs) and one or more web applications in database(s) of their server(s) or external server(s) for later retrieval, updates, management and publishing. In an embodiment creator or owner of structured site or website can synchronize (based on snapshot, push, pull and merge synchronization) full or part of said structured site or website associated said structured information, selected and added actions and reactions controls and Graphical User Interfaces (GUIs), named Uniform Resource Locators (URLs) and one or more web applications from/to one or more databases of one or more servers or their server(s) or external server(s) for later retrieval, updates, backups, restores, management and publishing.

FIG. 7 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) wherein user can preview, create, and update named structure information and one or more elements of structure site or website. User can instantly create structure site or website including enter, edit or select structured information name 787, add or link associated structured information (e.g. select structured information name from list of select structured information name 615 and add or update structured information 625) and add one or more types of structured information 772, enter, edit, select webpage name 788 and Uniform Resource Locator (URL) of webpage and add 774 one or more webpage names and associate URLs. User can visually re-arrange position and move anywhere structured information 787 in structured page area 780. Likewise user can visually re-arrange position and move anywhere webpage names 788 in named webpage link area 782. User is enabling to add 785 or select 785 and remove 791 one or more actions and reaction controls or Graphical User Interfaces (GUIs) e.g. 790. User can visually re-arrange position and move anywhere one or more actions and reaction controls or Graphical User Interfaces (GUIs) e.g. 790 in one or more actions and reaction controls or Graphical User Interfaces (GUIs) area 784.

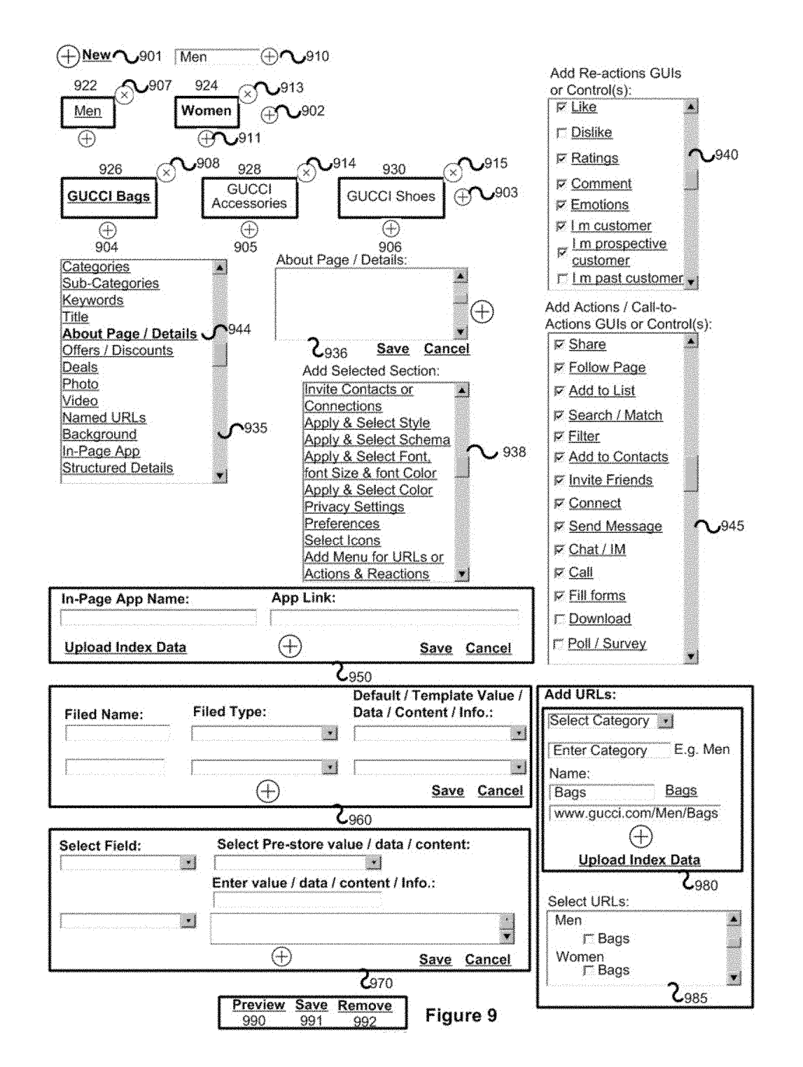

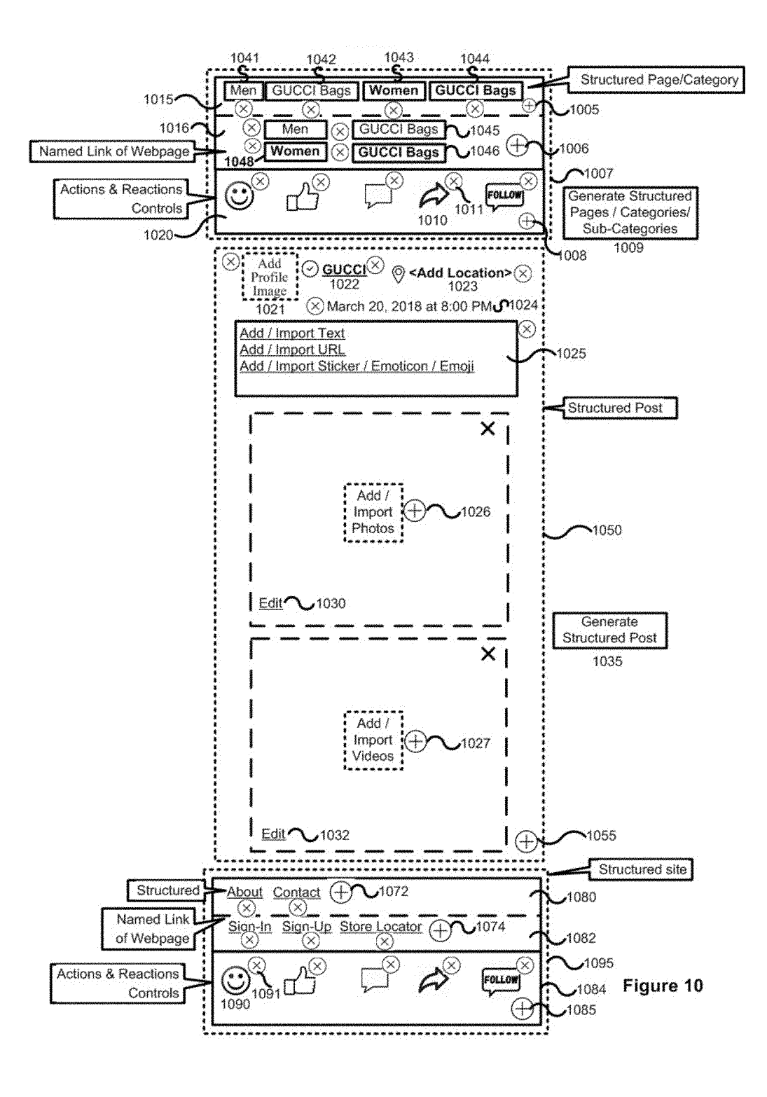

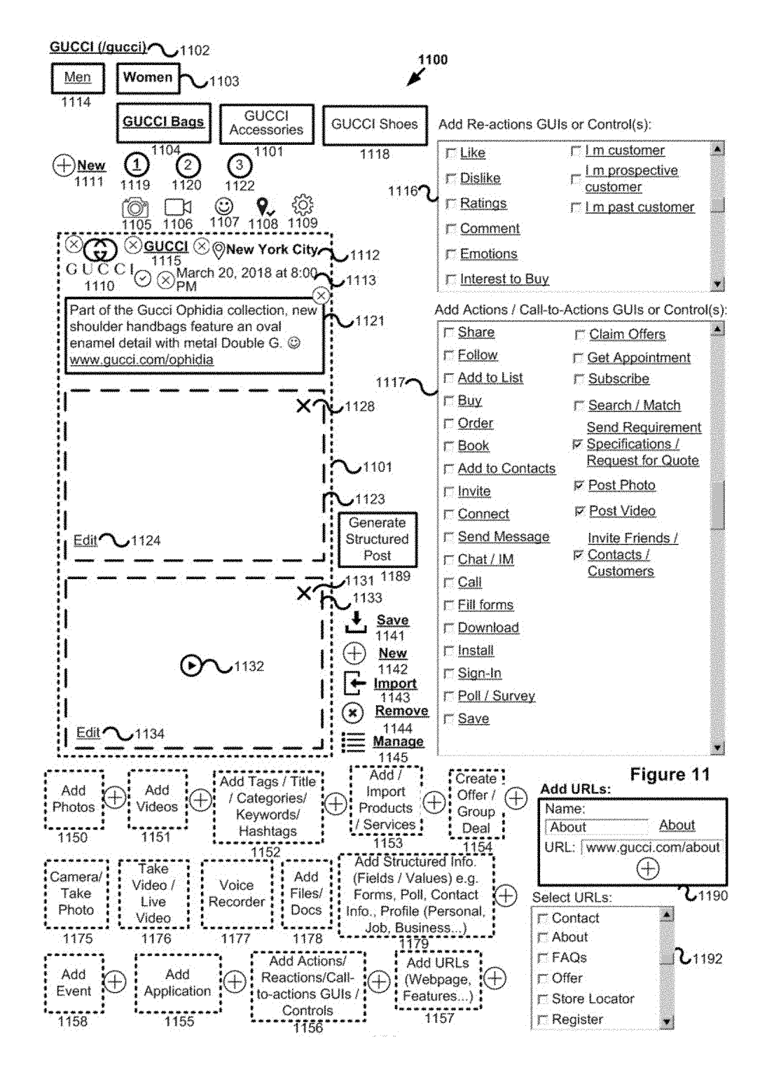

In an embodiment based on profile of structured site or website user, server module 151 import and present some details which user can anytime update or change including profile photo or image or logo 721, user name including brand name, company name, product name, service name, person name and associate link of profile 722, location information 723. FIGS. 11-13 discuss in detail about creation, updating, previewing and managing structured posts 705. FIGS. 9-10 discuss in detail about creation, updating, previewing and managing structured pages and categories 707.

In an embodiment user can visually select, apply and preview and save one or more types of style, schema, font type & name, font size and font color, themes, effects, transitions, customized layouts, interactive elements, animations, background styles, orientation, boarder and different types of size (height & width) of structured site or website including zoom to full screen, medium, small, mobile size and select icons 1290 for structured site or website

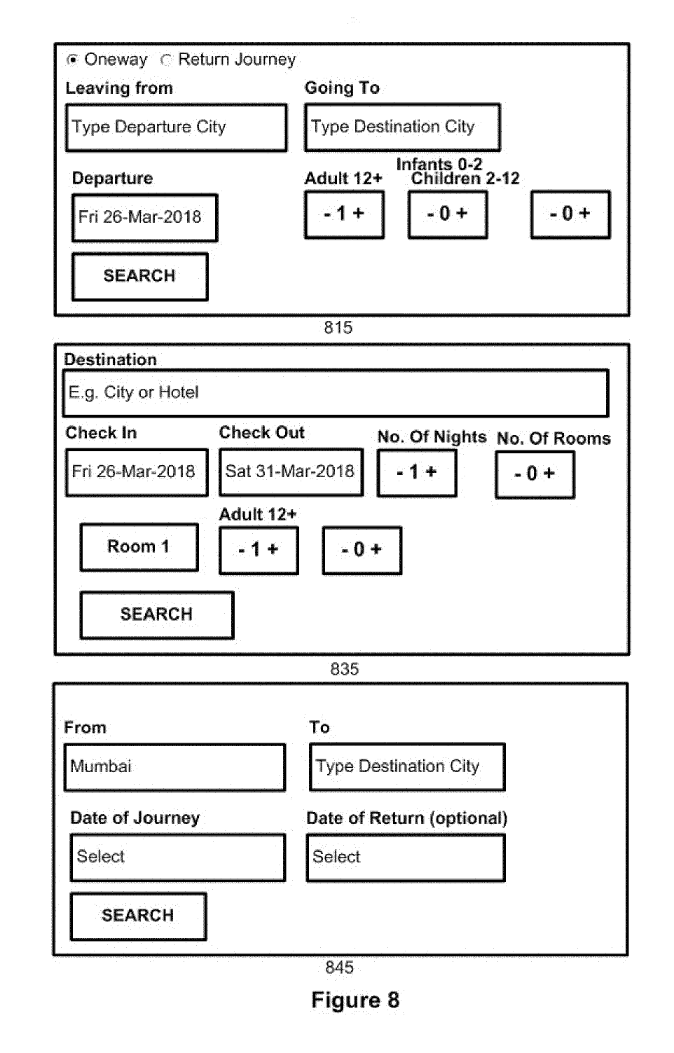

FIG. 8 illustrates exemplary web applications which can integrate with structured site or website. For example Flight booking online web application or smart client application or widget 815, hotel room booking online web application or smart client application or widget 835 and vehicle booking online web application or smart client application or widget 845.

FIG. 9 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) for enabling user to create one or more structured pages or categories of posts or one or more types of contents or collections of contents of said structured site or website (e.g. 472). In an embodiment structured site or website e.g. name “GUCCI” 452 having unique URL or link or namespace “/Gucci” (472) comprise protocol (http), a hostname (www.example.com)+“/Gucci”=full accessible path of URL is “http://www.example.com/Gucci”) 1102. User can tap on tap or click on “New” icon 901 to create or add new structured page or category or name or link or interface or tab. For example in the event of inputting or selecting name or title 910 and tapping on add icon 910, presenting created tab or structured page link or structured page name 922. User can add one or more structured pages or categories or tabs by tapping or clicking on add icon or button 902. User can add sub-categories or sub-page or child page for said selected page. For example user can select page 924 “Women” and can tap or click on “add” icon or button 911 to add sub-categories or sub-page name 904 of said parent page name 924. User can add one or more sub-categories or sub-pages 904/905/906 under of parent page 924. User can remove parent pages 922 or 924 by clicking or tapping on “remove” icon 907 or 907 and in the event of removing of parent page or categories, removing all child pages or sub-categories related to removed parent page or category. User can also remove one or more sub-categories or sub-pages 904 or 905 or 906 by clicking or tapping on corresponding “remove” icon or button 908/914/915. After adding one or more categories or names of structured pages and one or more sub-categories or child structured pages, user can select particular created category or structured page e.g. 924 and in the event of selecting particular created category or structured page e.g. “Women” page or category 924, presenting associated sub-categories or child structured pages e.g. 904/905/906 for enabling user to select particular sub-category or child structured page and in the event of selection of particular sub-category or child structured page e.g. “GUCCI Bags” 926, user can add associated one or more types of structured information 935 (For example in the event of clicking or tapping on selected type of structured information 944, user is presented with associate interface or form 936 for enabling user to provide associated details or field associated filed type specific data or values. In an embodiment user can create structured information templates and forms comprise one or more fields and associated field type and default value(s) and one or more types of fields 960 and selecting said created template, form and field and provide associated values or data or one or more types of contents 970), add or integrate in-page web application or smart client application 905 by providing in-page application name and Uniform Resource Locator (URL) or link, add selected one or more types of actions controls and Graphical User interface (GUIs) 945 and add selected reactions controls and Graphical User interface (GUIs) 940, named Uniform Resource Locator (URLs) 985 with said sub-page or sub-category 904.

In an embodiment user can select font, size of font color of font, schema, style and apply selected font, size of font color of font, schema and style of structured site or website, one or more associated structured pages, sub-pages or categories or sub-categories of structured pages, and posts associated text and URLs or links. In an embodiment can visually drag and drop to change position, re-ordering links of structured information, one or more structured pages, sub-pages or categories or sub-categories, actions and reactions controls and Graphical User interface (GUIs), named URLs, posts, and link of web applications.

In an embodiment after configuring structured site or website (e.g. 472) associated one or more structured pages or categories or sub-categories of structured pages, user can preview 990, save 991 and remove 992 said structured pages associated said structured information, selected and added actions and reactions controls and Graphical User Interfaces (GUIs), named Uniform Resource Locators (URLs) and one or more web applications. In an embodiment server module 151 of server 110 stores said structured site or website (e.g. 472) associated one or more structured pages or categories or sub-categories of structured pages and associated said structured information, selected and added actions and reactions controls and Graphical User Interfaces (GUIs), named Uniform Resource Locators (URLs) and one or more web applications in database 115 for later retrieval, updates, management and publishing. In an embodiment creator or owner of structured site or website can stores said structured site or website (e.g. 472) associated one or more structured pages or categories or sub-categories of structured pages associated said structured information, selected and added actions and reactions controls and Graphical User Interfaces (GUIs), named Uniform Resource Locators (URLs) and one or more web applications in database(s) of their server(s) or external server(s) for later retrieval, updates, management and publishing. In an embodiment creator or owner of structured site or website can synchronize (based on snapshot, push, pull and merge synchronization) full or part of said structured site or website (e.g. 472) associated one or more structured pages or categories or sub-categories of structured pages associated said structured information, selected and added actions and reactions controls and Graphical User Interfaces (GUIs), named Uniform Resource Locators (URLs) and one or more web applications from/to one or more databases of one or more servers or their server(s) or external server(s) for later retrieval, updates, backups, restores, management and publishing.

FIG. 10 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) wherein user can preview, create, and update structure site or website and one or more elements of structure site or website. User can instantly create structure site or website including enter or edit structured page name or category 1041 or sub-page name or sub-category 1042, add 1005 one or more page names or categories 1041/1043 or sub-page names or sub-categories 1042/1044, enter webpage name 1048 and Uniform Resource Locator (URL) of said webpage add 1006 one or more webpage names and associate URLs. User can visually re-arrange position and move anywhere structured page names 1041/1043 in structured page area 1015. Likewise user can visually re-arrange position and move anywhere webpage names 1048/1045/1046 in named webpage link area 1016. User is enabling to add 1008 or select 1008 and remove 1011 one or more actions and reaction controls or Graphical User Interfaces (GUIs) e.g. 1010. User can visually re-arrange position and move anywhere one or more actions and reaction controls or Graphical User Interfaces (GUIs) e.g. 1010 in one or more actions and reaction controls or Graphical User Interfaces (GUIs) area 1020.

In an embodiment based on profile of structured site or website user, server module 151 import and present some details which user can anytime update or change including profile photo or image or logo 1021, user name including brand name, company name, product name, service name, person name and associate link of profile 1022, location information 1023. FIG. 11-13 discuss in detail about creation, updating, previewing and managing structured posts 705.

In an embodiment user can generate 1009 structured page names or categories and one or more associated sub-page names or sub-categories based on relational data comprise names or categories of structured page and sub-pages of database e.g. 110.

In an embodiment user can visually select, apply and preview and save one or more types of style, schema, font type & name, font size and font color, themes, effects, transitions, customized layouts, interactive elements, animations, background styles, orientation, boarder and different types of size (height & width) and select icons for structured page names or categories and sub-pages or sub-categories of structured site or website.

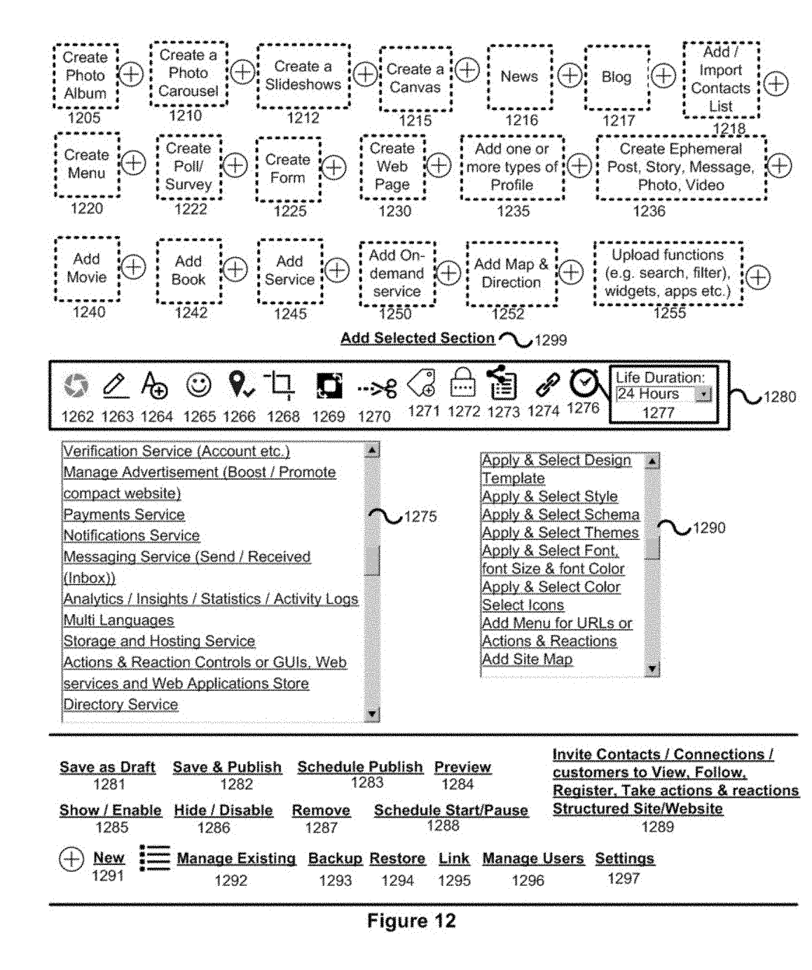

FIGS. 11-12 illustrates Graphical User Interface (GUI) of Structured Site or Website Management Application (Smart Client or Web enabled) 277 (In an embodiment of Structured Site or Website Management Application (Smart Client or Web enabled) 277 connected with server module 151 of sever 110) for enabling user to create or add or update or remove one or more structured posts or one or more types of content items 1101 for particular or selected structured page or category 1103 or structured sub-category or sub-page 1104 of structured site or website 1102. User can select structured site or website 1102 associated created pages or categories 1114/1103. For example user selects page name or category e.g. “Women” 1103 and in the event of selection of page name or category e.g. “Women” 1103, presenting associated sub-pages or sub-categories e.g. 1104/1101/1118. After selecting page or category e.g. 1103 and associated sub-page or sub-category e.g. 1104, user can add or create one or more structured posts e.g. 1101 including add 1150 or capture 1175 one or more photos 1123, add 1151 or record 1176 videos 1133, edited photos or videos (by using various editing features, wherein some of the photo or video or voice or live stream editing features discuss in 1180), add voice 1177, live video or live stream 1176, searched or selected or provided location information 1108 (e.g. 1112), draft or add text 1121 including URLs or web addresses or links, add emoticons, emoji, stickers 1107 in text or on/with/integrate with photo or video, add profile photo or logo 110, profile name and link of profile 1115, structured contents based on selected templates of structured information or user created templates or forms or fields and associated values or data or content 1179, structured information related to product & service 1153 including name, price or cost or fees, features, description, checkout URL, one or more photos, videos, structured information related to event 1158 including event name, location, description, start and end date & time or schedules of event, one or more categories, tags, hashtags, keywords and title 1152, structured information related to offers including discounts, user specific offer, coupons, cashback, free gifts or samples, vouchers, redeemable points, deals, group deals 1154, one or more types of attachments 1178, actions and reactions controls and Graphical User Interfaces (GUIs) 1156, named Uniform Resource Locators (URLs) 1192, one or more web applications or smart client applications 1155, create and add album 1205, carousal 1210, canvas 1215, slideshow 1212, news 1216, blog or article or microblog or updates or notification 1217, menu 1220, survey or poll 1222, one or more types of forms 1225, create, update and add one or more types of structured profile 1235 including general profile (e.g. name, age, gender, interest, work and home address), social profile (e.g. name, age, gender, interest, work and home address, add, import and invite friends, connects and connections, prepare or select status, updates, checked-in place, location information for sharing with one or more contacts or followers or users of network, prepare one or more types of contents for sharing), business or professional profile, customer & prospective customer profile, job profile, matrimonial profile by using profile creation step by step wizard or template based profile creation based on fields and associated values, profile builder wizard or Graphical User Interface (GUI) which enables user to select structured information template and provide said selected template of form or Graphical User Interfaces (GUI) and associated one or more selected or created fields specific field type specific one or more values or data or content including text, numeric, currency, image, flag (Yes/No), list, alphanumeric, selections from list, select ranges, select from combo-box, select from auto-fills or suggested, slide to provide value via slider, select type or select radio button associated option, check one or more checkboxes), create, update & add one or more webpages 1230 for unstructured or structured information, create and add ephemeral photo or video or post or stories or album or set of or one or more types of contents 1236, create & add map & direction including search and select locating or place on map, and define geo-fence boundary, user created or developed or selected or 3^{rd} parties one or more objects, controls, functions, Graphical User Interfaces (GUIs), widgets, web applications, smart client applications 1255, add on-demand service 1250 including enabling viewing user of structured site or web site to act as consumer or provider of on-demand service, search, select and request on-demand services, set online availability status, enable to set one or more types of status including accept, reject, ignore, based on current location of user's device auto provide one or more types of status including arriving and arrived, and enable to communicate with each other, add or integrate one or more types of services including payment service, verification service, sign-in or sign-up service, notification service, messaging service, and translation service 1245 and any combination thereof.

In an embodiment user can edit or augment photo or video via click or tap on edit option 1124 or 1134 to present features of editing 1280, wherein edit includes apply one or more types of photo filters 1262, draw on photo via pen 1263, add text on or with photo 1264, add or overlays emoticons, voice, geo-filters, image(s), emoji(s) on photo 1265, add location or place information 1266 including select from list, search and select location or place information, map & direction from map 1266, select from map current location or place 1266, crop photo 1268, rotate photo 1269, remove part from photo 1270, resize photo, add tags or hashtags or categories or keywords with photo 1271, add password 1272 with photo to enable receiving user to view photo by entering said password, select or enter name or type of one or more sharing applications through which user will share link of said photo 1273, add URL or web address or link or short link 1274, apply ephemeral settings 1276 including set view duration and life duration 1277 (e.g. select from list 1277 particular number of seconds or hours or days), select from list particular number of times allowed to view to make post as non-ephemeral. After editing photo post user can save said edited photo or video. There are plurality types of available editing functions user can use to edit photo or video.

In an embodiment show thumbnails of structured posts 1119/1120/1122 and enable to select structured post by tapping or clicking on thumbnail. In an embodiment user can select 1119/1120/1122 and view structured post. In an embodiment user can save structured post 1141. In an embodiment user can add new structured post 1111 or 1142. In an embodiment user can import one or more structured posts 1143. In an embodiment user can select e.g. 1119/1120/1122 structured post and remove selected structured post 1141. In an embodiment user can manage and update selected 1119/1120/1122 structured post 1145.

In an embodiment enabling user to generate structured posts 1189 based on based on selected and customized template or part of template including type of structured information to generate structured information or type of contents including product, service, information, advertisement, offer, event, application, album, slideshow, carousal, canvas, forms including profile, menu, survey, event, poll based on data in relational database, one or more types of files including photos, videos, icons, objects, controls and Graphical User Interfaces (GUIs) including actions and reactions controls and Graphical User Interfaces (GUIs), named Uniform Resource Locators (URLs), web application, map & directions, preferences, settings, privacy settings, rules, wherein post or one or more types of content comprise photo, video, voice, text, location or place information, date & time, emoticons, profile link, Uniform Resource Locators (URLs) or named Uniform Resource Locators (URLs), structured information, actions and reactions controls and Graphical User Interfaces (GUIs) and any combination thereof.

In an embodiment after creating or updating structured site or website, user can save as draft 1281. In an embodiment after creating or updating structured site or website, user can save and publish structured site or website 1282. In an embodiment after creating or updating structured site or website, user can schedule to publish structured site or website 1283. In an embodiment after creating or updating structured site or website, user can preview 1281 structured site or website 1490. In an embodiment user can show 1285 or hide 1286 published structured site or website. In an embodiment user is enable to backup 1293 or restore 1294 structured site or website. In an embodiment user is enable to link structured site or website with other selected one or more structured site or website based on permission, authorization, privacy settings and privacy policies. In an embodiment admin user is enable to create roles, associate one or more users for enabling multi-user environment in creating and managing structured site or website, provide one or more types of roles, rights & privileges including allow particular user to add, edit, update, remove particular on or more structured sites or websites, structured site or website associated one or more pages or categories or sub-pages or sub-categories, associated one or more structured posts and one or more types of contents, and associated one or more types of one or more actions and reaction controls or GUIs, offers, events, payment information, form, profile, contacts, survey, ephemeral posts, and web applications, view analytics and statistics, add new user, and publish, set privacy settings, rules and policies 1296. In an embodiment user is enable to add new 1291 structured site or website. In an embodiment user is enable to select and manage already created one or more structured sites or websites.

In an embodiment server 110 provides domain name or unique name service to enable website owner or structured site owner or user to search, register and buy unique available domain name for structured site or structured website.

In an embodiment server 110 provides verification and certification service to verify structured site or structured website, associated company, brand, product, service, content and one or more types of profile including company or brand or product or service or local brand or shop or entity profile, user profile, social profile, business or professional profile, job profile, matrimonial profile and one or more types of structured information.

In an another embodiment the server 110 maintains various types of online web applications including hotel booking, ticket booking, air flight booking, cab booking, movie ticket booking, event booking, survey, poll, ordering, e-commerce, payment, subscribing of service(s), appointment, group deal, product catalogue, restaurant applications, web services, for enabling structured site or structured website owner or administrator to search, match, select, buy, customize, and add one or more web applications with structured site or structured website for making them available to their users.

In an another embodiment the server 110 maintains various types of actions controls and Graphical User Interfaces (GUIs) including share, refer, follow, connect, invite, buy, order, get appointment, subscribe, add to list, book, chat, send & receive messages and contents, instant messaging, question and answer, contacts, map & direction, claim offers, search, match, filter, sort, bookmark, save, bookmark, install app, download, upload, emoji, stickers and reactions controls and Graphical User Interfaces (GUIs) including like, dislike, rate, comment, review, emoji, stickers, emoticons.

In an embodiment server 110 provides advertisement service to structured site or structured website owner or admins or advertiser to enable them to advertise structured site or structured website based on one or more types of target criteria including one or more keywords, current location of advertiser or defined or set or selected one or more locations or places, selected one or more types of categories of locations or places, location within particular range or boundaries (e.g. within 20 miles) from advertiser's business place or location, one or more types of visitors or viewers or shoppers, visitors or viewers or shoppers of one or more places, one or more languages, one or more type of devices or browsers, interacted one or more types of entities including school, college, company name, defined geo-fence boundaries, schedules, type of user profile including gender type, age range, locations, checked-in place, one or more type of interests, activities, and behaviours, supplied object model or image or object keywords. Server 110 maintains said advertisement and associate criteria of advertisers and in the event of receiving search query from searching user, server 110 search and presents said search query specific search results including said contextual advertisement related search result items including each search result item associated title, URL and snippet or rich snippet and said search result item associated website or identified domain name associated structured site or structured website to searching user's device or search interface, for enabling searching to access search result item associated structured site or structured website. Server 110 matches searching user's keywords and profile data or one or more types of user data with advertisement criteria including keywords, type of profile and type of locations and identifies contextual advertisement related to said search keywords and searching user and presents search result items including each search result item associated title, URL and snippet or rich snippet and said search result item associated website or identified domain name associated structured site or structured website to searching user's device or search interface.

In an embodiment structured site or structured website is localized or globalized enabled or multi language enabled.

In an embodiment server 110 provides payment service to enable structured site or structured website to integrate payment service with structured site or structured website. In an embodiment structured site or structured website can integrate their or one or more 3^{rd} parties payment service with structured site or structured website.

In an embodiment server 110 provides notification service to enable structured site or structured website to integrate notification service with structured site or structured website. In an embodiment structured site or structured website can integrate their or one or more 3^{rd} parties notification service with structured site or structured website.

In an embodiment server 110 provides communication including chat, instant messaging, call, video call, and VOIP applications and services to enable structured site or structured website to integrate communication applications and service with structured site or structured website. In an embodiment structured site or structured website can integrate their or one or more 3^{rd} parties communication service with structured site or structured website.

In an embodiment server 110 provides structured site or structured website related analytics, insights, statistics and activity monitoring, tacking, storing, updating and logging services to structured site or structured website, wherein structured site or structured website related analytics, insights, statistics and logged activities, actions, events, transactions, status comprises number of impressions, date range and one or more types of locations or places and type of profile of users or viewing users or requesting users or searching users wise number of clicks, number of views of structured site or structured website, associated one or more structured pages and structured posts, photos, videos, and profile, each type of action specific number of actions including number of followers, number of form or survey fill-ups, number of calls, number of messages, number of video or VOIP calls, each type of reaction specific number of reactions including number of likes, comments, and shares, average ratings, number of transactions, number of registration, membership, installation of applications and participation with events or groups or deals or group deals, duration of time spend on website or particular web pages, duration of time spend on structured site or structured website or associated structured pages or associated structured posts, number of identified customers, number of identified prospective customers, number of invitations, number of claim offers including discounts, coupons, redeemable points, vouchers, cashbacks and samples or gifts, number of users who bought particular product or subscribe particular service, number of downloads, number of bookings, number of appointments, amount of transactions and associated each user's profile link or profile and metadata and any combination thereof.

In an embodiment server 110 provides hosting and storage service to structured site or website including cloud storage.

In an embodiment server 110 enables structured site or website to list in categories directories or lists of structured site or website.

In an embodiment server 110 Action & Reactions controls & GUIs, web services and Web Applications Store, for enabling structured site or website owner or user to search, match, view details, select, make payment, register, download, install, uninstall, subscribe, update, upgrade, customize, access one or more Action & Reactions controls & GUIs and Web Applications.

In an embodiment user can import or add contacts 1289 including customers, friends, connections (business, professional, social) including email addresses, phone numbers, social network account names with structured site or website and invite them to view said structured site or website, follow said structured site or website, connect with structured site or website or associated source, install application, install structured site or website, register with structured site or website, visit website, conduct one or more types of actions, reactions, transactions, communication, and participations.

In an embodiment user can select and apply one or more types of style, schema, font type & name, font size and font color, themes, effects, transitions, customized layouts, interactive elements, animations, background styles, orientation, boarder and different types of size (height & width) of structured site or website including zoom to full screen, medium, small, mobile size and select icons 1290 for structured site or website, structured page categories and sub-categories of structured site or website.

In an embodiment structured site or website admin to add site map of structured site or website with structured site or website.

In an embodiment enable to create smart client application of structured site or website, so others can search, match, select, view details, download, install, un-install or remove, share, use as free or make payment, subscribe, update and upgrade said smart client application version of said structured site or website.

In an embodiment enabling admin of structured site or website to merge one or more structured sites or websites.

In an embodiment enabling admin of structured site or website to divide structured site or website into one or more structured sites or websites.

In an embodiment enabling admin of structured site or website to select particular structured page as a home page of structured site or website.

In an embodiment enabling admin of structured site or website to provide one or more types of settings 1297 including make published structured site or website or one or more structured pages or sub-pages of structured site or website or one or more structured posts as un-published or make un-published structured site or website or one or more structured pages or sub-pages of structured site or website or one or more structured posts as published, wherein unpublished structured site or website or one or more structured pages or sub-pages of structured site or website or one or more structured posts can view and access by authorized administrators or users, allow or not allow visitors of structured site or website to publish posts, Restrict one or more types of audience to view structured site or website or one or more structured pages or sub-pages of structured site or website or one or more structured posts including one or more selected locations, countries, age, gender, and language, allow authorized administrators or users to tag photos or videos or allow others to tag photos or videos, Block posts or comments contains particular words, allow to suggest structured site or website to others, allow or not allow to index deep data of structured site or website, allow or not allow to share link of structured site or website, allow to subscribe notification service to notify about new updates to subscribers, allow or not allow to provide comments in multiple or selected one or more languages, provide translate feature to enable user to translate contents of structured site or website or one or more structured pages or sub-pages of structured site or website or one or more structured posts, In the event of triggering of one or more types of activities, actions, reactions, events, updates and transactions get a notification, wherein one or more types of activities, actions, reactions, events, updates and transactions comprise new like, new comment, new followers, new subscribers, new purchases, new shares, new add to list, new ratings, new messages, new e-mails, new views, and new clicks, allow one or more users to act as admin, editor, moderator, advertiser, and analyst, block one or more viewing users, allow to access only registered users or logged-in users or subscribers or members, allow to search, match and filter contents of structured site or website, allow to display structured site or website on map or on particular one or more selected places or locations or within defined geo-fence boundaries, allow to display structured site or website with crawler base search result or searched contents associated with website or un-structured search result.

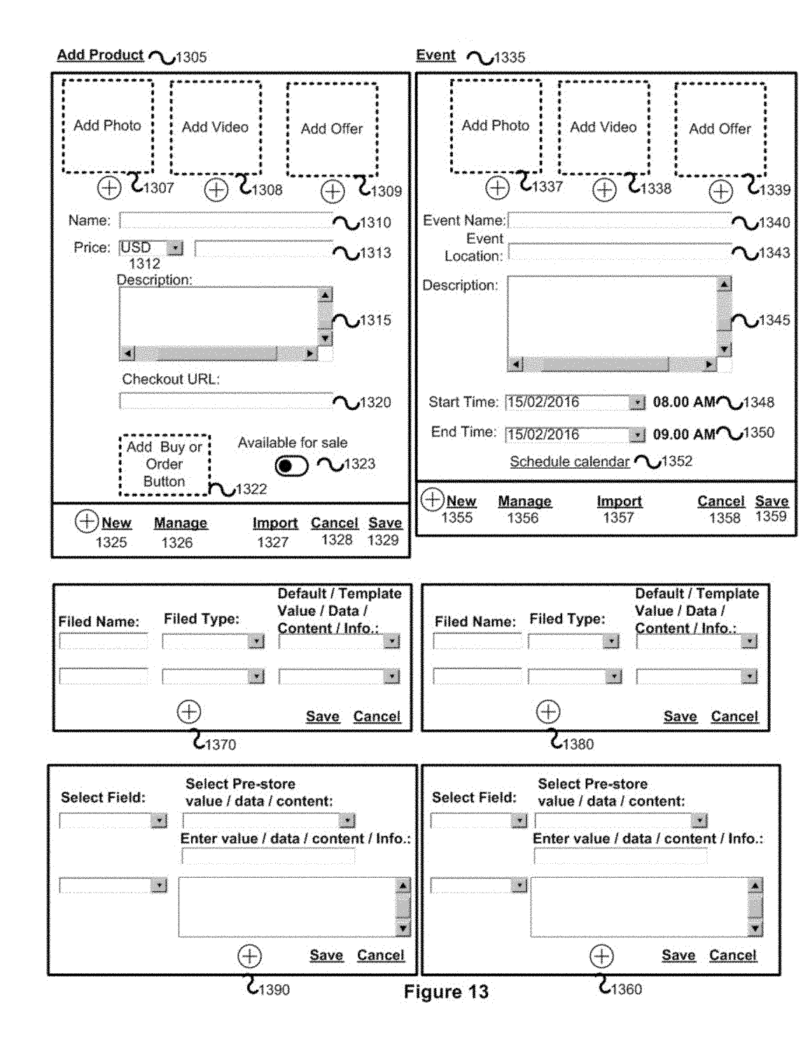

FIG. 13 illustrates shows exemplary types of structured information and structured posts. For example user can add product by providing one or more types of structured information including add one or more photos 1307, videos 1308, add offers or group deals 1309, type or categories of product or service, name 1310, features, description 1311, price of product or service 1313 and checkout URL 1320 related to one or more products. User can add buy or order button 1322 with product post or subscribe button with service post. User can provide indication 1323 whether product is available or not for sell. User can add one or more products 1325, manage and updates products 1326, import products 1327, save 1328 or cancel 1329 added product's details. User can add or create one or more additional customized fields, each field associated field type and each field specific default values 1370 and can select one or more fields from said created fields and provide field and field type specific data or values or content 1390.

In an embodiment after creating, saving, and publishing structured site or website for making them searchable for searching user of web search engine e.g. Google Search™, wherein a ‘web search engine’ is a software system that is designed to search for information on the World Wide Web. The search results are generally presented in a line of results often referred to as search engine results pages (SERPs). The information may be a mix of web pages, images, and other types of files. Some search engines also mine data available in databases or open directories. Unlike web directories, which are maintained only by human editors, search engines also maintain real-time information by running an algorithm on a web crawler. Internet content that is not capable of being searched by a web search engine is generally described as the deep web. Web search engine

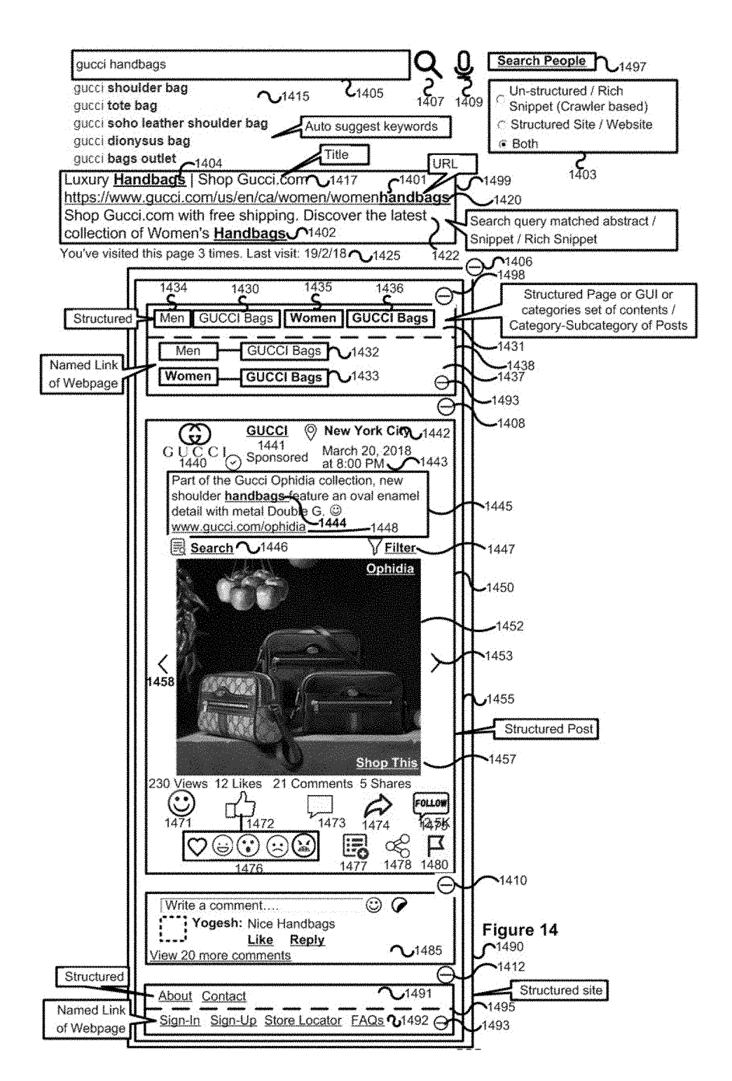

FIG. 14 illustrates Graphical User Interface (GUI) of Search Application (Smart Client or Web based) (In an embodiment Search Application (Smart Client or Web based) connected with server module web search engine 152 and/or server module Structured Site/Website Management & Searching 151 of sever 110) for enabling searching user to search based on user provided or entered or selected from suggested list of keywords 1415, provided by server module 152, search query or one or more keywords or key phrases 1405 and in the event of tapping or clicking on search button 1407, server module 152 receives said search query and finds search query or one or more keywords specific search results or information on the World Wide Web. Web search engine uses automated programs called spiders or crawlers and has a large index of keywords and where those words can be found. Web search engine is using web crawlers to organize information from webpages and other publicly available content in the Search index. Server module 152, serves said search results which are generally presented in a line of results often referred to as search engine results pages (SERPs), wherein search result item comprise title of the webpage 1417, so searching user or viewing user can click the title to go to the site or website, URL or web address 1420 of the searched or matched web page and snippet or rich snippet 1422, below the URL is text 1422 that helps show how the page relates to searching user's query. The words (e.g. “Gucci handbags”) 1405 searching user search for will show in bold (e.g. “handbags”) 1401/1402/1404 to make it easier for searching user to decide if the page has what searching user is looking for. Server module 151 extracts or parse or identify unique domain name or host name or unique second level domain name (e.g. “Gucci”) from search query specific search result item associated Uniform Resource Locator (URL) or web address of website or webpage 1420 and searches, matches, generates and retrieves said unique domain name or host name associated structured site or website 1490 (discuss in detail in FIG. 4(C)/FIGS. 6-13) and in an embodiment embedded or compose or combined or integrate said structured site or website 1490 with/below/on/overlay on/in prominent place/in search result 1499 or associate web page or display with search result 1499 and deep searches said search query (e.g. “Gucci handbags”) 1405 within/in said structured site or website 1490 associated data or one or more types of contents or data in relational database 115 of server 110 or from any external one or more database(s) of external server(s) and identifies and ranks matched posts, photos, videos or one or more types of content items or structured pages/categories or subpages/sub-categories and present to user structured site or website 1490 and shows matched and ranked post 1450 first in said presented structured site or website 1490, which have words (e.g. “handbags 1444) in text data and have recognized object (e.g. bags or handbags) in photo or video (video comprise series of images), wherein server module 151 recognizing or identifying objects in photo or video and identifies said recognized object associated keywords (e.g. bags or handbags) and identifies, rank and presents relevant photo or video or post 1450 in said presented structured site or website 1490 to searching user. In an embodiment user can tap or click on “Next” button 1453 or “Previous” button 1458 to view next or pervious matched or ranked post or photo or video or one or more types of contents associated with said presented structured site or website 1490. In an embodiment in the event of tapping or clicking on “expandable” icon 1406, server module 151 serves, loads and presents said search query 1405 specific search result item 1499 associated identified structured site or website 1490 and loads said search query 1405 matched first post 1450 related to associate structured page or category 1435 associated sub-page or sub-category 1436 of said structured site or website 1490 and in the event of tapping or clicking on “Next” button 1453 or “Previous” button 1458, server module 151 serves, loads and presents next post (if any). In the event of tapping or clicking on “collapsible” icon 1406, server module 151 serves, hides or unloads said presented or displayed structured site or website 1490. In an embodiment user can load/show or unload/hide structured page or category or sub-page or sub-category area 1438 by tapping or clicking on “collapsible” or “expandable” switchable icon 1498. In an embodiment user can load/show or unload/hide structured post area 1450 by tapping or clicking on “collapsible” or “expandable” switchable icon 1408. In an embodiment user can load/show or unload/hide structured site or website related structured information, actions & reactions controls or GUIs and named URLs area 1495 by tapping or clicking on “collapsible” or “expandable” switchable icon 1412.

In an embodiment user can scroll down or up to view other search result item associated matched structured site or website and can view matched posts or one or more types of contents rank-wise. In an embodiment searching user can search for information on the World Wide Web or search structured site or website or search both combined 1403. In an embodiment user can provide voice search query 1409. In an embodiment searching or viewing user can view all contents of structured site or website 1490. In an embodiment searching or viewing user can navigate, browse, access said structured site or website 1490 and associated structured pages or categories, sub-pages or sub-categories and structured posts including click or tap on link or tab or name of structured page or category (e.g. “Women” 1435), presenting associated structured sub-page or sub-category name or tab or link (e.g. “GUCCI Bags” 1436) in structured pages names or links or tabs area 1431 and in the event of click or tap on name or tab or link of particular structured page or category or associated structured sub-page or sub-category (e.g. “GUCCI Bags” 1436), display associated structured posts (1450) for enabling user to view post, post associated photo 1452 or video and associated one or more types of overlays content or links e.g. “Shop This” link 1457 for enabling viewing user to purchase said photo associated product, view profile photo or image or logo 1440, view named profile link 1441 of structured site or website associated account or user or brand or company, view location information 1442, view type of post (e.g. sponsored), view date & time of posting of contents 1443, view text associated with post including emoticons, emoji, stickers, Uniform Resource Locator (UR)L or web address or link, provide one or more types of reactions including select or provide expression emoticons 1476, like post 1450 by tapping or clicking on “Like” button or icon 1472, click or tap on “Comment” button or icon 1473 and provide comments, reviews, feedbacks, suggestions, use stickers and emoticons or emoji in comment, share 1474 said structured post or structured page or structured site with one or more or all contacts, connections, groups, followers or share 1478 via one or more sharing applications to one or more contacts, websites, social accounts, communication applications, profile, timeline, and feed, view number of reactions including number of views 1471, number of likes or particular type of reactions, number of comments, number of shares, number of followers, follow 1475 said structured site or website 1490 or account or user or source or advertiser or website related to said structured site or website 1490, report 1480 as inappropriate or spam to server module 151, install 1477 smart client version of said structured site or website 1490 or add 1477 said structured site or website 1490 in one or more types of lists or categories or favorite or bookmark 1477 said structured site or website 1490 for later access or view or share, search 1446 within said structured site or website 1490, filter 1447 contents of said structured site or website 1490, wherein filter comprise filter contents of said structured site or website 1490 based on date & time or rang of date & time of posting or updating of one or more types of contents, type of content including photo, video, video, offer, webpage, product details, service details, event, menu, structured information, album, carousal, canvas, slideshow, web application, news, blog, survey, poll, one or more keywords, categories, tags, hashtags, object keywords, object models or image, and location, view structured post associated comments or reviews and associated replies 1485 posted or provided by other users, searching or viewing users, view average ratings provided by other users, searching or viewing users, click or tap on named Uniform Resource locator (URL) e.g. 1432/1433 from list of named Uniform Resource locators (URLs) in named Uniform Resource locator (URL) area 1437 which redirect user to Uniform Resource locator (URL) associated website or webpage, view structured site or website 1490 associated one or more types of structured information by clicking or tapping on presented tab or link or name of type of structured information 1491, click or tap on named Uniform Resource locator (URL) from list of named Uniform Resource locators (URLs) in named Uniform Resource locator (URL) area 1492 which redirect user to Uniform Resource locator (URL) associated website or webpage.

In an embodiment user can search 1497, provide contacts information including e-mail address, phone number and account names of one or more social network to invite them or invite searched and selected one or more other users of network and in the event of acceptance of invitation connect them for enabling them to share one or more structured sites, structured pages, structured posts and share associated logged activities, actions, events, transactions, status and one or more types of reactions including viewed, liked, commented, rated, transacted, registered and shared one or more structured sites, structured pages, structured posts, view posts, follow, view profile, communicate with each other and send and receive messages. In an embodiment enable invitee to delete inviter's request to connect with invitee. In an embodiment server 110 enables users of network to search other users of network 1497 to view profile, number of followers, following and posts and follow particular user or selected one or more users by clicking or tapping on “Follow” button”. In an embodiment server 110 enables users of network to search other users of network 1497 and view profile and invite one or more selected users to connect with them and in the event of acceptance of connection request connecting each other for creating one or more types of networks including social network, business or professional network, and customer network.

In an embodiment server module 151 maintains updated index data of structured site or website 1490. In an embodiment server module 151 maintains updated data and contents of structured site or website 1490. In an embodiment maintain updated index data of structured site or website 1490 on external server(s) or database(s) and allow server module 151 of server 110 to access said index data of structured site or website 1490. In an embodiment maintain structured site or website 1490 including associated updated data and contents of structured site or website 1490 on external server(s) or database(s) and allow server module 151 of server 110 to access said structured site or website 1490 and associated data and contents of structured site or website 1490.

In an embodiment user can view clicked or tapped search result item 1499 associated structured site or website 1490 in right side of search result, so user can scroll or view search results and can view only one clicked or tapped search result item associated structured site or website 1490 at a time.

In an embodiment user can view search results on first interface and can view clicked or tapped search result item 1499 associated structured site or website 1490 in second interface.

In an embodiment user can view clicked or tapped search result item 1499 associated structured site or website 1490 overlay on search results and in the event of closing of structured site or website 1490 again view search results or search interface.

In an embodiment user can view only search result items associated structured sites or websites and can scroll up or scroll down to view structured sites or websites.

In an embodiment user can view updated structured posts in chronological order of followed structured site or website in structured site or website.

In an embodiment identifying search result associate unique identity or extracting unique identity (e.g. “gucci.com”) based on parsing search result (e.g. 1499) associated Uniform Resource Locator (URL) or web address (e.g. 1420) or metadata; automatically determining or preparing or generating query based on said identified unique identity (e.g. select * from [table name e.g. “all_strucutrued_info”] where [field_name e.g. “Global_Unique_Identity”]=“Gucci.com”); and automatically executing said query to automatically search, identify, invoke or retrieve or generate said identified unique identity (e.g. “Gucci.com”) associated one or more types of structured contents, structured data or structured website (e.g. 1490).

In an embodiment displaying said retrieved or generated one or more types of structured contents, structured data or structured website (e.g. 1490), wherein generating structured contents, structured data or structured website (e.g. 1490) based on pre-defined or pre-set structure or template or configuration and associated one or more types of settings (Discussed in detail in FIGS. 2-13).

In an embodiment displaying said retrieved or generated one or more types of structured contents, structured data or structured website (e.g. 1490) with said search result item (e.g. 1499) of search results, wherein search results comprise one or more search result items (e.g. 1499) and each search result (e.g. 1499) item may comprise title 1417, Uniform Resource Locator (URL) or web address 1420 and snippet 1422.

In an embodiment identifying unique identity (e.g. unique identity of website e.g. “Gucci.com”) based on search result item 1499 of search results comprise identifying worldwide unique domain name or unique domain name 1420 including a top-level domain name portion (e.g. “.com”) and a second-level domain name portion (e.g. “gucci”), wherein the top-level domain name portion specifying a top-level domain (e.g. “.com”) and the second-level domain name portion including at least one word or host name (e.g. “gucci”) or unique fully qualified domain name (FQDN) or absolute domain name (e.g. “Gucci.com”) including at least a top-level domain (e.g. “.com”) or second level domain name (e.g. “gucci”) or identifying unique user name (e.g. 2281/2282/2283/2284/2285/2286/2287/2288) of one or more external networks, websites, social networks, applications and services (e.g. Facebook™, Linked-In™, Twitter™, Instagram™) based on Uniform Resource Locator (URL) or parsing search result item 2225 associated Uniform Resource Locator (URL) or web address 2215 of website or webpage and identifying said identified unique user name or unique profile link of external network (e.g. 2281 or 2282 or 2283 or 2284 or 2285 or 2286 or 2287 or 2288) associated unique identity (e.g. unique identity of user e.g. “RathodYogesh” 2289) or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

In an embodiment maintaining or accessing pre-defined or pre-set or pre-configured structure or template or set-up or composition or configuration of structured website including associated one or more types settings, elements, widgets, objects, applications, controls and Graphical User Interfaces (GUIIs) and structured contents and structured data (Discussed in detail in FIGS. 3-13); identifying search result associate unique identity or extracting unique identity (e.g. “gucci”) based on parsing search result 1499 associated Uniform Resource Locator (URL) or web address 1420 or metadata; automatically determining or preparing or generating query (e.g. select * from [table name e.g. “all_strucutrued_info”] where [field_name e.g. “Global_Unique_Identity”]=“Gucci.com”) based on said identified unique identity (e.g. “gucci”); and automatically executing said query (e.g. select * from [table name e.g. “all_strucutrued_info”] where [field_name e.g. “Global_Unique_Identity”]=“Gucci.com”) to automatically search and identify said identified unique identity (e.g. “gucci”) associated one or more types settings, elements, objects, applications, interfaces, controls and Graphical User Interfaces (GUIs) and structured contents and structured data (Discussed in detail in FIGS. 3-13); and invoking or generating structured website 1490 based on said identified and retrieved one or more types settings, elements, objects, applications, interfaces, controls and Graphical User Interfaces (GUIs) and structured contents and structured data (Discussed in detail in FIGS. 3-13).

identifying unique identity (e.g. “gucci”) based on search result item; automatically determining or preparing or generating query (e.g. select * from [table name e.g. “all_strucutrued_info”] where [field_name e.g. “Global_Unique_Identity”]=“Gucci.com”) based on said identified unique identity (e.g. “gucci”); executing query (e.g. select * from [table name e.g. “all_strucutrued_info”] where [field_name e.g. “Global_Unique_Identity”]=“Gucci.com”) to automatically searching, identifying, invoking or retrieving or generating said identified unique identity associated one or more types of structured contents, structured data or structured website 1490; displaying said retrieved one or more types of structured contents, structured data or structured website 1490 with said search result item 1499.

In an embodiment receiving, from a first computing device of a first user, a search query 1405 to search for information on the World Wide Web or search for webpages with information that matches said search query 1405; searching, matching and identifying search results 1499; serving or presenting said search query 1405 specific search result items (e.g. 1499) or search results or search results pages to a first computing device of a first user, wherein search result item (e.g. 1499) may comprise title 1417, Uniform Resource Locator (URL) or web address 1420 and snippet 1422; identifying search result associate unique identity or extracting unique identity (e.g. “gucci”) based on parsing search result 1499 associated Uniform Resource Locator (URL) or web address 1420 or metadata; automatically determining or preparing or generating query (e.g. select * from [table name e.g. “all_strucutrued_info”] where [field_name e.g. “Global_Unique_Identity”]=“Gucci.com” and contains (field1, ‘ “firstword” or “secondword”’) based on said search query 1405 associated one or more keywords (e.g. “gucci” and “handbags”) and said identified unique identity (e.g. “gucci.com”); and automatically executing said query (e.g. select * from [table name e.g. “all_strucutrued_info”] where [field_name e.g. “Global_Unique_Identity”]=“Gucci.com” and contains (field1, ‘“firstword” or “secondword”’) to said search query (handbags) associated one or more keywords specific (e.g. “gucci” and “handbags”) and identified unique identity (e.g. “gucci”) associated one or more types of structured contents, structured data or contents 1445/1450 within structured website 1490 and displaying said identified one or more types of structured contents, structured data or contents within structured website 1490 with said search result item 1499 and highlighting search query related one or more keywords (e.g. “handbags” 1444) in said displayed one or more types of structured contents, structured data or contents within structured website 1490.

In an embodiment loading one or more identified structured content items or structured data or content items within structured website 1490 comprises a photograph or a video or a post contains photo, video, voice, text, location information, one or more types of contents or multimedia, one or more types of actions and reactions controls or Graphical User Interfaces (GUIs) and any combination thereof 1450; each viewing of the identified structured content items or structured data or content items (e.g. 1450) within structured website 1490 comprising sequential display (in an embodiment user can navigate next via next button or control 1458 or navigate previous via previous button or control 1453) of the plurality of identified structured content items or structured data or content items (e.g. 1450) within structured website 1490, wherein present on the display a first identified structured content item (e.g. 1450) or structured data or content item (e.g. 1450) within structured website 1490 of the set of identified structured content items or structured data items or content items within structured website 1490; receive from a touch controller a haptic contact signal indicative of a gesture applied to the display 1490; wherein the controller in response to the haptic contact signal, proceeds to load and present on the display 1490 a second identified structured content items or structured data or content item within structured website 1490 of the set of identified structured content items or structured data items or content items within structured website 1490 or present on the display 1490 loaded second identified structured content items or structured data or content item (if any) within structured website of the set of identified structured content items or structured data items or content items within structured website.

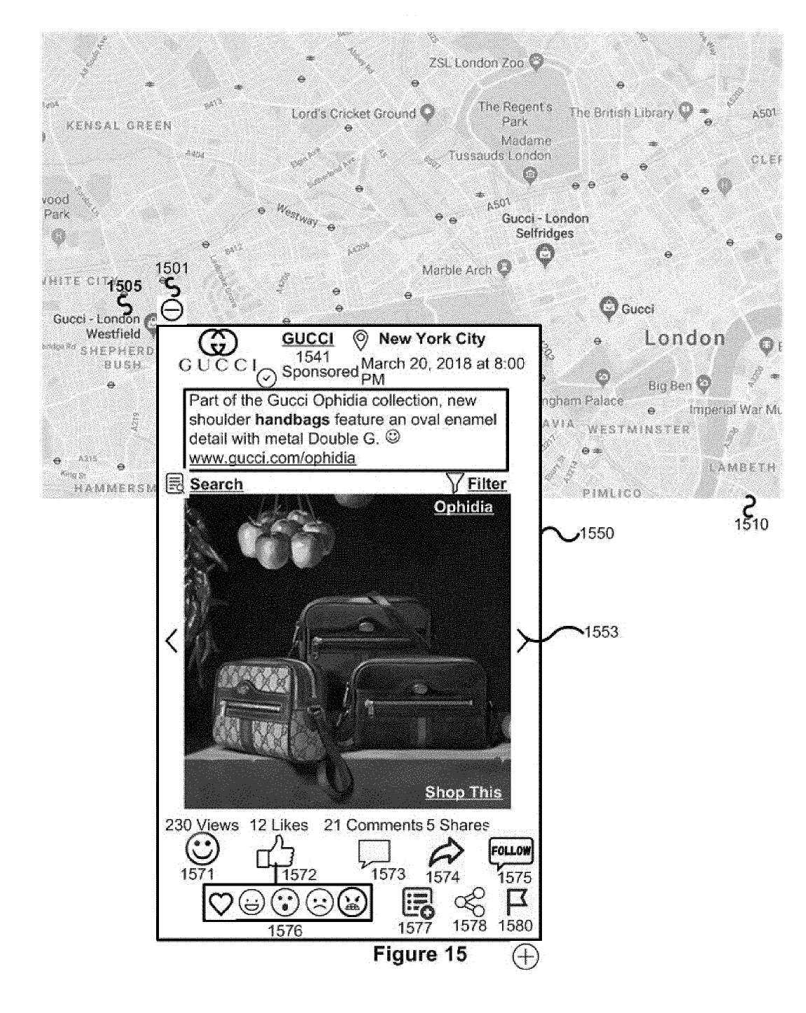

FIG. 15 illustrates, in an embodiment enabling to attach or integrate structured site or website with one or more websites, webpages, messages, contents, in photo, in video, in post, in map 1510 associate place or location or within pre-defined geo-fence boundary 1505, applications, interfaces, widgets via one or more types of controls including button, link, menu item, icon, image. In an embodiment in the event of click or tap on place 1505 associated expand icon 1501 identify, serve, load and present structured site or website associated first or matched or relevant structured post 1550 and in the event of click or tap on collapse icon 1501 hide or unload structured site or website. All other features of structured site or website 1490 discussed in detail in FIG. 14.

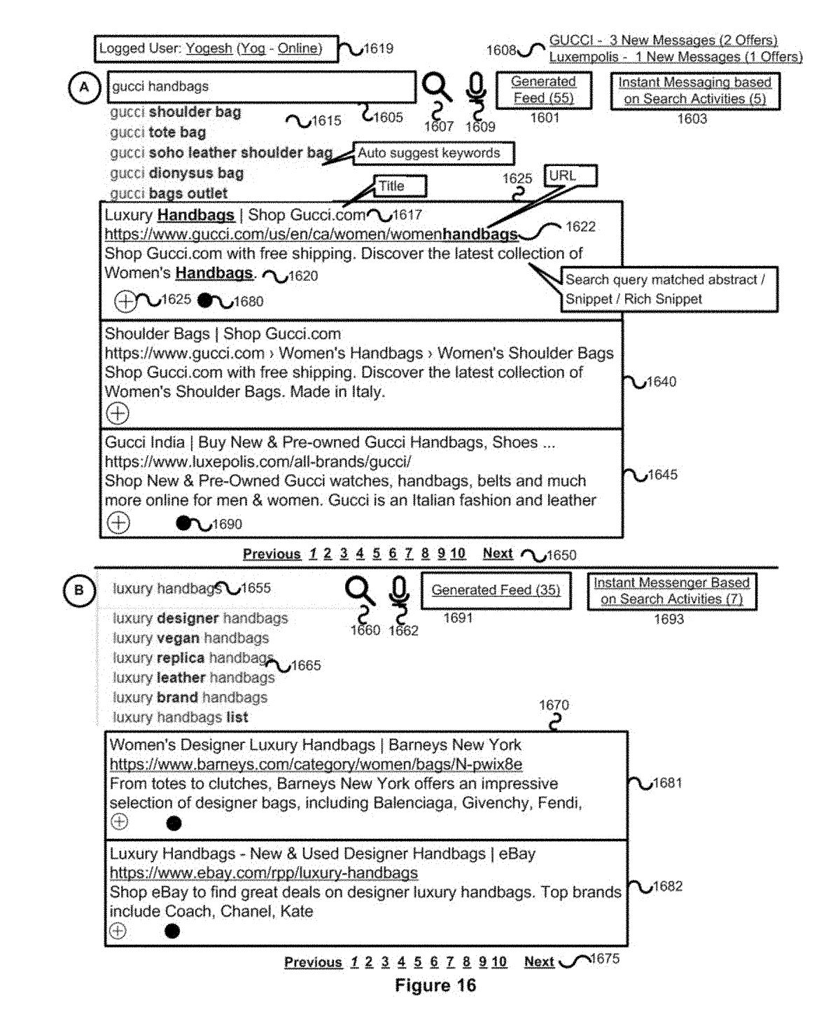

FIG. 16 Graphical User Interface (GUI) of Search Application (Smart Client or Web based) 271 (In an embodiment Search Application (Smart Client or Web based) 271 connected with server module web search engine 152 and/or server module Structured Site/Website Management & Searching 151 and Monitoring searching activities and actions and generating feed based on monitored search related activities and actions 153 of sever 110). Server module 152 receives, from a client search application 271 of a first computing device 130/FIG. 2 of a first user, a search query 1605 to search for information on the World Wide Web or search for webpages with information that matches said searching query 1605. Server module 152 of server 110 searches, matches, identifies, retrieves and generates said search query 1605 specific search results 1625. Server module 152 of server 110 serves and presents said search query 1605 specific search result items 1620/1630/1635/1640/1645 or search results 1625 or search results pages 1625. Searching user can perform one or more searches based on one or more search queries. For example server module 152 receives, from a client search application 271 of a first computing device 130/FIG. 2 of a first user, a search query 1655 to search for information on the World Wide Web or search for webpages with information that matches said searching query 1655. Server module 152 of server 110 searches, matches, identifies, retrieves and generates said search query 1655 specific search results 1670. Server module 152 of server 110 serves and presents said search query 1655 specific search result items 1681/1682/1683 or search results 1670 or search results pages 1670.

Server module 151 of server 110 identifies identity of search result item associated website, webpage, source, account or user based on extracting worldwide or global unique identity domain name or host name or second level domain name from parsing search result item associated Uniform Resource Locator (URL) or web address of website or webpage. In an embodiment server module 151 identifies identity of registered user of server 110 based on said matching said global unique identity in the form of unique domain name with said identified registered user associated stored website or domain name or hostname.

Server module 153 of server 110 monitors and tracks each search result item of search result associated activities, actions, events, transactions, interactions, session, status, behaviours, communications, sharing and reactions and logs and stores to server 110 database 115 with said identified unique identity of searching user and/or with said identified unique identity of user, source, account, website, or domain name and/or with said search query specific keywords and/or with said identified unique identity of search session of said identified unique identity of searching user and/or with similar search queries related to said identified unique identity of said searching user, wherein said monitored or tracked or logged one or more types of activities, actions, events, transactions, interactions, session, status, behaviours, communications, sharing and reactions comprise present in search result or view in search result (Impression), click on title link or Uniform Resource Locator (URL), view similar, follow search result item associated source, account, user or website, invite to connect or connect with search result item associated source, account, user or website, view or viewed search result item associated website or webpage, view or viewed search result item associated website or webpage for particular duration, view or viewed search result item associated website associated one or more or particular category or named product, service, section, feature and webpage, view or viewed search result item associated website associated categories, keywords, hashtags, tags, and taxonomy, added to cart, purchased, booked, or get appointment or ordered one or more or particular category or named product or service or movie or event or play with associated details, data and metadata, playing of particular named, category or keyword associated video or music or song or movie, liked photo, video, product, service, post, website, webpage associated identified keywords, identified keywords based on recognized objects in photo or video (series of images), associated metadata, name, tags, hashtags and categories, visiting or visited one or more types of social network including Facebook Page or Feed or Posts, Twitter Feed or Profile or Account, Instagram Page, Linked-in Profile, Youtube Video, Snapchat, Google+, Pinterest,

provided comments, reviews, ratings and associated keywords, shared website or webpage link or Uniform Resource locator (URL), posts, products and associated keywords and metadata, checked-in or visited one or more places & associated details, status, activities, current of monitored user device's location, participating or participated particular event and associated location, place and details, entered in or stays at or stay for particular duration or exit from pre-defined Geo-fence and associated details and activities, duration of search session, time spend on particular identified website or webpage or feature of webpage, click or view particular type of content including news, blog, photo, video, product, service, about, and contact, structured site or structured website related analytics, insights, statistics and monitored or tracked or logged one or more types of activities, actions, events, transactions, interactions, session, status, behaviours, communications, sharing and reactions comprises liked, disliked, rated, commented, shared, bookmarked, added to one or more types of lists, transacted including make payment, purchase or order product or service, and get appointment, followed, connected, communicated, install application, participated, subscribed, registered one or more structured sites or pages or posts and associate structured details related keywords and metadata, viewing of structured site or structured website, associated one or more structured pages and structured posts, photos, videos, and profile, one or more types of actions including follow, form or survey fill-ups, making of calls, sending and receiving of messages, video or VOIP calls, each type of reaction specific reactions including likes, comments, and shares, ratings, transactions, registration, membership, installation of applications and participation with events or groups or deals or group deals, duration of time spend on website or particular web pages clicked from structured site or website, duration of time spend on structured site or structured website or associated structured pages or associated structured posts, disclosure by searching user as a customer or prospective customer of or identified customer or prospective customer of structured site or website associated website, seller, brand, product or service, invitation to connect send, acceptance of invitation to connect, claim offers including discounts, coupons, redeemable points, vouchers, cashbacks and samples or gifts, by particular product or subscribe particular service, download, make bookings, get appointments, amount of transactions and any combination thereof.

Server module 153 identifies matched structured sites or websites and associated pages, posts and posts, photos, videos, and one or more types of contents from one or more sources including server 110 based on said search query, one or more types of user data associated or related with said searching or viewing or requesting user and said monitored or tracked or logged one or more types of activities, actions, events, transactions, interactions, session, status, behaviours, communications, sharing and reactions and generates contextual feed items based on said search query, one or more types of user associated or related data and said monitored, tracked, logged and stored one or more types of one or more search result or search result items associated activities, actions, events, transactions, interactions, session, status, behaviours, communications, sharing and reactions and serving and presenting said generated feed items in current search query specific feed or in search result session specific feed or in similar search queries specific feed or in user's timeline or in one or more type of feed or in user's profile or in page or webpage or interface or application or via one or more communication channels, services, media, interface and applications including email, instant messenger or 3^{rd} parties or external one or more types of one or more websites, accounts, profile, applications and services.

In an embodiment user can click or tap on “expandable” switchable icon 1625 to view search result item associated structured site or website 1490. In an embodiment user can click or tap on “collapse” switchable icon 1625 to hide search result item associated structured site or website 1490. In an embodiment searching user can search for information on the World Wide Web or search structured site or website or search both combined (discussed in detail in FIGS. 1-15).

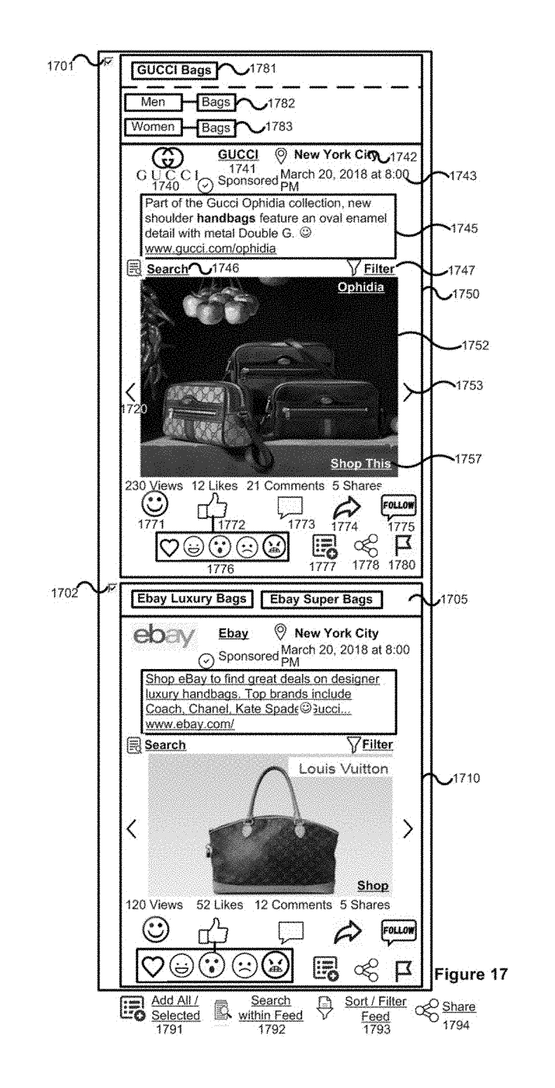

FIG. 17 illustrates Graphical User Interface (GUI) of Feed Application (Smart Client or Web based) 272 (In an embodiment Feed Application (Smart Client or Web based) 272 connected with server module 153) for enabling searching user or viewing user to view said generated and updated feed items 1701, so searching or requesting or viewing user can receive and view updated, news, contextual posts or one or more types of contents including photos, videos, news, article, blog, images, live video stream, web applications, ULRs or links, text, associated location information, emoticons, number of each type specific reactions, view and access associated reactions and actions controls or Graphical User interfaces (GUIs) and any combination thereof, wherein searching or requesting or viewing user can receive and view updated, news, contextual posts or one or more types of contents posted by search result item associated website or associated account with server 110 and from one or more contextual sources. In an embodiment user can tap or click on generated feed button 1601 to view real-time generated or updated contextual one or more types of contents or feed items or structured sites or websites or posts 1701 including view contextual structured posts of structured site or website first in presented structured site or website. In an embodiment user can view next contextual structured posts of structured site or website in presented structured site or website by tapping or clicking on next button or icon 1753.

In an embodiment presenting said feed items or structured sites or websites or posts or one or more types of contents in auto determined lists or categories or named tabs or named links or feed type or interface or application including present followed sources specific fed items in followed sources feed, present connected users or friends or contacts related feed items in user's timeline, present connected professional or businesses related feed items in business or professional or employment related feed, present connected websites related feed items in customer or prospective customer feed.

In an embodiment user can view feed items in one or more auto created lists or categories including followed or following sources, connected sources, friends or contacts, professional or business contacts, consumers of peculiar products or services providers or sellers related sources, reacted (liked, rated, commented, shared) sources, transacted sources, clicked sources, searched related sources (in categories of search queries of user), visited websites sources, viewed profiles related sources, visited or entered, stayed & exited in pre-defined geo-fence, checked-in places related sources, scanned images or code including QRcode to view information related sources.

In an embodiment user can select all or one or more posts or feed items 1701/1702 and can add to one or more types of lists or categories including Bookmark, Liked or Favorite, Save, Sharable, Installable, List of structured site or website, add to selected one or more categories for later view, access and manage, based on user's home and work address identified local business or places related sources, current trends related sources, editor picked related sources, interacted entities related sources.

In an embodiment present all feed types associated feed items in single parent feed in chronological order. In an embodiment present or display feed items based on chronological order.

In an embodiment enabling user to sort or filter 1793 feed items based on date & time ranges, source, type of feed item, categories of source, content type of feed item including photo, video, post, news, blog, offer, product, service, event, menu, album, carousal, canvas, slideshow, live stream, voice, file type, type of structured information, on-demand service, map & direction, type of post including jocks, news, slogan, movie, local, product, service, brand, company, information, selfie, travel, food based on recognized objects in photo or video or post, type of sources including contacts (network, email, phone, 3^{rd} parties social accounts, websites), business, professional, social.

In an embodiment enabling user to like, dislike, rate, based on slider provide indication to like more or less, follow, unfollow, remove, block, report including mark as spam or inappropriate, feed item associated sources.

In an embodiment enabling user to share 1794 particular or one or more selected feed item with one or more contacts, connected users of network, groups, followers and 3^{rd} parties one or more applications or social networks related one or more accounts, profiles, users, contacts, connected users, groups, followers.

In an embodiment enabling user to search 1792 within feed or feed associated feed items based on one or more keywords, search query, apply advance search criteria including search posted date & time range specific, selected one or more sources, source categories, location or places or type or category of locations or places, type, categories supplied object model or image (matching supplied object model or image with recognized objects in feed item associated photo or video) specific feed items.

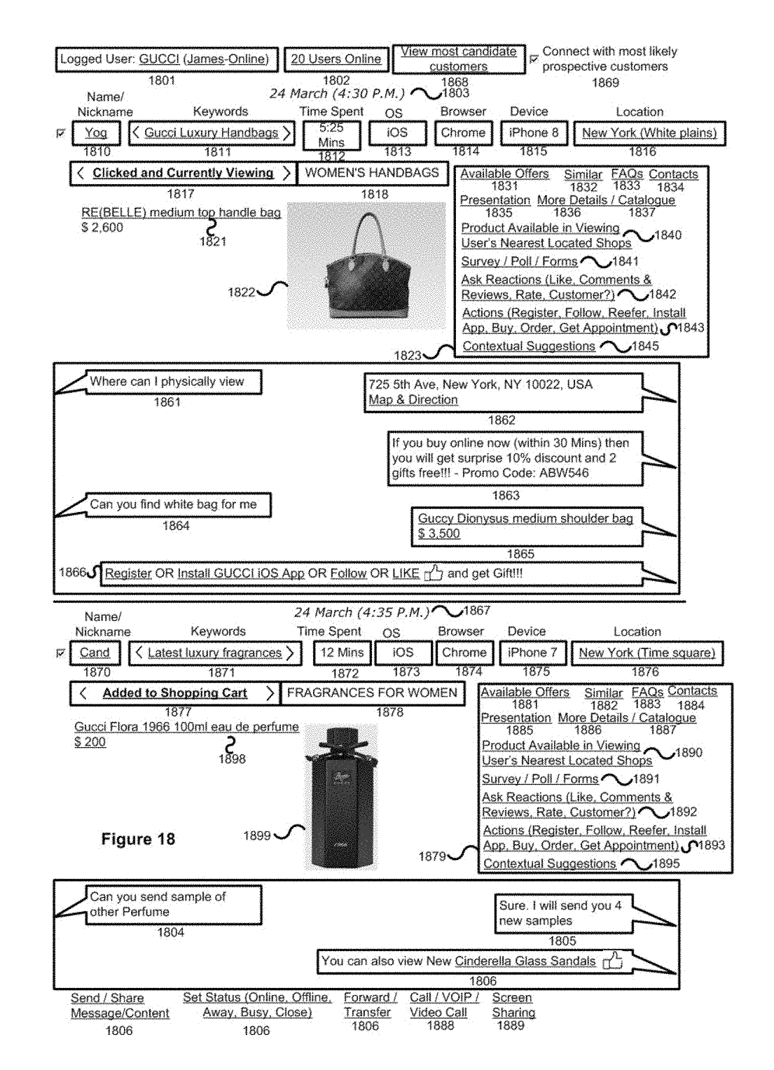

FIG. 18 illustrates Graphical User Interface (GUI) of Communication Application (Smart Client or Web based) 273 including Instant Messenger (In an embodiment Communication Application (Smart Client or Web based) 273 connected with server module 154) for enabling website or structured site or website owner or administrator or user to communicate, collaborate, participate with searching users for sharing, communication, collaboration, participation, conducting one or more actions and reactions whose search result contains their website or domain name in search result item and searching users interacting with their website or structured site or website wherein interaction comprise click on URL or link associated with said website or structured site or website owner or administrator or user, visiting or viewing or reacting on or taking actions on website or structured site or website of said website or structured site or website owner or administrator or user.

Server module 152 receiving, from a client search application 271 of a first computing device 130/FIG. 2 of a first user, a search query 1605 to search for information on the World Wide Web or search for webpages with information that matches said searching query 1605. Server module 152 of server 110 searches, matches, identifies, retrieves and generates said search query 1605 specific search results 1625. Server module 152 of server 110 serves and presents said search query 1605 specific search result items 1620/1630/1635/1640/1645 or search results 1625 or search results pages 1625. Searching user can perform one or more search searches based on one or more search queries. For example server module 152 receives, from a client search application 271 of a first computing device 130/FIG. 2 of a first user, a search query 1655 by server module 152 to search for information on the World Wide Web or search for webpages with information that matches said searching query 1655. Server module 152 of server 110 searches, matches, identifies, retrieves and generates said search query 1655 specific search results 1670. Server module 152 of server 110 serves and presents said search query 1655 specific search result items 1681/1682/1683 or search results 1670 or search results pages 1670.

Server module 151 of server 110 identifies identity of search result item associated website, webpage, source, account or user based on extracting worldwide or global unique identity domain name or host name or second level domain name from parsing search result item associated Uniform Resource Locator (URL) or web address of website or webpage. In an embodiment server module 153 identifies identity of registered user of server 110 and identify structured site or website 1490 based on matching said global unique identity in the form of unique domain name with said identified registered user associated stored website or domain name or hostname. In an embodiment user can click or tap on “expandable” switchable icon 1625 to view search result item associated said identified structured site or website 1490. In an embodiment user can click or tap on “collapse” switchable icon 1625 to hide search result item associated structured site or website 1490. In an embodiment searching user can search for information on the World Wide Web or search structured site or website or search both combined (discussed in detail in FIGS. 1-15).

Server module 154 of server 110 monitors and tracks each search result item of search result associated activities, actions, events, transactions, interactions, session, status, behaviours, communications, sharing and reactions and logs and stores to server 110 database 115 with said identified unique identity of searching user and/or with said identified unique identity of user, source, account, website, or domain name and/or with said search query specific keywords and/or with said identified unique identity of search session of said identified unique identity of searching user and/or with similar search queries related to said identified unique identity of said searching user, wherein said monitored or tracked or logged one or more types of activities, actions, events, transactions, interactions, session, status, behaviours, current location of searching user's device, collaborations, communications, sharing and reactions comprise present in search result or view in search result (Impression), click on title link or Uniform Resource Locator (URL), view similar, follow search result item associated source, account, user or website, invite to connect or connect with search result item associated source, account, user or website, view or viewed search result item associated website or webpage, view or viewed search result item associated website or webpage for particular duration, view or viewed search result item associated website associated one or more or particular category or named product, service, section, feature and webpage, view or viewed search result item associated website associated categories, keywords, hashtags, tags, and taxonomy, added to cart, purchased, booked, or get appointment or ordered one or more or particular category or named product or service or movie or event or play with associated details, data and metadata, playing of particular named, category or keyword associated video or music or song or movie, liked photo, video, product, service, post, website, webpage associated identified keywords, identified keywords based on recognized objects in photo or video (series of images), associated metadata, name, tags, hashtags and categories, visiting or visited one or more types of social network including Facebook Page or Feed or Posts, Twitter Feed or Profile or Account, Instagram Page, Linked-in Profile, Youtube Video, Snapchat, Google+, Pinterest, provided comments, reviews, ratings and associated keywords, shared website or webpage link or Uniform Resource locator (URL), posts, products and associated keywords and metadata, checked-in or visited one or more places & associated details, status, activities, current of monitored user device's location, participating or participated particular event and associated location, place and details, entered in or stays at or stay for particular duration or exit from pre-defined Geo-fence and associated details and activities, duration of search session, time spend on particular identified website or webpage or feature of webpage, click or view particular type of content including news, blog, photo, video, product, service, about, and contact, structured site or structured website related analytics, insights, statistics and monitored or tracked or logged one or more types of activities, actions, events, transactions, interactions, session, status, behaviours, communications, sharing and reactions comprises liked, disliked, rated, commented, shared, bookmarked, added to one or more types of lists, transacted including make payment, purchase or order product or service, and get appointment, followed, connected, communicated, install application, participated, subscribed, registered one or more structured sites or pages or posts and associate structured details related keywords and metadata, viewing of structured site or structured website, associated one or more structured pages and structured posts, photos, videos, and profile, one or more types of actions including follow, form or survey fill-ups, making of calls, sending and receiving of messages, video or VOIP calls, each type of reaction specific reactions including likes, comments, and shares, ratings, transactions, registration, membership, installation of applications and participation with events or groups or deals or group deals, duration of time spend on website or particular web pages clicked from structured site or website, duration of time spend on structured site or structured website or associated structured pages or associated structured posts, disclosure by searching user as a customer or prospective customer of or identified customer or prospective customer of structured site or website associated website, seller, brand, product or service, invitation to connect send, acceptance of invitation to connect, claim offers including discounts, coupons, redeemable points, vouchers, cashbacks and samples or gifts, by particular product or subscribe particular service, download, make bookings, get appointments, amount of transactions and any combination thereof.

In an embodiment websites implements or integrates or embedded or deploy visitors tracking script or tracking code including Ecommerce tracking code to website's shopping cart which tracks when user visits said website or webpage of said website via server module 154 of server 110 and server module 154 of server 110 keeps monitors and track of each clicked URL associated with search result item associated websites (who implemented or embedded or ingrates said scripts) associated one or more types of activities, actions, events, transactions, interactions, session, status, behaviours, communications, sharing and reactions and logs and stores to server 110 database 115 with said identified unique identity of searching user and/or with said identified unique identity of user, source, account, website, or domain name, wherein script provided by server 110 which website owner can copy the script and paste it before the </body> tag of website on each page or each product or service details or post or photo or video or event or menu or album or structured infuriation or form, one or more types of controls including buttons, radio buttons, checkboxes, combo boxes, lists, menu or menu items, sections, icon, image, links or Uniform Resource Locator (URL) and one or more types of Graphical User Interface (GUIs). The best practice to do this is to include it in a file that is common to all web pages in website. A monitoring (or tracking) code lets the server module 154 of server 110 gather data on a website. This makes it possible to track user activity on said website. In an embodiment each of registered user or account with server 110 gets a unique monitoring code when they activate their account, wherein monitoring code makes possible for the server module 154 of server 110 to identify and monitor visitors on said website, automatic display of live instant messenger or chat or application (discussed in FIG. 18) on their website. The Mobile Package contains server-side tracking codes that use PHP, JavaServer Pages, ASP.NET, or Perl for its server-side language.

In an embodiment sever model 154 identifies identity of search result item 1620 associated website or Uniform Resource Locator (URL) 1622 associated unique identity or unique identity of user account. In an embodiment sever model 154 identifies identity of search result item 1620 associated website, webpage, source, account or user based on extracting worldwide or global unique identity domain name or host name or second level domain name from parsing search result item associated Uniform Resource Locator (URL) or web address of website or webpage 1622. In an embodiment sever model 154 identifies identity of registered user and identify identity of structured site or website based on matching said global unique identity in the form of unique domain name with said identified registered user associated stored website or domain name or hostname.

In an embodiment sever model 154 identifies identity of search result item 1620 associated account or user based on extracting unique user name and associated particular social network and matching said identified unique user name with user names of users of network who provided their one or more social networks' unique user names. In an embodiment sever model 154 identifies identity of search result item 1620 associated account or user based on matching search result item associated Uniform Resource Locator (URL) or web address with one or more profile Uniform Resource Locators (URLs) of users of network to identify unique user who provided their one or more social networks' unique profile Uniform Resource Locators (URLs).

In an embodiment sever model 154 identifies identity of registered user and identify identity of structured site or website based on matching said identified unique profile URL or identified user name associated with 3^{rd} parties website or application including social network with said identified registered user associated stored unique profile URLs or identified user names rated to one or more websites or applications including social networks.

In an embodiment server module 154 of server 110 monitors and tracks each search result item of search result associated activities, actions, events, transactions, interactions, session, status, behaviours, communications, sharing and reactions and logs and stores to server 110 database 115 with said identified unique identity of searching user and/or with said identified unique identity of user, source, account, website, or domain name and/or with said search query specific keywords and/or with said identified unique identity of search session of said identified unique identity of searching user and/or with similar search queries related to said identified unique identity of said searching user, wherein based on said monitored or tracked or logged one or more types of activities, actions, events, transactions, interactions, session, status, behaviours, current location of searching user's device, collaborations, communications, sharing and reactions, user data including user's home, work and current locations, preferences, interests and friends of friends or connections of connections, followers, following users suggesting prospective connections. In an embodiment identify rank of suggested prospective connections based on transacted, liked, registered, add to one or more types of lists, visited and spend particular duration of time, nearest location, and followed websites or accounts or users or structured site or website.

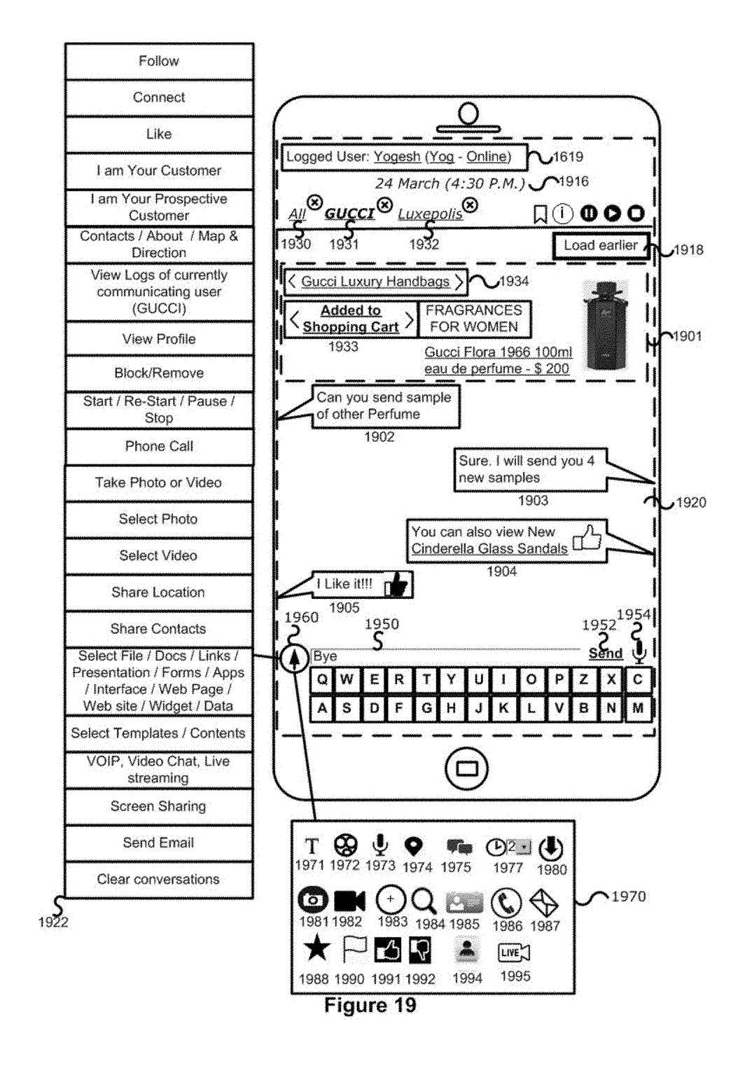

FIG. 18 illustrates Graphical User Interface (GUI) of Communication Application 273 of said identified source or account or user's device (In an embodiment Communication Application 273 connected with server module 154). In an embodiment sever model 154 presents said identified source or account or user associated with said search result item 1620, said search result item 1620 associated monitored, tracked, logged and stored one or more types of information about one or more types of one or more activities, actions, events, transactions, interactions, session, status, behaviours, communications, sharing and reactions to Communication Application 273 of for enabling said search result item 1620 associated source or account or user to communicate, collaborate, share, transact, connect, participate with said searching user via Communication Application 273 (discuss in FIG. 19) of searching user's device. In an embodiment particular search result item 1620 associated identified source or account or user can communicate with searching user based on presented current activity type or one or more selected activity types including view, like, comment, rate, share, follow, subscribe, add to cart, book, buy, order particular product or service or photo or video or post in website or structured site or website, view particular feature or webpage, added to cart particular product or service, like particular product or service, follow, providing indication that searching user is customer or prospective customer, view profile, monitored current location of searching user's device or checked-in place by searching user related search result item 1620 associated identified source or account or user.

FIG. 18 illustrates Graphical User Interface (GUI) shows logged-in user name 1810 of search result item 1620 associated identified source or account or user (e.g. “GUCCI”) and currently communicated user (e.g. “James”). In an embodiment administrator of search result item 1620 associated identified source or account or user (e.g. “GUCCI”) can create, add, update, remove and define one or more users and provides one or more types of rights and privileges, apply privacy policies, roles including administrator, agent or editor or communicator, moderator, advertiser or promoter, supervisor & like), and privacy settings. Currently logged-in user 1801 can set or provide one or more status 1806 including Online, Offline, Busy, Away, and Close. Currently logged-in user 1801 can view number of searching users 1802 online or who searching or searched or viewing their website or structured site or website and can select particular or one or more searching users and can communicate with them. In an embodiment server module 154 determines most prospective customer or candidate customers' base on searching users one or more types of actions including like, provide indication that searching user is current or past customer or subscriber or prospective customer or subscriber, current subscriber (visit for renewals), follow, connect, register with website or structured site or website, past or near past transactions, add to cart particular product or service, duration of time spend on website or structured site or website and presents said list 1868 of determined searching users to logged-in user 1801. In an embodiment logged-in user 1801 can instantly connect 1869 with all most likely or prospective or candidate customers (Most of the time searching user quickly searches and visits one or more websites to identify relevant websites, products or services, so instant connection and communication with said determined most prospective customer(s) is needed). In an embodiment logged-in user 1801 can provide one or more types of status 1801 including online, offline, facility not available, busy, away, and close. In an embodiment logged-in user 1801 can view searching user's name 1810 and public or allowed full or part of profile, wherein profile access via profile link 1810, searching or searched keywords or one or more variant search queries 1811, time spend on web site and structured site or website 1812, searching user's device operating system type or name 1813, searching user's device browser type or name 1814, searching user's device type or name 1815, monitored current location of searching user's device 1816, current activity, action, event, transaction, communication, reaction type, name, template, metadata, system data 1817 and associate details and structured data 1818/1821/1822. In an embodiment providing past activities, actions, events, transactions, communications, reactions, associate type, name, template, metadata, system data and associate details and structured data. In an embodiment enable to select from list 1817 type or name of activity, action, event, transaction, communication, reaction. In an embodiment view current search session related search results, which contains unique domain name of said logged-in user or account, associated related to sell of product or services (e.g. viewing product or service details) or selected or filtered or all activities, actions, events, transactions, communications, reactions, associate type, name, template, metadata, system data and associate details and structured data 1817. In an embodiment presenting said searching user 1810 related or searching user's 1810 related activity 1817 specific contextual resources, contents, structured contents, offers, links, actions and reaction controls or GUIS, suggestions, locations, presentations, similar products or services to logged-in user 1801 for enabling logged-in user 1801 to share with said searching user 1810. Based on current activity, action, event, transaction, communication, reaction type, name, template, metadata, system data 1817 and associate details and structured data 1818/1821/1822, logged-in user 1801 can determine what to share, ask, provide details and provide answers of queries of searching user 1861. For example logged-in searching user 1619, searched “Gucci handbags” and clicked on search result item 1499 of search results associated URL 1420 and visits website (e.g. “www.gucci.com”) and currently viewing particular product, wherein server module 154 monitors, tracks and stores said activity associate activity type name or template, and details including product page name or category (e.g. “WOMEN'S HANDBAGS”), product photo, product name & price (e.g. “RE(BELLE) medium top handle bag $2,600”) and generates, serves, and presents said logged activity details to logged-in user 1801 to Communication Application (Smart Client or Web based) 273 of logged-in user's 1801 device 135 including product photo (e.g. 1822), product name & price 1821 and product page category 1818. For example Searching user 1619 taps or clicks on icon or button or control 1680 and sends message or starts instant messaging with search result item associated online available user 1801, wherein logged-in user 1801 receives and views said instant message 1861 and provided answers 1862 to queries 1861. Then logged-in user selects and sends contextual offers 1863 to said searching user 1619. Searching user asks another question 1864, wherein logged-in user 1801 searches required products and send 1865 to said searching user 1619. In an embodiment logged-in user 1801 selects one or more actions and reaction controls, links, button or GUIs and prepare message 1866 and send to said searching user 1619. For example logged-in user 1801 selects “Register”, “Install App”, “Follow” and “Like” buttons or links and prepare message 1866 and send to searching user 1619, wherein searching user 1619 can register with “Gucci.com” website or structured site or website or install application via provided link or “Follow” or Like website or structured site or website of “GUCCI”. Likewise logged-in user 1801 communicates with other searching user 1870 for other related search keywords 1871 related product 1889/1898 and activity type 1877.

In an embodiment based on searching user permission, logged-in user 1801 can make calls, VOIP or video calls, share one or more types of contents, share screen 1889, send email 1888 to searching user (e.g. 1619). In an embodiment logged-in user 1801 can communicate with one or more searching users concurrently or selectively. In an embodiment logged-in user 1801 can transfer or forward 1806 message or initiated communication or message session with particular user to other logged-in or online available user.

FIG. 19 illustrates Graphical User Interface (GUI) of Communication Application 273 of said identified searching user's device (In an embodiment Communication Application 273 connected with server module 154). In an embodiment searching user while searching any time can click or tap on button or icon or link or control 1603 to invoke or open or initiate Communication Application 273 including instant messenger application (smart client or web based) and communicate with selected 1931 or preferred 1931 search result item 1620 associated said identified source or account or user (e.g. “GUCCI”) associated with said search result item 1620. In an embodiment in the event of communicating or sending of messages by search result item 1620 associated said identified source or account or user (e.g. “GUCCI”) associated with said search result item 1620 then notifying 1608 searching user about receiving of new messages including offers (negotiations, discounts, gifts, samples, vouchers, coupons, redeemable points, promo code, cashbacks, free services, deals), group deals, about launching of new products or services or shops or service center or branch), events, exhibition, application, requested call-to-actions and reactions, presentation, useful information (health effects, natural ingredients, benefits, advantages, tips, guidance, lowest price, reviews & ratings). In an embodiment enabling searching user to view search result item 1620 associated identified source or account or user's or their logged-in user's one or more types of status 1680 including online, offline, facility not available, busy, away, close. In an embodiment logged-in searching user 1619 can follow, connect, search result item associated identified unique website and structured site or website

In an embodiment enabling logged-in searching user 1619 to like, dislike, rate, provide comments, follow, connect post, product, service, event, menu item, photo, video, webpage, web application, smart client application, website and structured post, structured pages and structured site or website.

In an embodiment enabling logged-in searching user 1619 to provide indication that user is past or current customer or prospective customer for search result item associated source or account or user or website or structured site or website.

In an embodiment enabling logged-in searching user 1619 to end text 1971, emoticons, stickers or emoji 1972, record or recorded voice file 1973 share location 1974, ephemeral message 1777 (set view duration with message e.g. 10 seconds and send, wherein target recipients can view said message for said pre-set view duration e.g. 10 seconds and in the event of expiration of timer (e.g. 10 seconds), remove or hide said message from recipients and/or server and/or sender's device. In an embodiment timer can set by server or recipient to make message as transient), save selected message 1980, backup and restore messages, capture and send photo 1981, record video and send video 1982, select one or more photos, videos, albums, files and send 1983, search and share links, URLs, webpage, files, images, video 1984,

In an embodiment enabling logged-in searching user 1619 to make call 1986, send e-mail 1987, send SMS, provide ratings 1988, report as spam or inappropriate 1990, like 1991 and dislike 1992 message, save to contact 1993, share contacts, share screen, start and end live streaming or live video.

In an embodiment enabling logged-in searching user 1619 to start or initiate, pause, re-start, clear and stop communication or conversations or connections.

In an embodiment enabling logged-in searching user 1619 to block, un-block, remove, add or connect communication with particular search result item associated source or account or user or website or structured site or website.

In an embodiment enabling logged-in searching user 1619 to take one or more actions including view map & direction, view presentation (product, service details), buy, order, get appointment, subscribe, make payment, add to cart, share, refer, install, register, claim offers, negotiate, participate in group deals, send invitation to connect, direct or one tap or one click connect (if allowed by source or user or account or website or structured site or website), follow & refer or reactions including like, dislike, provide emoticons or stickers or emoji or expressions, rate, comment based on presented one or more actions or reactions controls or Graphical User interfaces (GUIs) in messages.

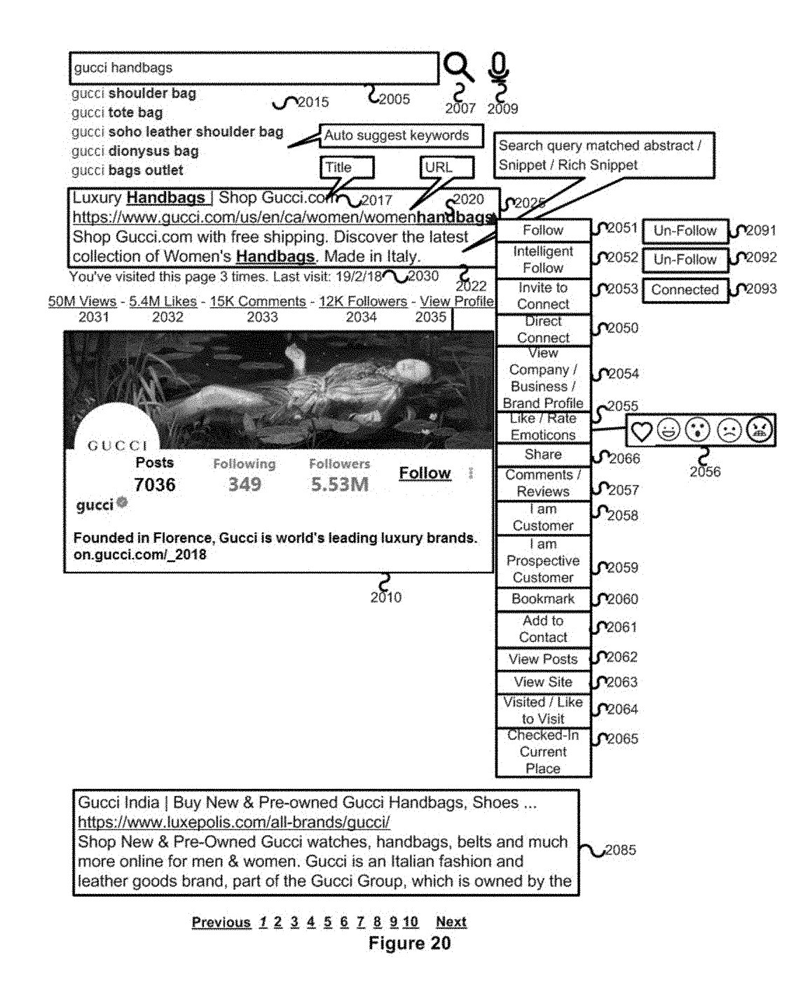

FIG. 20 illustrates Graphical User interface (GUI) of Search Application (Smart Client or Web based) 271 (In an embodiment Search Application (Smart Client or Web based) 271 connected with server module web search engine 152 and Search Result associated user actions and reactions module 155 of sever 110). Server module 152 receives, from a client search application 271 of a first computing device 130/FIG. 2 of a first user, a search query 2005 to search for information on the World Wide Web or search for webpages with information that matches said searching query 2005. Server module 152 of server 110 searches, matches, identifies, retrieves and generates said search query 2005 specific search results 2025. Server module 152 of server 110 serves and presents said search query 2005 specific search result items 2025/2085 or search results or search results pages.

Searching user to search based on user provided or entered or selected from suggested list of keywords 2015, provided by server module 152, search query or one or more keywords or key phrases 2005 and in the event of tapping or clicking on search button 2007, server module 152 receives said search query 2005 and finds search query or one or more keywords 2005 specific search results or information 2025/2085 on the World Wide Web. Web search engine uses automated programs called spiders or crawlers and has a large index of keywords and where those words can be found. Web search engine 152 is using web crawlers to organize information from webpages and other publicly available content in the Search index. Server module 152, serves said search results 2025/2085 which are generally presented in a line of results often referred to as search engine results pages (SERPs), wherein search result item comprise title of the webpage 2017, so searching user or viewing user can click the title to go to the site or website, URL or web address 2020 of the searched or matched web page and snippet or rich snippet 2022, below the URL is text 2022 that helps show how the page relates to searching user's query 2005. The words (e.g. “Gucci handbags”) 2005 searching user search for will show in bold (e.g. “handbags”) to make it easier for searching user to decide if the page has what searching user is looking for. Server module 155 extracts or parses or identifies unique domain name or host name or unique second level domain name (e.g. “Gucci”) from search query specific search result item 2025 associated Uniform Resource Locator (URL) or web address 2020 of website or webpage.

Server module 155 of server 110 identifies identity of search result item 2025 associated website, webpage, source, account or user (e.g. “GUCCI”) based on extracting worldwide or global unique identity domain name or host name or second level domain name (e.g. “Gucci”) from parsing search result item 2025 associated Uniform Resource Locator (URL) or web address 2020 of website or webpage. In an embodiment server module 155 identifies identity of registered user (e.g. “GUCCI”) of server 110 based on said matching said global unique identity in the form of unique domain name (e.g. “Gucci”) with said identified registered user (e.g. “GUCCI”) associated stored website or domain name or hostname (e.g. “Gucci”).

In an embodiment sever model 155 identifies identity of search result item 2025 associated website or Uniform Resource Locator (URL) 2020 associated unique identity or unique identity of user account. In an embodiment sever model 155 identifies identity of search result item 2025 associated website, webpage, source, account or user based on extracting worldwide or global unique identity domain name or host name or second level domain name from parsing search result item associated Uniform Resource Locator (URL) or web address 2020 of website or webpage. In an embodiment sever model 155 identifies identity of registered user and identify identity of structured site or website based on matching said global unique identity in the form of unique domain name with said identified registered user associated stored website or domain name or hostname.

In an embodiment server module 152 receive, from a first computing device of a first user, a search query 2005 to search for information on the World Wide Web or search for webpages with information that matches said searching query 2005 and searches, matches and identifies search results 2025/2085. Server module 152 serves or presents said search query 2005 specific search result items 2025/2085 or search results or search results pages to a first computing device 130/FIG. 2 of a first user, wherein search result item comprise title 2017, URL or web address 2020 and snippet 2022. Searching user is enable to follow or subscribe search result item 2025 associated uniquely identified source or user or account or website or product or service or brand 2020 by tapping or clicking on search result item associated or integrated or embedded “Follow” or “Subscribe” button or link or menu item or icon or control or Graphical User interface (GUI) 2051. In the event of tapping or clicking on “Follow” or “Subscribe” button or link or menu item or icon or control or Graphical User interface (GUI) 2051, Server module 155 receives, from a first computing device of a first user, request to follow or subscribe search result item 2025 associated source or account or user or website or webpage. Server module 155 identifies identity of source or account or user or website or webpage (e.g. “Gucci”) based on said request to follow or subscribe search result item associated identified domain name or host name, wherein identify domain name or host name or user name (e.g. “Gucci”) and type of social network account based on extracting or parsing search result item associated URL or web address 2020 of website or webpage. Server module 155 stores or relates in database, identity of searching user with said identified identity of search result item 2025 associated said identified domain name or host name or user name (e.g. “Gucci”) and type of social network account including social or business & professional or customer or following & followers network. Server module 155, receive, from a second computing device of the second user, a message for distribution to one or more unspecified recipients. Server module 155, identify, by a computer processor, the followers of the second user as recipients of the message; and sending the message to the followers of the second user, including the first user.

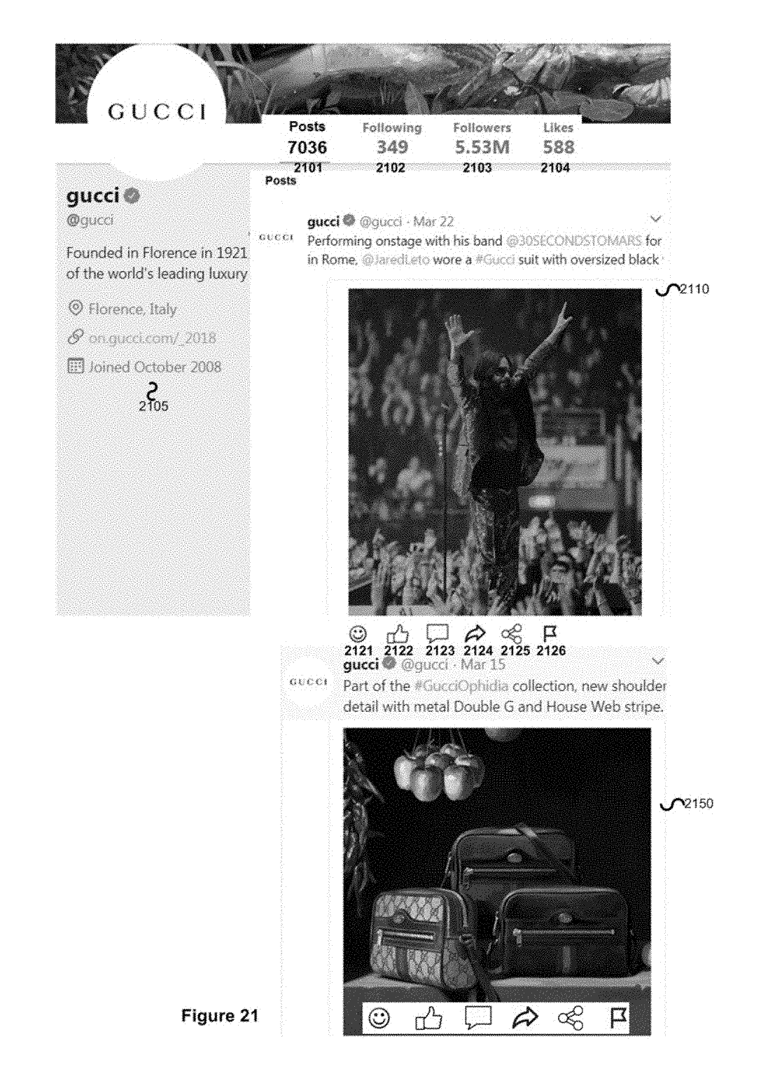

In an embodiment FIG. 21 illustrates Graphical User Interface (GUI) for enabling following users to view followed sources associated posted each post or one or more types of contents including messages, posts, photos, videos, text, Links or URLs and any combinations thereof.

In an embodiment user can intelligently follow search result item associated identified user or account or source or website, wherein said search result item associated identified user or account or source or website can send posts or contents to selected one or more followers, type of followers including selected type of gender, one or more types of interests, age range, income range, qualification, one or more languages, one or more categories, type of activity, action, behaviours, status and transaction, keywords in logged search queries, selected or set or pre-defined locations or geo-fence boundaries or places specific matched followers, preference of followers.

In an embodiment user can intelligently follow search result item associated identified user or account or source or website, wherein server module 155 auto determining presenting of followed sources associated posted one or more types of contents including messages, posts, photos, videos, text, Links or URLs and any combinations thereof based on one or more types of user data including current or past search queries, user status, preferences, current or past logged activities, actions, events, transactions, interactions, status, views, clicks, sharing, communications, current or past locations of user's device, checked-in places, enter, stay & exit in geo-fence boundary, one or more types of user reactions including likes, comments, and ratings, date & time, user profile including type of gender, age range, income range, qualification, and any combination thereof.

In an embodiment server module 152 receive, from a first computing device of a first user, a search query 2005 to search for information on the World Wide Web or search for webpages with information that matches said searching query 2005 and searches, matches and identifies search results 2025/2085. Server module 152 serves or presents said search query 2005 specific search result items 2025/2085 or search results or search results pages to a first computing device 130/FIG. 2 of a first user, wherein search result item comprise title 2017, URL or web address 2020 and snippet 2022. Searching user is enable to send invitation to connect with search result item 2025 associated uniquely identified source or user or account or website or product or service or brand 2020 by tapping or clicking on search result item associated or integrated or embedded “Invite to Connect” button or link or menu item or icon or control or Graphical User interface (GUI) 2053. In the event of tapping or clicking on “Invite to Connect” button or link or menu item or icon or control or Graphical User interface (GUI) 2053, Server module 155 receives, from a first computing device of a first user, request to connect with search result item 2025 associated source or account or user or website or webpage. Server module 155 identifies identity of source or account or user or website or webpage (e.g. “Gucci”) based on said request to connect search result item associated identified domain name or host name, wherein identify domain name or host name or user name (e.g. “Gucci”) and type of social network account based on extracting or parsing search result item associated URL or web address 2020 of website or webpage. Server module 155 sends invitation to connect to said identified source or account or user or website or webpage and in the event of accepting request to connect by said identified source or account or user or website or webpage, server module 155 stores or relates in database, identity of searching user with said identified identity of search result item 2025 associated said identified domain name or host name or user name (e.g. “Gucci”) and type of social network account including social or business & professional or customer network. In an embodiment server module 155, receive, from a second computing device of the second user, a message for distribution to one or more connected users. Server module 155, identify, by a computer processor, the connections of the second user as recipients of the message; and sending the message to the connected users of the second user, including the first user. In an embodiment enable invitee to delete inviter's request to connect with invitee. In an embodiment user is enable to ignore received connection request.

In an embodiment enabling connected users to communicate with each other, send and receive messages, posts, make call, share profile, request recommendation, recommend or refer, view profile, follow, unfollow, remove connection, invite to join particular group or event, save profile, report or block.

In an embodiment in the event of rejection of connection request by invitee inform about rejection to searching user or inviter or invitor.

In an embodiment server module 152 receive, from a first computing device of a first user, a search query 2005 to search for information on the World Wide Web or search for webpages with information that matches said searching query 2005 and searches, matches and identifies search results 2025/2085. Server module 152 serves or presents said search query 2005 specific search result items 2025/2085 or search results or search results pages to a first computing device 130/FIG. 2 of a first user, wherein search result item comprise title 2017, URL or web address 2020 and snippet 2022. Searching user is enable to directly connect (based on pre-set permission to directly connect provided by search result item associated uniquely identified source or user or account or website) with search result item 2025 associated uniquely identified source or user or account or website or product or service or brand 2020 by tapping or clicking on search result item associated or integrated or embedded “Direct Connect” button or link or menu item or icon or control or Graphical User interface (GUI) 2050. In the event of tapping or clicking on “Direct Connect” button or link or menu item or icon or control or Graphical User interface (GUI) 2050, Server module 155 receives, from a first computing device of a first user, request to connect with search result item 2025 associated source or account or user or website or webpage. Server module 155 identifies identity of source or account or user or website or webpage (e.g. “Gucci”) based on said request to connect search result item associated identified domain name or host name, wherein identify domain name or host name or user name (e.g. “Gucci”) and type of social network account based on extracting or parsing search result item associated URL or web address 2020 of website or webpage. Server module 155 stores or relates in database, identity of searching user with said identified identity of search result item 2025 associated said identified domain name or host name or user name (e.g. “Gucci”) and type of social network account including social or business & professional or customer network. In an embodiment Server module 155, receive, from a second computing device of the second user, a message for distribution to one or more connected users. Server module 155, identify, by a computer processor, the connections of the second user as recipients of the message; and sending the message to the connected users of the second user, including the first user. In an embodiment enabling connected users to communicate with each other, send and receive messages, posts, make call, share profile, request recommendation, recommend or refer, view profile, follow, unfollow, remove connection, invite to join particular group or event, save profile, report or block.

In an embodiment In an embodiment server module 152 receive, from a first computing device of a first user, a search query 2005 to search for information on the World Wide Web or search for webpages with information that matches said searching query 2005 and searches, matches and identifies search results 2025/2085. Server module 152 serves or presents said search query 2005 specific search result items 2025/2085 or search results or search results pages to a first computing device 130/FIG. 2 of a first user, wherein search result item comprise title 2017, URL or web address 2020 and snippet 2022. Searching user is enabling to send request to view one or more types of information or contents related to search result item associated identified domain name or host name or user name and type of social network account by tapping or clicking on search result item associated or integrated or embedded “View Company/Business/Brand Profile” 2054 or “View Profile” or “View Posts” 2062 or “View Structured Site” 2063 button or link or menu item or icon or control or Graphical User interface (GUI). In the event of tapping or clicking on said button or link or menu item or icon or control or Graphical User interface (GUI), Server module 155 receives, from a first computing device of a first user, request to view one or more types of information or contents including user profile, business profile, job profile, social network profile, company profile, webpage, published contents, posts, messages, photos, videos, structured information and structured site or website. Server module 155 identifies identity of source or account or user or website or webpage (e.g. “Gucci”) based on said request to view one or more types of information or contents related to search result item associated identified domain name or host name, wherein identify domain name or host name or user name (e.g. “Gucci”) and type of social network account based on extracting or parsing search result item associated URL or web address 2020 of website or webpage and presenting to searching user, requested one or more types of information or contents.

In an embodiment server module 152 receive, from a first computing device of a first user, a search query 2005 to search for information on the World Wide Web or search for webpages with information that matches said searching query 2005 and searches, matches and identifies search results 2025/2085. Server module 152 serves or presents said search query 2005 specific search result items 2025/2085 or search results or search results pages to a first computing device 130/FIG. 2 of a first user, wherein search result item comprise title 2017, URL or web address 2020 and snippet 2022. Searching user is enable to take one or more actions and reactions on search result item 2025 associated uniquely identified source or user or account or website or product or service or brand 2020 by tapping or clicking on search result item associated or integrated or embedded one or more types of actions and reactions controls or Graphical User Interface(s) (GUIs) including button or link or menu item or icon 2055/2066/2057/2058/2059/2060/2061/2065. In the event of tapping or clicking on one or more types of actions and reactions controls or Graphical User Interface(s) (GUIs) including button or link or menu item or icon 2055/2066/2057/2058/2059/2060/2061/2065, Server module 155 receives, from a first computing device of a first user, one or more types of actions, status and reactions including like, dislike, selected expression or emoticon or emoji or sticker indicating one or more types of user actions and reactions, rating, sharing, referring, bookmark, add to one or more types of list, comment on search result item or source or post or one or more types of contents including page, webpage, user profile, business profile, job profile, social network profile, company profile, webpage, published contents, posts, messages, photos, videos, structured information and site and checked-in search result item associated place, indication of customer or prospective customer or current or past client or guest or member or student or employee or employer or friend or in contact or in connection or patient or viewer or viewed or viewing or like to view or read or reader or like to read or listen or listener or like to listen or eat or eating or like to eat or visited or visiting or will visit place of search result item associated source or website or webpage or account or user or entity (In an embodiment present list of types of indications based on search query, search result item associated profile, type of website, searched content, type of content including photo, video, post, advertisement, text, blog, news, keywords, identified keywords based on recognized objects in photo or video (series of images) categories, location and user data including current and past visited or checked-in locations or places and associated details including profile, current event (movie, play, show), type & name of place or associated business details (shop name), date & time). Server module 155 identifies identity of source or account or user or website or webpage (e.g. “Gucci”) based on said request to connect search result item associated identified domain name or host name, wherein identify domain name or host name or user name (e.g. “Gucci”) and type of social network account based on extracting or parsing search result item associated URL or web address 2020 of website or webpage and storing said one or more types of searching user's reactions with said identified domain name or host name or user name and type of social network account including social or business & professional or customer or following & followers network.

In an embodiment presenting said stored one or more types of actions, reactions and status, related to said domain name or host name, provided by users of network with search result item related to said domain name or host name, wherein presenting information about one or more types of actions, reactions and status comprise number of likes 2032, number of dislikes, number of comments or reviews 2033, average ratings, view comments and reviews 2033, number of followers 2034, number of shares, number of views 2031, number of impressions, number of prospective customers, number of customers, number of connections, number of each type of emoticons including happy, happier, not happy, number of bookmarks, number of add to list, number of checked-in place, number of add to contacts, number of profile views, number of posts views, number of clicks, number of site views and view basic profile 2035/2010.

In an embodiment user can unfollow search result item 2025 associated uniquely identified followed source or user or account or website 2020 by tapping or clicking on search result item associated or integrated or embedded “Unfollow” button 2091.

In an embodiment user can unfollow search result item 2025 associated uniquely identified intelligent followed source or user or account or website 2020 by tapping or clicking on search result item associated or integrated or embedded “Unfollow” button 2092.

In an embodiment user can disconnect search result item 2025 associated uniquely identified connected source or user or account or website 2020 by tapping or clicking on search result item associated or integrated or embedded “disconnect” or “connected” button 2093.

In an embodiment providing various types of notification to user or account or website or structured website owner or admin or user including when somebody follow, connect, send invitation, like or rate or bookmark or add to contact or add to list or comment on or share or view profile or post or photo or video or product or service or application or website or webpage or structured site or website, view in search result, provide indication of customer, provide indication of prospective customer or current or past client or guest or member or student or employee or employer or friend or in contact or in connection or patient or viewer or viewed or viewing or like to view or read or reader or like to read or listen or listener or like to listen or eat or eating or like to eat or current or past client or guest or member or student or employee or employer or friend or in contact or in connection or patient or viewer or viewed or viewing or like to view or read or reader or like to read or listen or listener or like to listen or eat or eating or like to eat (in an embodiment (present list of types of indications based on search query, search result item associated profile, type of website, searched content, type of content including photo, video, post, advertisement, text, blog, news, keywords, identified keywords based on recognized objects in photo or video (series of images) categories, location and user data including current and past visited or checked-in locations or places and associated details including profile, current event (movie, play, show), type & name of place or associated business details (shop name), date & time), provide indication of visit or visiting place or checked-in place related to said user or said user's business, click on link, visit website or structured site or website, add to cart, buy product, subscribe service, order, book, participate in group or event or deals or group deals, claim offer, get appointment.

FIG. 21 illustrates Graphical User Interface (GUI) for enabling user to view posts or one or more types of contents 2110/2150 from followed sources, accounts, users, websites and structured sites or websites 2102. In an embodiment posting user is presented with posting Graphical User Interface (GUI) for enabling posting user to post one or more types of contents including post, message, one or more photos, videos, text, link or Uniform Resource Locator (URL), stickers, emoticons and emoji, location information and any combination thereof. In an embodiment enabling viewing user to take one or more actions and reactions on post including like 2122, provide comments and reviews 2123, rating, report as spam or inappropriate 2126, enable to share 2124 post to one or more contracts, connections, groups, enable to share to one or more websites and applications and enable to share via 2125 one or more applications, services. In an embodiment user can view number of posts 2101, number of following 2102, number of followers 2103 and number of total likes 2104. In an embodiment user can view profile 2105.

FIG. 22 illustrates Graphical User interface (GUI) of Search Application (Smart Client or Web based) 271 (In an embodiment Search Application (Smart Client or Web based) 271 connected with server module web search engine 152 and Search Result associated user actions and reactions module 155 of sever 110). Server module 152 receives, from a client search application 271 of a first computing device 130/FIG. 2 of a first user, a search query 2205 to search for information on the World Wide Web or search for webpages with information that matches said searching query 2205. Server module 152 of server 110 searches, matches, identifies, retrieves and generates said search query 2205 specific search results 2210/2225. Server module 152 of server 110 serves and presents said search query 2205 specific search result items 2210/2225 or search results or search results pages.

Searching user to search based on user provided or entered or selected from suggested list of keywords, provided by server module 152, search query or one or more keywords or key phrases 2205 and in the event of tapping or clicking on search button 2207, server module 152 receives said search query 2205 and finds search query or one or more keywords 2205 specific search results or information 2210/2225 on the World Wide Web. Web search engine uses automated programs called spiders or crawlers and has a large index of keywords and where those words can be found. Web search engine 152 is using web crawlers to organize information from webpages and other publicly available content in the Search index. Server module 152, serves said search results 2210/2225 which are generally presented in a line of results often referred to as search engine results pages (SERPs), wherein search result item comprise title of the webpage, so searching user or viewing user can click the title to go to the site or website, URL or web address of the searched or matched web page and snippet or rich snippet, below the URL is text that helps show how the page relates to searching user's query. The words (e.g. “Yogesh Rathod”) searching user search for will show in bold (e.g. “Yogesh Rathod”) to make it easier for searching user to decide if the page has what searching user is looking for.

Server module 155 extracts or parses or identifies unique domain name or host name or unique second level domain name (e.g. “Gucci”) from search query specific search result item 2025 associated Uniform Resource Locator (URL) or web address 2020 of website or webpage.

In an embodiment registered user of server 110 can view user name 2289. In an embodiment enabling user to provide user names 2281/2283/2285/2287 or profile links 2282/2284/2286/2288 of one or more external or 3^{rd} parties social networks including Facebook, Linked-In, Twitter and Instagram and save or update 2299 to server 110 database 115.

In an embodiment sever module 155 identifies identity of search result item 2225 associated account or user based on matching search result item associated Uniform Resource Locator (URL) or web address 2215 with one or more profile Uniform Resource Locators (URLs) of users of network 2282/2284/2286/2288 to identify unique user 2289 who provided their one or more social networks' unique profile Uniform Resource Locators (URLs) 2282/2284/2286/2288.

In an embodiment sever model 155 identifies identity of search result item 2225 associated account or user based on extracting unique user name (e.g. “yogeshcrathod”) and associated particular social network or domain name and type of network of particular social network of (e.g. “LinkedIn”) from search result item associated Uniform Resource Locators (URLs) 2215 by parsing search result item associated Uniform Resource Locators (URLs) 2215 and matching said identified unique user name (e.g. “yogeshcrathod”) with user names of users of network who provided their one or more social networks' unique user names 2281/2283/2285/2287 (e.g. “yogeshcrathod”) or matching said identified unique user name (e.g. “yogeshcrathod”) and identified particular social network or domain name particular social network of (e.g. “LinkedIn”) with user names of users of network who provided their unique user name 2283 (e.g. “yogeshcrathod”) related to said particular social network or domain name particular social network of (e.g. “LinkedIn”).

In an another embodiment server module 155 of server 110 identifies identity of search result item 2225 associated website, webpage, source, account or user (e.g. “LinkedIn”) based on extracting worldwide or global unique identity domain name or host name or second level domain name (e.g. “LinkedIn”) from parsing search result item 2225 associated Uniform Resource Locator (URL) or web address 215 of website or webpage. In an embodiment server module 155 identifies identity of registered user (e.g. “LinkedIn”) of server 110 based on said matching said global unique identity in the form of unique domain name (e.g. “LinkedIn”) with said identified registered user (e.g. “LinkedIn”) associated stored website or domain name or hostname (e.g. “LinkedIn”) (discussed in detail in FIG. 20-21).

In an embodiment sever model 155 identifies identity of search result item 2225 associated website or Uniform Resource Locator (URL) 2015 associated unique identity or unique identity of user account. In an embodiment sever model 155 identifies identity of search result item 2225 associated website, webpage, source, account or user based on extracting worldwide or global unique identity domain name or host name or second level domain name from parsing search result item associated Uniform Resource Locator (URL) or web address 2020 of website or webpage. In an embodiment sever model 155 identifies identity of registered user and identify identity of structured site or website based on matching said global unique identity in the form of unique domain name with said identified registered user associated stored website or domain name or hostname.

In an embodiment server module 152 receive, from a first computing device 130 of a first user 2202, a search query 2205 to search for information on the World Wide Web or search for webpages with information that matches said searching query 2205 and searches, matches and identifies search results 2210/2225. Server module 152 serves or presents said search query 2025 specific search result items 2210/2225 or search results or search results pages to a first computing device 130/FIG. 2 of a first user 2202, wherein search result item 2225 comprise title 2016, URL or web address 2015 and snippet 2017. Searching user 2202 is enable to follow or subscribe search result item 2025 associated uniquely identified source or user or account (e.g. “RathodYogesh”) 2289 by tapping or clicking on search result item 2225 associated or integrated or embedded “Follow” or “Subscribe” button or link or menu item or icon or control or Graphical User interface (GUI) 2251. In the event of tapping or clicking on “Follow” or “Subscribe” button or link or menu item or icon or control or Graphical User interface (GUI) 2251, Server module 155 receives, from a first computing device 130 of a first user 2202, request to follow or subscribe search result item 2225 associated source or account or user (e.g. “RathodYogesh”) 2289. Server module 155 identifies identity of source or account or user (e.g. “yogeshcrathod”) based on said request to follow or subscribe search result item 2225 associated identified unique user name or account name, wherein identify unique user name or account name (e.g. “yogeshcrathod”) and type of social network account (e.g. “LinkedIn”) based on extracting or parsing search result item 2225 associated URL or web address 2015 of website or webpage (e.g. “www.LinkedIn.com”). Server module 155 stores or relates in database 115 of server 110, identity of searching user (e.g. “Ella” 2202) with said identified identity of search result item 2225 associated said identified user name or account name (e.g. “RathodYogesh”) 2289 associated with server 110 and type of social network (e.g. “LinkedIn” or Business Type social network) including social or business & professional or customer or following & followers network. Server module 155, receive, from a second computing device 135 of the second user (e.g. “RathodYogesh”) 2289, a message 2371 for distribution to one or more unspecified recipients (e.g. follower “Ella” 2202). Server module 155, identify, by a computer processor, the followers of the second user as recipients of the message 2371; and sending the message 2371 to the followers of the second user (e.g. “RathodYogesh”) 2289, including the first user (e.g. follower “Ella” 2202).

In an embodiment FIG. 22 illustrates Graphical User Interface (GUI) for enabling following users to view followed sources associated posted each post or one or more types of contents including messages, posts, photos, videos, text, Links or URLs and any combinations thereof. In an embodiment FIG. 22 illustrates Graphical User Interface (GUI) for enabling posting user to post 2373 one or more type of contents or post or message 2371 to followers (e.g. follower “Ella” 2202). of posting user (e.g. “RathodYogesh”) 2289.

In an embodiment user can intelligently follow 2254 search result item associated identified user or account or source (e.g. “RathodYogesh”) 2289, wherein said search result item associated identified user or account or source (e.g. “RathodYogesh”) 2289 can send posts or contents 2371 to selected one or more followers, type of followers 2374 including selected type of gender, one or more types of interests, age range, income range, qualification, one or more languages, one or more categories, type of activity, action, behaviours, status and transaction, keywords in logged search queries, selected or set or pre-defined locations or geo-fence boundaries or places specific matched followers, preference of followers.

In an embodiment user can intelligently follow 2254 search result item 2225 associated identified user or account or source (e.g. “RathodYogesh”) 2289, wherein server module 155 automatically determining presenting of followed sources associated posted one or more types of contents (e.g. 2371) including messages, posts, photos, videos, text, Links or URLs and any combinations thereof 2371 based on one or more types of user data including current or past search queries, user status, preferences, current or past logged activities, actions, events, transactions, interactions, status, views, clicks, sharing, communications, current or past locations of user's device, checked-in places, enter, stay & exit in geo-fence boundary, one or more types of user reactions including likes, comments, and ratings, date & time, user profile including type of gender, age range, income range, qualification, and any combination thereof.

In an embodiment server module 152 receive, from a first computing device 130 of a first user 2202, a search query 2205 to search for information on the World Wide Web or search for webpages with information that matches said searching query 2205 and searches, matches and identifies search results 2210/2225. Server module 152 serves or presents said search query 2205 specific search result items 2210/2225 or search results or search results pages to a first computing device 130/FIG. 2 of a first user 2202, wherein search result item 2225 comprise title 2216, URL or web address 2215 and snippet 2217. Searching user 2202 is enable to send invitation to connect 2257/2258 with search result item 2225 associated uniquely identified source or user or account (e.g. “RathodYogesh”) 2289 by tapping or clicking on search result item 225 associated or integrated or embedded “Invite to Connect” button or link or menu item or icon or control or Graphical User interface (GUI) 2257/2258. In the event of tapping or clicking on “Invite to Connect” button or link or menu item or icon or control or Graphical User interface (GUI) 2257/2258, Server module 155 receives, from a first computing device 130 of a first user 2202, request to connect with search result item 2225 associated source or account or user or website or webpage. Server module 155 identifies identity of source or account or user (e.g. “RathodYogesh”) 2289 based on said request to connect search result item 2225 associated identified user name or account name (e.g. “RathodYogesh”) 2289, wherein identify user name or account name (e.g. “RathodYogesh”) 2289 and type of social network (e.g. “LinkedIn”—Business Type) based on extracting or parsing search result item 2225 associated URL or web address 2215 of website or webpage. Server module 155 sends invitation to connect to said identified source or account or user (e.g. “RathodYogesh”) 2289 and in the event of accepting request to connect by said identified source or account or user (e.g. “RathodYogesh”) 2289, server module 155 stores or relates in database, identity of searching user (e.g. “Ella” 2202) with said identified identity of search result item 2225 associated said identified user name or account name (e.g. “RathodYogesh”) 2289 and type of social network (e.g. “LinkedIn”—Business Type) including social or business & professional or customer network. In an embodiment server module 155, receive, from a second computing device 135 of the second user (e.g. “RathodYogesh”) 2289, a message 2371 for distribution to one or more connected users. Server module 155, identify, by a computer processor, the connections (e.g. “RathodYogesh”) 2289 of the second user (e.g. “RathodYogesh”) 2289 as recipients of the message 2371 and sending the message 2371 to the connected users of the second user, including the first user (e.g. “Ella” 2202). In an embodiment enable invitee to delete inviter's request to connect with invitee. In an embodiment user is enable to ignore received connection request.

In an embodiment enabling connected users (e.g. “Ella” 2202) and (e.g. “RathodYogesh” 2289) to communicate with each other, send and receive messages, posts, make call, share profile, request recommendation, recommend or refer, view profile, follow, unfollow, remove connection, invite to join particular group or event, save profile, report or block.

In an embodiment in the event of rejection of connection request by invitee inform about rejection to searching user or inviter or invitor.

In an embodiment server module 152 receive, from a first computing device 130 of a first user 2202, a search query 2205 to search for information on the World Wide Web or search for webpages with information that matches said searching query 2205 and searches, matches and identifies search results 2210/2225. Server module 152 serves or presents said search query 2205 specific search result items 2210/2225 or search results or search results pages to a first computing device 130/FIG. 2 of a first user 2202, wherein search result item 2225 comprise title 2216, URL or web address 2215 and snippet 2217. Searching user is enable to directly connect (based on pre-set permission to directly connect provided by search result item associated uniquely identified source or user or account) with search result item 2225 associated uniquely identified source or user or account name (e.g. “RathodYogesh”) 2289 by tapping or clicking on search result item associated or integrated or embedded “Direct Connect” button or link or menu item or icon or control or Graphical User interface (GUI) 2263. In the event of tapping or clicking on “Direct Connect” button or link or menu item or icon or control or Graphical User interface (GUI) 2263, Server module 155 receives, from a first computing device 130 of a first user 2202, request to connect with search result item 2225 associated source or account or user (e.g. “RathodYogesh”) 2289. Server module 155 identifies identity of source or account or user (e.g. “RathodYogesh”) 2289 based on said request to connect search result item 2225 associated identified user name or account name (e.g. “RathodYogesh”) 2289, wherein identify user name or account name (e.g. “RathodYogesh”) 2289 and type of social network (e.g. “LinkedIn”—Business Type) based on extracting or parsing search result item 2225 associated URL or web address 2215 of website or webpage. Server module 155 stores or relates in database, identity of searching user (e.g. “Ella” 2202) with said identified identity of search result item 2225 associated said identified user name or account name (e.g. “RathodYogesh”) 2289 and type of social network (e.g. “LinkedIn”—Business Type) including social or business & professional or customer network. In an embodiment server module 155, receive, from a second computing device 135 of the second user (e.g. “RathodYogesh”) 2289, a message 2371 for distribution to one or more connected users. Server module 155, identify, by a computer processor, the connections (e.g. “RathodYogesh”) 2289 of the second user (e.g. “RathodYogesh”) 2289 as recipients of the message 2371 and sending the message 2371 to the connected users of the second user, including the first user (e.g. “Ella” 2202).

In an embodiment enabling connected users (e.g. “Ella” 2202) and (e.g. “RathodYogesh” 2289) to communicate with each other, send and receive messages, posts, make call, share profile, request recommendation, recommend or refer, view profile, follow, unfollow, remove connection, invite to join particular group or event, save profile, report or block.

In an embodiment server module 152 receive, from a first computing device 130 of a first user 2202, a search query 2205 to search for information on the World Wide Web or search for webpages with information that matches said searching query 2205 and searches, matches and identifies search results 2210/2225. Server module 152 serves or presents said search query 2205 specific search result items 2210/2225 or search results or search results pages to a first computing device 130/FIG. 2 of a first user 2202, wherein search result item 2225 comprise title 2216, URL or web address 2215 and snippet 2217. Searching user 2202 is enabling to send request to view one or more types of information or contents related to search result item associated identified user name or account name (e.g. “RathodYogesh”) 2289 and type of social network (e.g. “LinkedIn”—Business Type) by tapping or clicking on search result item 225 associated or integrated or embedded “View Social Profile” 2253 or “View Professional Profile” 2252 or “View Posts” 2261 or “View Structured Site” 2262 button or link or menu item or icon or control or Graphical User interface (GUI). In the event of tapping or clicking on said button or link or menu item or icon or control or Graphical User interface (GUI), Server module 155 receives, from a first computing device 130 of a first user 2202, request to view one or more types of information or contents including user profile, business or professional profile, job profile, social network profile, company profile, webpage, published contents, posts, messages, photos, videos, structured information and structured site or website. Server module 155 identifies identity of source or account or user (e.g. “RathodYogesh”) 2289 based on said request to view one or more types of information or contents related to search result item 2225 associated identified user name or account name (e.g. “RathodYogesh”) 2289, wherein identify user name or account name (e.g. “RathodYogesh”) 2289 and type of social network (e.g. “LinkedIn”—Business Type) based on extracting or parsing search result item 2225 associated URL or web address 2215 of website or webpage and presenting to searching user 2202, requested one or more types of information or contents.

In an embodiment server module 152 receive, from a first computing device 130 of a first user 2202, a search query 2205 to search for information on the World Wide Web or search for webpages with information that matches said searching query 2205 and searches, matches and identifies search results 2210/2225. Server module 152 serves or presents said search query 2205 specific search result items 2210/2225 or search results or search results pages to a first computing device 130/FIG. 2 of a first user 2202, wherein search result item 2225 comprise title 2216, URL or web address 2215 and snippet 2217. Searching user 2202 is enable to take one or more actions and reactions on search result item 2225 associated uniquely identified source or user or account name (e.g. “RathodYogesh”) 2289 by tapping or clicking on search result item 2225 associated or integrated or embedded one or more types of actions and reactions controls or Graphical User Interface(s) (GUIs) including button or link or menu item or icon 2255/2259/2256/2266/2260. In the event of tapping or clicking on one or more types of actions and reactions controls or Graphical User Interface(s) (GUIs) including button or link or menu item or icon 2255/2259/2256/2266/2260, Server module 155 receives, from a first computing device 130 of a first user 2202, one or more types of actions, status and reactions including like, dislike, selected expression or emoticon or emoji or sticker indicating one or more types of user actions and reactions, rating, sharing, referring, bookmark, add to one or more types of list, comment on search result item or source or post or one or more types of contents including page, webpage, user profile, business profile, job profile, social network profile, company profile, webpage, published contents, posts, messages, photos, videos, structured information and site.

Server module 155 identifies identity of source or account or user (e.g. “RathodYogesh”) 2289 based on said search result item 2225 associated identified user name or account name (e.g. “RathodYogesh”) 2289, wherein identify user name or account name (e.g. “RathodYogesh”) 2289 and type of social network (e.g. “LinkedIn”—Business Type) based on extracting or parsing search result item 2225 associated URL or web address 2215 of website or webpage. Server module 155 stores or relates in database, identity of searching user (e.g. “Ella” 2202) with said identified identity of search result item 2225 associated said identified user name or account name (e.g. “RathodYogesh”) 2289 and type of social network (e.g. “LinkedIn”—Business Type) including social or business & professional or customer network. Server module 155 stores said one or more types of searching user's (e.g. “Ella” 2202) reactions with said identified identity of search result item 2225 associated said identified user name or account name (e.g. “RathodYogesh”) 2289 and type of social network (e.g. “LinkedIn”—Business Type) including social or business & professional or customer network.

In an embodiment presenting said stored one or more types of actions, reactions and status, related to said domain name or host name, provided by users of network with search result item related to said user name or account name, wherein presenting information about one or more types of actions, reactions and status comprise number of likes, number of dislikes, number of comments or reviews, average ratings, view comments and reviews, number of followers, number of shares, number of views, number of impressions, number of connections, number of each type of emoticons including happy, happier, not happy, number of bookmarks, number of add to list, number of add to contacts, number of profile views, number of posts views, number of clicks, number of site views and view basic profile.

In an embodiment user can unfollow search result item 2225 associated uniquely identified followed source or user or account 2289 by tapping or clicking on search result item associated or integrated or embedded “Unfollow” button 2291.

In an embodiment user can unfollow search result item 2225 associated uniquely identified intelligent followed source or user or account 2289 by tapping or clicking on search result item 2225 associated or integrated or embedded “Unfollow” button 2292.

In an embodiment user can disconnect search result item 2225 associated uniquely identified connected source or user or account 2289 by tapping or clicking on search result item 2225 associated or integrated or embedded “disconnect” or “connected” button 2264.

In an embodiment enabling to send request to follow and in the event of acceptance or confirm said request to follow, store in database identity of follower with said request accepting user and enable follower to receive each posted contents by followed source.

In an embodiment enabling user to search friends or contacts or professionals or business contacts in network based on name, hometown or city, current city, high school, college, university, based on mutual friends of one or more selected contacts, employer, graduate school, export contacts from one or more e-mail accounts, external social network accounts, applications accounts including communication application accounts, phone contacts, e-mail addresses, uploaded contacts or one or more uploaded files of contacts.

In an embodiment enabling user to provide one or more types of information including contact and basic information including mobile phone number, email, home address including street, city, town, zip, neighborhood, marital status, birth date or age, gender type, time zone, login security details, profile links or Uniform Resource Locator (URLs) and user names or account names of one or more types of social networks, work details including company name, position, address, city, description, work time period (from-to), professional skills, experience including title, company, location, from date, to date, current work, and description, accomplishments including publication, certification, patent, course, project, honor and awards, test score, language, interest groups and organization, select kills from one or more types of list, school name, time period (from-to), graduated or not, description, attend for college or graduate school, high school name, time period (from-to), graduated or not, description, current city, hometown, interests, preferences, search and add family members, search and send request to connect and import contacts from one or more sources or upload contacts, liked events, movies, books, places, food items, celebrities, websites, products, services, brands, friends, sports, applications, companies, entities.

In an embodiment enabling user to post one or more types of contents or posts including messages, photos, videos, text, location information, updates, status, tags, categories, keywords, stickers, emoticons, emoji, and any combination thereof for followers and/or for all or one or more connected users of user. view timeline of user including posted one or more types of contents or posts by user including messages, photos, videos, text, location information, updates, status, stickers, emoticons, emoji, and any combination thereof, and structured posts.

In an embodiment providing various types of notification to user or account including when somebody follow, connect, send invitation, like or rate or bookmark or add to contact or add to list or comment on or share or view profile or post or photo or video or application or website or webpage or structured site or website, view in search result, click on link or Uniform Resource Locator (URL), visit website or structured site or website, add to cart, buy product, subscribe service, order, book, participate in group or event or deals or group deals, claim offer, get appointment, birthday, work anniversary, marriage anniversary, start new position of connections or contacts or friends.

In an embodiment enabling user to search, match and filter business and professional contacts based on industry type, company name, job type, locations, job title, 1^{st} degree, 2^{nd} degree and 3^{rd} degree related contacts, first name, last name, current or past companies, language, school, college, skill, education, groups, interest and any combination thereof.

In an embodiment enabling user (e.g. “Ella” 2202) to import contacts including name, one or more types of social networks, websites, applications and services associated contacts' account names and profile links, email addresses, phone numbers. Based on said imported contacts associated details including account names, user names, profile links of various types of social networks, websites, applications and services and email addresses, and phone numbers, presenting search result to said searching user (e.g. “Ella” 2202) comprise searched profiles of users on various social networks (e.g. 2210/2225) or search result items associated with said each contact's one or more social networks (e.g. Facebook, Twitter, Linked-In) (e.g. 2210/2225) and in an embodiment enable searching user (e.g. “Ella” 2202—registered user with server 110 or present invention's network or website or application or platform or service) to follow search result item e.g. 210 associated identified user (e.g. RathodYogesh 2289—registered user with server 110 or present invention's network or website or application or platform or service), in an embodiment enable searching user (e.g. “Ella” 2202) to send request to follow to search result item e.g. 2210 associated identified user (e.g. RathodYogesh 2289) and in the event of acceptance of request by search result item e.g. 2210 associated identified user (e.g. RathodYogesh 2289) make searching user (e.g. “Ella” 2202) as follower of said request accepted search result item e.g. 2210 associated identified user (e.g. RathodYogesh 2289) to receive each post or message posted by said search result item e.g. 2210 associated identified user (e.g. RathodYogesh 2289), in an embodiment enabling searching user (e.g. “Ella” 2202) to direct connect with said search result item e.g. 2225 associated identified user (e.g. RathodYogesh 2289), in an embodiment enabling searching user (e.g. “Ella” 2202) to send request or invitation to connect to search result item e.g. 2225 associated searching user (e.g. “Ella” 2202) and in the event of acceptance of request by search result item e.g. 2225 associated identified user (e.g. RathodYogesh 2289), connect searching user (e.g. “Ella” 2202) with said search result item e.g. 2225 associated identified user (e.g. RathodYogesh 2289) and enable to communicate, collaborate, participate, share with each other including send and receive message, view profile, add to group, view published posts and one or more types of contents.

In an embodiment enabling user (e.g. “Ella” 2202) to import contacts including name, one or more types of social networks, websites, applications and services associated contacts' account names and profile links, email addresses, phone numbers. Based on said imported contacts associated said provided details including account names, user names, profile links of various types of social networks, websites, applications and services and email addresses, and phone numbers, automatically search profiles of users on various social networks (e.g. 2210/2225) or search result items associated with said each contact's one or more social networks (e.g. Facebook, Twitter, Linked-In) (e.g. 2210/2225) and in an embodiment automatically make said user (e.g. “Ella” 2202), follower of said each searched imported contact associated search result item associated user (e.g. RathodYogesh 2289), in an embodiment automatically connect said user (e.g. “Ella” 2202) with said each searched imported contact associated search result item associated user (e.g. RathodYogesh 2289) and enable to communicate, collaborate, participate, share with each other including send and receive message, view profile, add to group, view published posts and one or more types of contents.

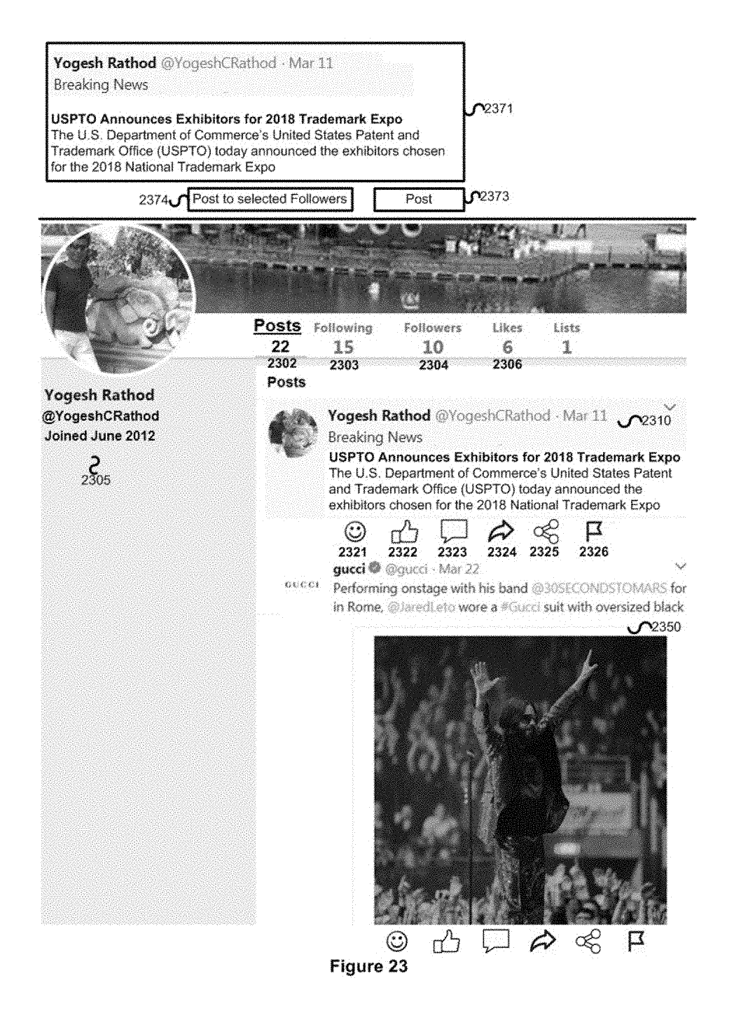

FIG. 23 illustrates Graphical User Interface (GUI) for enabling user 2202 to view posts or one or more types of contents 2310/2350 from followed sources, accounts, users and structured sites 2289. In an embodiment posting user (e.g. “RathodYogesh”) 2289 is presented with posting Graphical User Interface (GUI) 2371 for enabling posting user (e.g. “RathodYogesh”) 2289 to post one or more types of contents 2371 including post, message, one or more photos, videos, text, link or Uniform Resource Locator (URL), stickers, emoticons and emoji, location information and any combination thereof. In an embodiment enabling viewing user 2202 to take one or more actions and reactions on post including like 2322, provide comments and reviews 2323, rating, report as spam or inappropriate 2326, enable to share 2324 post to one or more contracts, connections, groups, enable to share to one or more websites and applications and enable to share via 2325 one or more applications, services. In an embodiment user can view number of posts 2301, number of following 2302, number of followers 2303 and number of total likes 2304. In an embodiment user can view profile 2212 of search result item 2210 associated identified user or account (e.g. “RathodYogesh”) 2289.

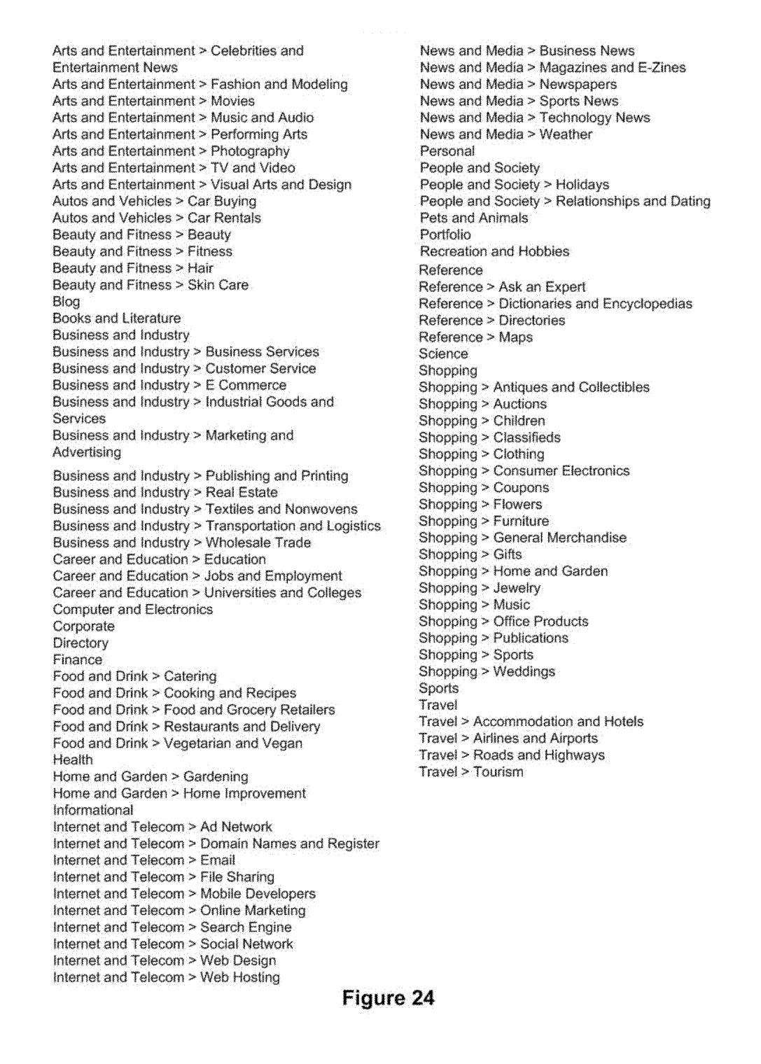

FIG. 24 illustrates exemplary taxonomy of structured site or website categories. Structured site or website creator or owner or administrator can select and associate one or more taxonomies with structured site or website to make it better searchable and list in categories directories.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

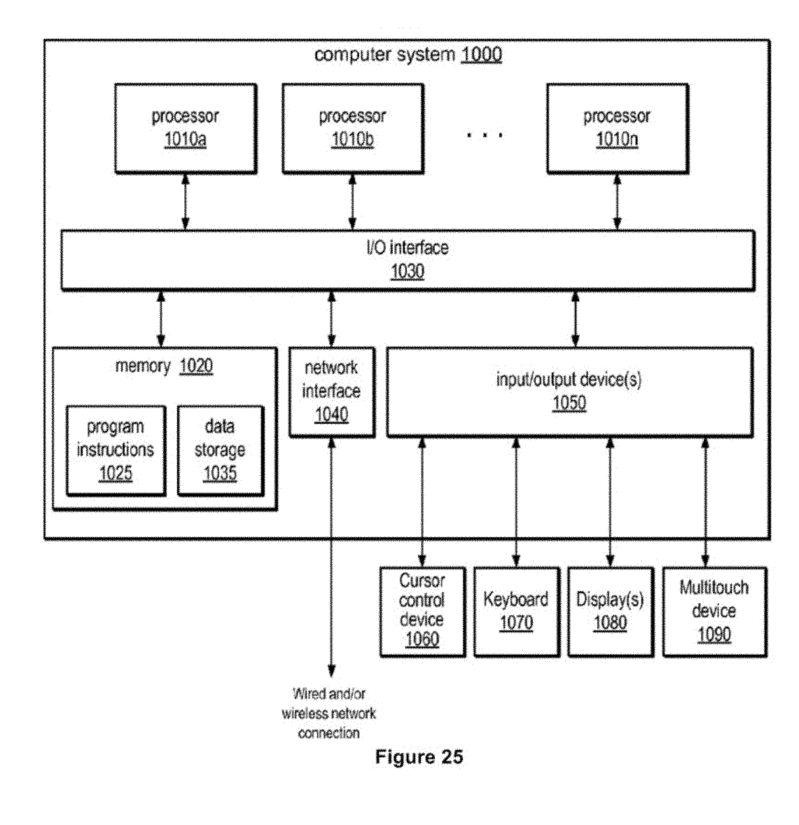

Various components of embodiments of methods as illustrated and described in the accompanying description may be executed on one or more computer systems, which may interact with various other devices. One such computer system is illustrated by FIG. 25. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 25, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability. Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claim:

1. A server, comprising: a processor; and a memory storing instructions executed by the processor to: identifying search result associate unique identity or extracting unique identity based on parsing search result associated Uniform Resource Locator (URL) or web address or metadata; automatically determining or preparing or generating query based on said identified unique identity; and automatically executing said query to automatically search, identify, invoke or retrieve or generate said identified unique identity associated one or more types of structured contents, structured data or structured website.

2. The server of claim 1 wherein displaying said retrieved or generated one or more types of structured contents, structured data or structured website, wherein generating structured contents, structured data or structured website based on pre-defined or pre-set structure or template or configuration and associated one or more types of settings.

3. The server of claim 1 wherein displaying said retrieved or generated one or more types of structured contents, structured data or structured website with said search result item of search results, wherein search results comprise one or more search result items and each search result item may comprise title, Uniform Resource Locator (URL) or web address and snippet.

4. The server of claim 1 wherein identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

5. The server of claim 1 wherein receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item may comprise title, Uniform Resource Locator (URL) or web address and snippet.

6. The server of claim 1 wherein automatically querying one or more structured data sources or storage mediums including photos, videos, images, voice, emoticons, stickers, text, data, location information and one or more types of files associated with said unique identity using said structured query.

7. The server of claim 1 wherein one or more types of structured contents may comprise structured website including structured page or category or structured sub-page or sub-category specific structured post, wherein structured post may comprise one or more photos, videos, text, location information, emoticons, links or Uniform Resource Locators (URLs) and one or more types of digital content, actions and reactions Graphical User interfaces (GUIs) or controls, actions and reactions statistics, structured information including one or more fields and associated values or data, web applications and any combination thereof.

8. The server of claim 7 wherein enabling user to view structured site or website, posts, one or more types of profiles, follow, share, add to contact, add to one or more types of lists, send invitation to connect, direct connect with said search result item associated identified worldwide unique domain name or host name or second level domain name or identified search result item associated global unique identity (GUID) or unique user name or user identity or user associated unique account.

9. The server of claim 7 wherein enabling user to provide one or more types of reactions including like, dislike, bookmark, add to one or more types of lists, add to contact, provide one or more types of emoticons, emoji, stickers, provide comments, ratings & reviews on said search result item associated identified worldwide unique domain name or host name or second level domain name or identified search result item associated global unique identity (GUID) or unique user name or user identity or user associated unique account, unique account associated structured site or website, structured page, profile, post or one or more types of contents or multimedia.

10. The server of claim 7 wherein enabling user to take or conduct one or more types of actions on post or one or more types of contents or multimedia associated with said search result item associated identified worldwide unique domain name or host name or second level domain name or identified search result item associated global unique identity (GUID) or unique user name or user identity or user associated unique account, wherein one or more types of actions including buy, order, book, subscribe, share, message, view product or service details, view structured information.

11. A server, comprising: a processor; and a memory storing instructions executed by the processor to: maintaining or accessing pre-defined or pre-set or pre-configured structure or template or set-up or composition or configuration of structured website including associated one or more types settings, elements, widgets, objects, applications, controls and Graphical User Interfaces (GUIIs) and structured contents and structured data; identifying search result associate unique identity or extracting unique identity based on parsing search result associated Uniform Resource Locator (URL) or web address or metadata; automatically determining or preparing or generating query based on said identified unique identity; and automatically executing said query to automatically search and identify said identified unique identity associated one or more types settings, elements, objects, applications, interfaces, controls and Graphical User Interfaces (GUIs) and structured contents and structured data; and invoking or generating structured website based on said identified and retrieved one or more types settings, elements, objects, applications, interfaces, controls and Graphical User Interfaces (GUIs) and structured contents and structured data.

12. The server of claim 11 wherein structured contents and data comprise a photo, a video, a text, a location information, an emoticons or icons or stickers or emoji, an Uniform Resource Locator (URL) or web address or link, structured data including one or more types of one or more fields and associated values or data, one or more templates or part of templates and associated one or more types of fields and field specific values and any combination thereof and a form, a message, a post.

13. The server of claim 11 wherein settings comprise name, title, one or more categories, type, position, height, width, length, font name, font type, font color, font size, background color, foreground color, order, sequence number, Uniform Resource Locator (URL) or web address or link or namespace associated with structured website or associated one or more pages or sub-pages or categories or sub-categories or associated one or more posts and post associated on or more types of contents or multimedia including photo, video, image, voice, location, emoticon or emoji or sticker, album, slideshow, canvas, carousal, named webpage Uniform Resource Locator (URL), structured data and associated one or more types of controls or Graphical User Interfaces (GUIIs), applications, widgets, objects, structured information templates or edited parts of templates, forms and any combination thereof.

14. The server of claim 11 wherein controls or Graphical User Interfaces (GUIIs) comprise actions controls or Graphical User Interfaces (GUIIs) including share, refer, buy, subscribe, order, book, get appointment, install and reactions controls or Graphical User Interfaces (GUIIs) including like, dislike, expression emoticons or emoji or stickers or icons or templates, comment & review, ratings and one or more applications including web applications, smart client applications.

15. The server of claim 11 identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.

16. A server, comprising: a processor; and a memory storing instructions executed by the processor to: receiving, from a first computing device of a first user, a search query to search for information on the World Wide Web or search for webpages with information that matches said search query; searching, matching and identifying search results; serving or presenting said search query specific search result items or search results or search results pages to a first computing device of a first user, wherein search result item may comprise title, Uniform Resource Locator (URL) or web address and snippet; identifying search result associate unique identity or extracting unique identity based on parsing search result associated Uniform Resource Locator (URL) or web address or metadata; automatically determining or preparing or generating query based on said search query associated one or more keywords and said identified unique identity; and automatically executing said query to automatically search, identify, invoke or retrieve or generate said search query associated one or more keywords specific and identified unique identity associated one or more types of structured content items, structured data or content items within structured website.

17. The server of claim 16 wherein displaying said identified one or more types of structured contents, structured data or contents within structured website with said search result item.

18. The server of claim 17 wherein, highlighting search query related one or more keywords in said displayed one or more types of structured contents, structured data or contents within structured website.

19. The server of claim 16 wherein loading one or more identified structured contents or structured data or contents within structured website comprises a photograph or a video or a post contains photo, video, voice, text, location information, one or more types of contents or multimedia, one or more types of actions and reactions controls or Graphical User Interfaces (GUIs) and any combination thereof; each viewing of the identified structured contents or structured data or contents within structured website comprising sequential display of the plurality of identified structured contents or structured data or contents within structured website, wherein present on the display a first identified structured content item or structured data or content item within structured website of the set of identified structured content items or structured data items or content items within structured website; receive from a touch controller a haptic contact signal indicative of a gesture applied to the display; wherein the controller in response to the haptic contact signal, proceeds to load and present on the display a second identified structured content items or structured data or content item within structured website of the set of identified structured content items or structured data items or content items within structured website or present on the display loaded second identified structured content items or structured data or content item within structured website of the set of identified structured content items or structured data items or content items within structured website.

20. The server of claim 16 wherein identifying unique identity based on search result item of search results comprise identifying worldwide unique domain name or unique domain name including a top-level domain name portion and a second-level domain name portion, wherein the top-level domain name portion specifying a top-level domain and the second-level domain name portion including at least one word or host name or unique fully qualified domain name (FQDN), or absolute domain name including at least a second-level domain and a top-level domain or second level domain name or identifying unique user name of one or more external networks, websites, social networks, applications and services based on Uniform Resource Locator (URL) or parsing search result item associated Uniform Resource Locator (URL) or web address of website or webpage and identifying said identified unique user name or unique profile link of external network associated unique identity or identifying unique identity based on search result item associated metadata including global unique identity (GUID) or identifying said identified worldwide unique domain name or host name or second level domain name or unique user name of one or more external networks, social networks, applications and services or search result item associated global unique identity (GUID) associated unique user name or user identity or user account of present network or website or application or service.
